(19) United States
(12) Patent Application Publication
(10) Pub. No.: US 2009/0276305 A1
(43) Pub. Date: Nov. 5, 2009

(54) AFFILIATE AND CROSS PROMOTION SYSTEMS AND METHODS

(76) Inventor: Brian Clopp, Cranbury, NJ (US)

Correspondence Address: MEREDITH & KEYHANI, PLLC, 330 MADISON AVE., 6TH FLOOR, NEW YORK, NY, 10017, US

(21) Appl. No.: 12/422,848

(22) Filed: Apr. 13, 2009

Related U.S. Application Data
(60) Provisional application No. 61/044,323, filed on Apr. 11, 2008.

(51) Int. Cl. G06Q 30/00

(52) U.S. Cl. 705/14.16

(57) ABSTRACT

A method for managing referrals between a consumer, merchant, and at least one affiliate; generating a referral identifier by a referral identifier generator for an affiliate to give at least one consumer, the referral identifier representing a promotional offer for at least one consumer; accepting and tracking the referral identifier from at least one consumer in an affiliate tracking system; awarding at least one consumer at least one promotion according to a referral identifier; determining the core set by each merchant; determining the core reserve according to the core and at least consumers purchase history with at least one merchant store; awarding the primary affiliate at least one affiliate reward according to the core reserve and each subaffiliate at least one affiliate reward according to the core reserve; and awarding the merchant at least one merchant reward according to the consumers purchase history with each merchant store and the core.

This application claims priority to provisional patent application number 61044323 entitled “Clopp Model” filed Apr. 11, 2008 and non-provisional patent application number 12421686 filed Apr. 10, 2009.

The present invention relates to systems and methods for enabling affiliate, cross promotion and new payment structures between individuals and businesses. Models, methods, and payment structures of the present invention may be applied to other markets, such as the stock market.

With the economy being more and more strained, the role of discounts, cross promotion and alternate revenue sources are becoming more important and desirable. The present invention provides systems and methods to encourage economic growth, create new ways to advertise that are available to small and large businesses alike. It is an object of the present invention to promote the creation of small businesses, and to assist small businesses in forming relationships with other businesses.

The present invention seeks to create a model that introduces new payment and pricing methods, and helps create a bottoms-up, Reverse Pyramid, approach to economics and various markets. It creates Multitude Economics, with more power being in the hands of individuals, and changes current paradigms. It also helps join businesses and services in new ways, allowing new synergies and potentials to form. Additionally, it is applicable to many different markets and economies. While a few niche markets are explored herein—ISO (Independent Sales Organization) companies for credit card processing, Affiliate Companies for agent-generated sales and tracking, Advertising, and new relationships between such businesses—it should be noted this will be developed in its applications to other markets and businesses such as, but not limited to, “stock markets,” “international trade,” “real estate,” “rental properties,” “healthcare”.

Some of the new concepts introduced include, but are not limited to: an ISO company having the ability to take on Sub-Agents or have an Agent-Tier system; an Affiliate Company allowing itself to be listed as a vendor store for an agent to market; an Affiliate Company that offers promotions to agents and store owners; an Affiliate Company that has a relationship with an ISO company, and allows the agents of one company to also be the agent of another; An Affiliate Company or an ISO that allows an Entity to be an Agent (such as a Store, Newspaper, Non-Profit, Sorority, Church, or any other); a company (Affiliate Company, Store, or other) that partners with another to offer new methods of discounts and promotions; an Affiliate Company that has a feedback and rating system for agents/affiliates/store owners/stores/customers/etc.; an Affiliate Company (or any other company or website) that helps businesses find each other for Joint Ventures; introduces new Business-To-Business, Business-With-Business, Business-For-Business ventures; helps businesses run Pooled Advertising; allows a Newspaper to be an agent/affiliate to an ISO or Affiliate Company so the advertised store or product may now receive a free or discounted advertisement provided the Newspaper receives a sales commission or other token; and others.

This also leads to many new inventions; with various methods and tools used to deliver the models. Some of these new inventions and concepts include Advanced Agent Tracking, Agent Tracking In-Store, Advanced Purchase Tracking, Advanced Credit-Card Tracking, Advanced Customer Tracking, Advanced Sales Tracking, Tracking by Elements, Pooled Advertising, Joint Coupons, Communal Discounts, Group Discounts, Symbiotic Business, the tools for businesses to find each other and run Pooled ads or Joint Coupons, the systems and tools to put all of the above in place, and more. The various means of delivering such concepts extend to many different technological methods of delivery.

These and other features, aspects and advantages of the present invention will become better understood with reference to the following description and claims.

### SUMMARY OF THE INVENTION

The present invention relates generally to affiliate and cross promotion systems and methods. Business-For-Business can be for any joint ventures or partnerships and need not be a promotional venture.

According to one embodiment, a method for managing referrals between a consumer, merchant, and at least one affiliate, wherein a first affiliate is a primary affiliate and subsequent affiliates are sub-affiliates; generating a referral identifier by a referral identifier generator in a computer processor coupled to a network for an affiliate to give at least one consumer, the referral identifier representing a promotional offer for at least one consumer; accepting and tracking the referral identifier from the at least one consumer in an affiliate tracking system in a computer processor coupled to a network; awarding at least one consumer at least one promotion according to the referral identifier; determining the core set by the merchant; determining the core reserve according to the core and at least consumers purchase history with at least one merchant store; awarding the primary affiliate at least one affiliate reward according to the at core reserve and each subaffiliate at least one affiliate reward according to the core reserve; and awarding the merchant at least one merchant reward according to the at least one consumers purchase history with at least one merchant store and the core.

According to another embodiment, a computer processor implemented system for managing cross promotions and awarding at least two promotions between at least two merchants according to a consumers purchase history with at least one of the at least two merchants is provided, the system comprising; at least two merchants, each merchant having a store and agreeing to an agreeable predetermined promotional offer at the store; a referral identifier generator for each merchant to give at least one consumer, the referral identifier generator in a computer processor system coupled to a network and the referral identifier representing a promotional offer for at least one consumer; an affiliate tracking system for accepting and tracking the referral identifier from the at least one consumer, the affiliate tracking system in a computer coupled to a network, wherein the at least one consumer is awarded at least one promotion according to the referral identifier and at least one merchant is awarded at least one merchant reward according to the at least one consumers purchase history with at least one store.

These and other features, aspects and advantages of the present invention will become better understood with reference to the following description and claims.

### BRIEF DESCRIPTION OF THE DRAWINGS

FIGS. 1-20 depict the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

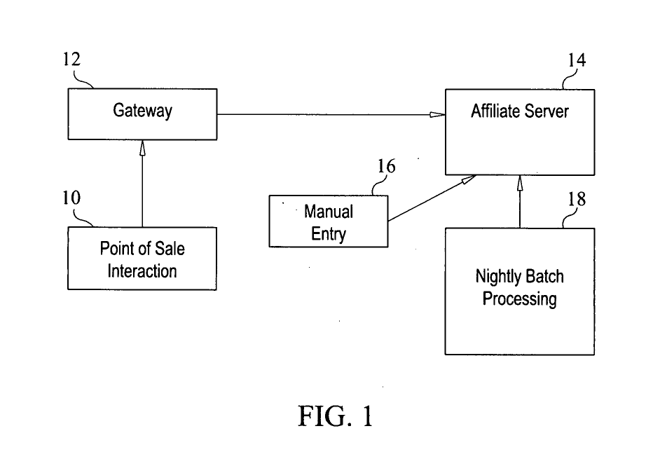

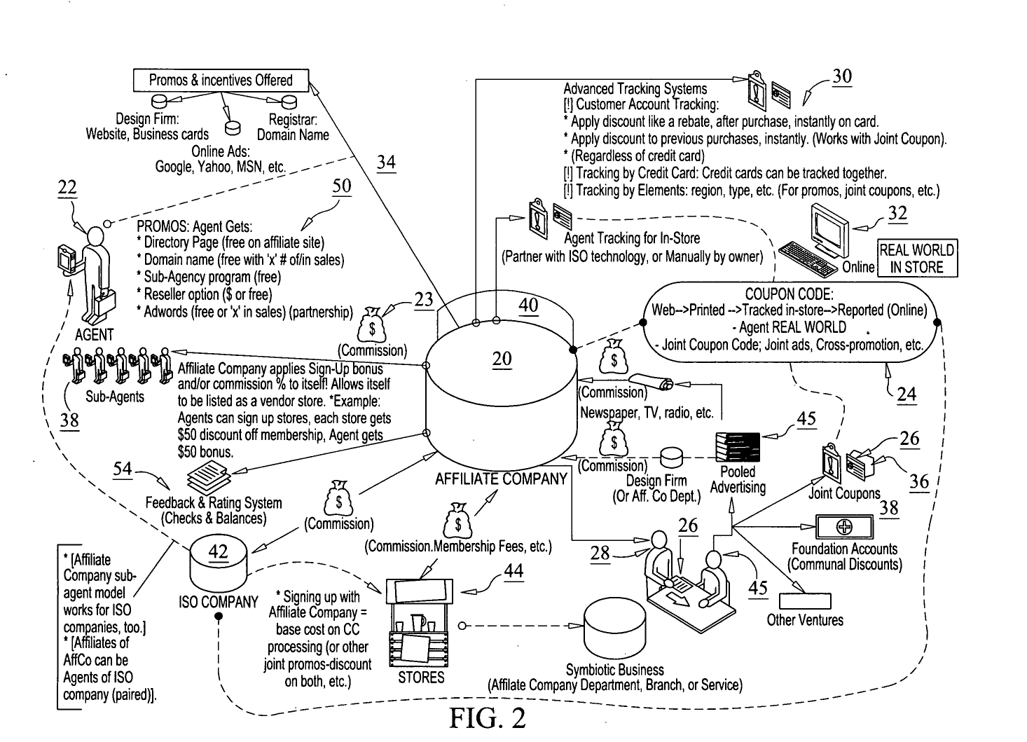

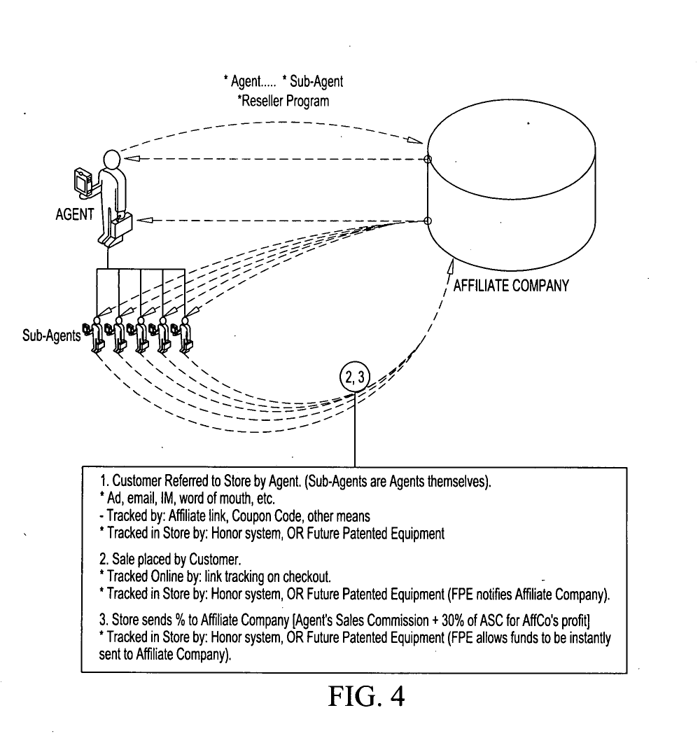

With reference to FIGS. 1-5 the present invention provides systems and methods for managing referrals between a consumer, merchant, and at least one affiliate (22) a referral identifier generator (32) for an affiliate (22) to give at least one consumer (28) a referral identifier (26), the referral identifier generator (32) in a computer processor system coupled to a network (34) and the referral identifier (26) representing a promotional offer for at least one consumer (28); an affiliate tracking system (30) for accepting and tracking the referral identifier (26) from the at least one consumer (28), the affiliate tracking system (30) in a computer coupled to a network, wherein the at least one consumer (28) is awarded at least one promotion according to the referral identifier (26), the affiliate (22) is awarded at least one affiliate reward (23) according to the at least one consumers (28) purchase history with at least one store (44) and the merchant (45) is awarded at least one merchant reward according to the at least one consumers (28) purchase history with at least one store (44).

According to another embodiment, a computer processor implemented system for managing cross promotions and awarding at least two promotions between at least two merchants (45) according to a consumers (28) purchase history with at least one of at least two merchants, the system comprising; at least two merchants (45), each merchant having a store (44) and agreeing to an agreeable predetermined promotional offer at the store (44); a referral identifier generator (32) for each merchant (45) to give at least one consumer (28), the referral identifier generator (32) in a computer processor system coupled to a network and the referral identifier (26) representing a promotional offer for at least one consumer (28); an affiliate tracking system (30) for accepting and tracking the referral identifier (26) from the at least one consumer (28), the affiliate tracking system (30) in a computer coupled to a network, wherein the at least one consumer (28) is awarded at least one promotion according to the referral identifier (26) and at least one merchant (45) is awarded at least one merchant reward according to the at least one consumers (28) purchase history with at least one store. The at least two merchants may be a first merchant and a second merchant and a merchant reward for the second merchant may be preconditioned upon a consumers purchase history with the first merchant. For example, there may be an offer for ten percent off at Julie's Ice Cream (a first merchant), the coupon may be given out at Bob's Pizza (a second merchant) and Bob's Pizza may get a merchant reward if the consumer eats at Julie's Ice Cream, but only if the consumer purchases at Julie's Ice Cream.

Another example may be a group of ski slopes (each being a different Merchant in this example) in Utah decide to give consumers a 10% discount off consumer's next ski lift if ski lift is in Utah, regardless of which slope/mountain consumer goes to next. In this example Merchants may, or may not, make a commission on the referral, and the referral may not be directly to a particular ‘store’ but rather to the entire Network of ‘stores’. The merchant reward at the merchant giving away the free ticket is cross-promotion marketing. Although they are not receiving monetary gains, the skier may find out they like skiing at that hill the best and become a lifelong customer. Another example: All ski slopes in Utah agree that if a consumer skiis at a set amount of locations (‘merchants’), such as two or more slopes (or three or more slopes—any amount), the consumer receives a 10% discount rebated to the previous slopes and also a 10% discount applied to the latest slope once they reach that threshold (and possibly every slope thereafter). Another example: “Ski at 3 resorts, get free lift ticket to 4th resort free” (in this last example, so 4th resort is not incurring a loss, money can be paid via escrow from the first two via funds channeled into a conglomerate escrow account managed by the Affiliate System). In each of these examples, Consumer is encouraged to go to the competition to receive a discount, and this should ultimately increase consumer's enjoyment of the area as well as increase the number of visitors to each ski slope. In other examples, an Alliance may be formed by one ski slope in Utah such as Snow Basin, another ski slope in the Alps, another ski slope in Italy, a scuba dive shop in Fiji, and a safari company in Australia, where they provide globe-trotting consumers rebates and discounts once consumer passes a threshold (such as a monetary amount spent, or a set number of ‘merchants’ consumer engages in a purchase from). In this last example, merchants across seas who would not normally interact with each other may discover each other, and engage in relationships to bring business to each other. Such relationships may further assist in increasing the exposure and advertisement of each business, reaching consumers where the consumers may not have otherwise heard of that merchant overseas, thereby giving a cross promotion to reach consumers who may not have even known of the other merchant. The Affiliate Network System may suggest such a network to Merchants; for example, the Affiliate Network System may see that there is a shoe store in NYC, belt store in Australia, hat store in France, and suggest to each merchant that they form a Network with each other, and may even suggest a particular cross-promotion (which may even be based on the products, using info gathered by the Affiliate System about the products of those Merchants, or data submitted to the Affiliate Network System about the products of that Merchant).

The methods described herein may take different forms, for example no consumer or merchant needed in the typical sense. For example, if stock brokers are trading from one to the other (the selling broker is the merchant and the purchasing broker is the consumer); could also be a mutual trade where each would be a consumer and an affiliate.

There may be an agreement between any of the merchants, subaffiliates and affiliates which may be termed an affiliate award agreement. The data gathered based on the agreement formed between the Merchants can be given to the system that forms the coupon for the consumer to print out (or link to track). Such data may be deciphered at point-of-sale by equipment in store where it may then be sent to the Affiliate Network System (this may require a pre-programmed recognition system to identify the percentage, amount, etc.); or it may be sent directly to Affiliate Network System where scan box is unknowing what coupon is for; or both. The former may be the best method where a small computer at the counter may identify what the coupon is for without relying on a connection to the ANS, in case of an outage with the internet or phone connection.

The referral identifier (26) may be selected from the group consisting of a coupon, joint coupon, radio frequency identifier coupon, mobile phone coupon, signal delivered coupon, computer generated link, referrer coupon, coupon code and system generated automated coupon code. The affiliate tracking system for accepting the referral identifier (26) may be offline. There may also be at least one subaffiliate (38), and a subaffiliate referral identifier generated by the referral identifier generator (32), wherein the subaffiliate (38) is awarded at least one affiliate reward according to the at least one consumers purchase history. The rewards (affiliate reward, merchant rewards, etc.) may or may not be withheld at moment of the transaction and may be claimable at that time or at a later date, as desired by the parties.

The referral identifier may be a joint coupon (38) and the at least one consumer (22) may be awarded at least one promotion according to the referral identifier, wherein the affiliate (22) is also a second affiliate (38) and the first affiliate (22) and the second affiliate (38) are each awarded at least one reward according to the at least one consumers purchase history with at least one store (44). There may also be an independent sales organization (42), affiliate company (20), bank, clearing house, stock exchange and market. The affiliate company (20) manages the system and methods accepting information from all parties (e.g. agents, subagents, ISO companies, merchants, consumers, referral identifier generator). The advanced tracking system (30) may be separate or part of the affiliate company (20). There may also be sub affiliate companies (40). The referral identifier may be a pooled advertisement (45). The merchant (45) may also be an affiliate (22). There may also be a computer implemented networked directory (50) wherein at least one merchant selects at least one symbiotic relationship to create a business alliance. This may be, for example, where a Merchant selects another Merchant to create a ‘joint venture’ and/or create a ‘Network’.” This may also be where an merchant finds another merchant to publish and solicit a coupon. There may also be an Affiliate-Tier system, wherein at least one subaffiliate (38) and affiliate (22) have an affiliate award agreement. The affiliate tracking system (30) may also have In-Store Affiliate Tracking (52), Advanced Purchase Tracking, Advanced Credit-Card Tracking, Advanced Customer Tracking, Advanced Sales Tracking and Tracking by Elements. The promotion may be a points system. There may also be a feedback system (54). In-Store Affiliate Tracking may be a method or system by which referrals of a particular Affiliate are tracked to that Affiliate's account from a physical location such as a store. It may also assist with tracking data amongst groups, communities, networks, or pools of more than one affiliate. Advanced Purchase Tracking may be a method or system by which a purchase can be tracked. This may provide advanced details about a purchase, such as a detailed breakdown of the items (cost, quantity, type, category, SKU #, model #, other). This may also be used in “real time”, such as a scan gun while the customer walks around the shop scanning bar codes of items (Advanced Item Tracking). This may further the potentials of the system in many ways. It may be used to alert a customer when they are about to make a purchase about a joint coupon, a rebate coupon, or any kind of coupon code that is applicable to that item in cooperation with an item from another Merchant. It may alert a customer of a joint coupon in that store, or provide a suggestion to a similar item that the customer may like or a suggestion to a similar item that may be on sale. Advanced Customer Tracking may be the tracking of one customer and their related purchases, and eligibilities such as cross-promotions, rebates, and/or points earned. This may be tracked by any means or identifier, including but not limited to Credit Card, Bonus Card, ID #, name, the coupon itself (such as if the coupon was printed from a Consumer User Account on the Affiliate System Network), or other. Advanced Customer Account Tracking may be used to apply discounts like a rebate or joint rebate, after a purchase has already been made, instantly on the consumer's credit card. It may also be used to apply discounts to previous purchases, instantly. This may work with Joint Coupons, and may work regardless of the Credit Card type. Tracking by Credit Card may allow credit cards to be tracked together. This may be done via credit card; currently one credit card can only track to that one account . . . here, a customer may have two credit cards of different types (one MasterCard with Chase, one Visa with Wachovia), and purchases made by either card are pooled into a collective system. A customer can therefore be identified as that customer regardless of the credit card used. This allows for a customer to make a purchase on Card 1 at Store A, and to make a purchase on Card 2 at Store B, and still allow those purchases to be tracked and linked to a joint-promotion between those two stores and therefore issues any discounts or rebates, at point of sale or retroactively after purchase (or both). Advanced Sales Tracking may be the tracking of a particular sale, or sets of sales such as those that rely on each other for a joint discount or rebate. It may assist in tracking purchases, such as those that have deals or promos attached to them. It may also be used by a Merchant as a means of tracking elements such as inventory, discounts, or even commissions owed a particular affiliate. It may be used to gather data about sales and their effectiveness, as well as compare the effectiveness of sales that other merchants are running. Tracking By Elements may be the gathering or tracking of data by region, type, and more. It may be used in the situation of a joint coupon, promo, and more. Tracking by Elements, as with other methods and systems herein, may be bi-directional. For example, a Consumer may be online looking at a product on a Merchant's ecommerce website; Tracking By Elements may have acknowledged the Consumer's zip code, and searched for deals within a twenty mile radius to Consumer, thereby displaying a Joint Coupon to Consumer where Consumer may receive a discount on the existing product they are viewing as well as a discount on a product at another Merchant across town if Consumer buys both products and uses the Promo Code provided. Note: All tracking methods may appear via any venue, including but not limited to internet, in-store or other . . . as well as any delivery mechanism including but not limited to coupon, bar code, phone, iphone, or similar device, terminal, cash register, laptop, scanner, manual entry, or other, or any combination thereof. Tracking may be via credit card, gift card, loyalty card, affiliate card, data systems, inventory system, stock market, online trade system, or anything. A system generated automated coupon code is a coupon that need not be swiped. It may be data entered by consumer from their Consumer User Account, and maybe only Consumer's Club Card is swiped whereby merchant's terminal knows to check consumer's account eligibilities and coupon enrollments. This would cut down on the number of coupons a consumer needs to carry, by providing a system where the Consumer only needs to carry their one card or a key-in code, and the system sees what coupons they are eligible for—this way a shopper does not have to lug around a ton of coupons on paper (easy to lose in purse), and it saves trees. It would also allow the Merchant to alert the consumer of coupons they may not have known about but may be automatically enrolled in. A rebate with joint coupon is a rebate applying to a first purchase at Merchant A at time of a second purchase at Merchant B, instantly at point of sale. A Discount with Joint Coupon is where the consumer gets a discount at point of sale on that purchase, and an Award with Joint Coupon is where the consumer gets a future award or award for future use such as gift certificate. A Consumer's card that can be used to store data, or link to a database (such as one residing on Affiliate Network System or Affiliate Processing System, or in Consumer's User Account). The Consumer's Card may therefore act as a means of using many coupons on one card, rather than holding individual paper coupons. Consumer may enroll online to add to card, or may be automatically enrolled (and may receive alerts via ways such as email or text). Instead of carrying individual coupons, consumer only needs Consumer Coupon Card. A Consumer Card, Coupon Card, or Consumer Coupon Card may be used to compile all coupons applicable to a particular consumer and make them accessible at point of sale (online or in store) by having the Card (or consumer's identification # in the Affiliate Network System, which may be the card #) that may be encountered by Merchant and processed through the Affiliate Processing System, to apply eligible coupons to the purchase (which may be applied at point of sale). It may be an Affiliate Card as stated before; but an affiliate is not needed. Merchants would benefit by having the ability to track their coupon sales, and Consumers and Merchants alike would benefit by having coupons in one place for a Consumer and to save on printing cost and trees.

A Consumer Card, Coupon Card, or Consumer Coupon Card may be used to compile all coupons applicable to a particular consumer and make them accessible at point of sale (online or in store) by having the Card (or consumer's identification # in the Affiliate Network System, which may be the card #) that may be encountered by Merchant and processed through the Affiliate Processing System, to apply eligible coupons to the purchase (which may be applied at point of sale). This may be an Affiliate card or may be separate from an Affiliate Card; no affiliate is needed. Merchants may have the ability to track their coupon sales, and Consumers and Merchants alike will be happy having coupons in one place for convenience of a Consumer, and to save on printing cost and trees (thereby keeping advertising and product costs lower, and helping the environment). Data may effectively be entered by consumer from their Consumer User Account (such as by consumer enrolling in a coupon from a merchant or a Joint Coupon from two merchants), and this data may be read by or interacted by Consumer Card or access granted by use of Consumer Card, thereby allowing said card to be used for any coupon Consumer has enrolled in at corresponding merchants. Consumer may likewise easily track and view coupon expirations, coupons enrolled in, coupon eligibility and availability, and more from within Consumer User Account on the Affiliate Network System, and may schedule alerts to be sent for particular coupons (such as a text notifying consumer of a desired coupon's expiration one day prior to expiration, or an email notifying consumer of new coupon on a particular product, or a phone call alerting consumer a product has just gone on sale or been discounted in price). By way of example: Patricia normally has fifteen coupons cut out from newspapers disorganized in her purse, and she cannot keep them all straight and often loses them when they become fumbled and stick to her keys. Instead of dealing with this old way of managing and using Coupons, Patricia logs online into her Consumer User Account on the Affiliate Network System, browses for her desired coupons, and hits “add to Coupon Card,” thereby enrolling those coupons onto her card. She may apply for coupons and be accepted by merchants, and she may elect to auto-enroll for an entire merchant. She then goes into a store and uses several coupons by simply swiping her Coupon Card, and receives an award such as a discount on the purchase. This may be combined with affiliate coupons, joint coupons, and other methods and systems. Merchants may make use of existing coupons to “coupon match” and honor coupons on Coupon Card that would otherwise be applied to purchases at competing merchants. A device such as terminal may know to check consumer's account eligibilities and coupon enrollments. This method and system may cut down on the number of coupons a consumer needs to carry, by providing a system where the Consumer only needs to carry their one card or a key-in code, and the system sees what coupons they are eligible for—this way a shopper does not have to lug around a ton of coupons on paper (easy to lose in purse), and it saves trees. It would also allow the Merchant to alert the consumer of coupons they may not have known about but may be automatically enrolled in. Consumer's card may be used to store data, or link to a database (such as one residing on Affiliate Network System or Affiliate Processing System, or in Consumer's User Account); Consumer's Card may therefore act as a means of using many coupons on one card, rather than holding individual paper coupons. Consumer may enroll online to add to card, or may be automatically enrolled (and may receive alerts via ways such as email or text). Instead of carrying individual coupons, consumer only needs Consumer Coupon Card. An Affiliate Card may be a separate card as a Consumer Coupon Card, or may function the same; consumer may use an Affiliate Card to gain points and awards and may be used for promotions that have been given from an Affiliate; however a Coupon Card may function the same way if need be. A Consumer may be auto-enrolled into any promotions by a particular affiliate(s) or affiliate network or merchant, where ‘auto-enrolled’ means that consumer may make use of coupons from such party without having to apply for each coupon; consumer may have added such an Affiliate to their favorites, or allowed such an auto-enrollment to occur from within their Consumer User Account preferences. No affiliate is necessary; coupons may strictly be for a Merchant. A second Merchant may be optional, for a Joint Coupon, but no joint coupon is necessary—a coupon may be solely for a particular Merchant. A Consumer Coupon Card need not be an actual physical card; it may be an identification number that may be keyed in online, a means of identifying a consumer such as the consumer having their fingerprint scanned at the counter to identify them and thereby relay consumer's identity to the Affiliate Processing System so that Affiliate Processing System may see coupon eligibilities of Consumer in Affiliate Network System and interact with those eligibilities and promotional deals to apply discounts to consumer's purchase, etc. The Affiliate Processing System may perform back-end data gathering from the store and sorting. Information may travel from the Affiliate Gateway to the Affiliate Platform to the Affiliate Processor (does the tracking of data and processing of it). The Affiliate Network System may be an online website for Merchants to find other Merchants and form ventures, Affiliate to enroll or apply for promotions to solicit to Consumer, Merchants to form Alliances, Affiliates to form Alliances, Consumers to form Alliances. Data gathered in the Affiliate network system may interact with the affiliate processing system so those parties in the affiliate processing system can view tracking and reports of the data; the affiliate network system may also be used to do things such as a Merchant issuing a refund, which may require the affiliate processing system to work in reverse to issue a consumer a refund and withdrawal that set of money from Affiliate's escrow account.

The present invention builds a new kind of Affiliate Program which includes a directory listing, sales feedback, a Reseller Program, advertising credit incentive and promotions, an affiliate program. Most affiliate programs and affiliate companies are for larger corporations and charge large upfront setup fees (For example, the typical affiliate company may generally charge a $10,000 setup fee, $1,000 a year maintenance fee and thirty percent (30%) of what the agent gets paid). The present invention can charge lower fees because it creates an incentive structure that creates alternate ways to generate revenues.

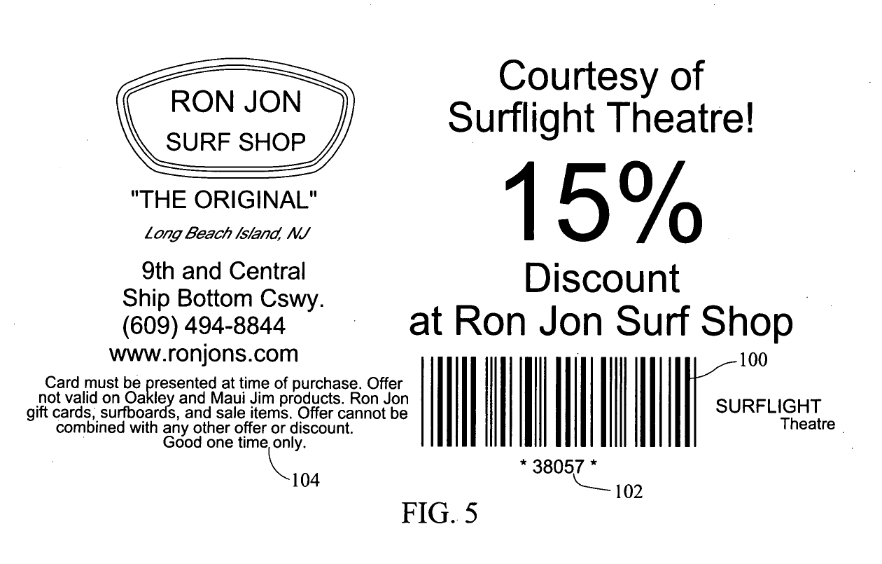

Some example of how this works may be a merchant selling a bag of rice, the system may create a referral identifier generator in the form of a coupon that represents a promotional offer for the buyer to get 10% off, the affiliate gets 5% of the item purchased (it may be 5% of the single item or of the entire purchase, depending on the arrangement). The merchant award is the money paid for the item purchased. An example of a coupon according to the present invention is depicted in FIG. 5. As shown, there may be a bar code (100) or a referral code (102). There may also be coupon restrictions (104)

Another example may be at an auto mechanic; a consumer pays him $300 to fix the timing belt. While consumer is waiting for services to be complete, the consumer gets a back massage for free from a masseuse in a waiting room or at a neighboring business. The mechanic gives the masseuse $80 (the masseuse would normally charge $90, but gets continued business from the mechanic). The mechanic gets a flow of happy customers. In this example, the promotion is the massage, the merchant reward is the $300 to fix the timing belt and the affiliate reward is the $80 or ability to give a discount. This creates a symbiotic relationship because the masseuse has a consumer with free time, the auto mechanic has customers that are not upset about waiting and more likely to go to that auto mechanic than a competitor. In another example, the consumer may pay the mechanic $300 and while waiting pay the masseuse $80 (instead of the regular rate of $90), and customer likewise may receive a rebate of $20 on the services at the mechanic after returning from the massage. In this example, both merchants received less than they would have from one direct purchase, but the consumer has been encouraged to shop at both merchants and the consumer feels that have made a deal at a good bargain.

The present invention may also be utilized in an entirely online and automated environment. For example, an affiliate sets up a website at www.example.com and the affiliate gets five dollars ($5.00) each time a consumer clicks on a link in it as those are “high end” keywords a shop owner pays Google ten dollars ($10.00) for. The affiliate in turn advertises on Google using low end words to drive traffic to www.example.com (for example words that cost $0.50 per click). If one in ten follows a low end link, the affiliate just made $5.00. In this scenario the sub-affiliate on the bottom takes the risk and accrues the advertisement cost. The affiliate may have even received $100 bonus in Google adwords credit from Merchant or from Affiliate Company from passing a threshold such as $1,000 in sales. The present invention may also utilize a system in which users get points so that the consumer “gets something back” for buying something. A consumer may receive a rebate from Merchant A once they purchase a product from Merchant B. If a customer buys a second product (such as from a 2^{nd} Merchant in a joint coupon), the customer “gains” even though they are spending more money by making the second purchase. This may be, for example, a points system, rewards system and/or frequent flyer system. This may be a reward such as a free or discounted second item(s), discount on a future purchase, discount on the current purchase, gift certificate, rebate.

One core concept is the action of and ability for an ISO Company to take on a Tier Agent System; allowing an agent to take on sub-agents, and sub-agents to take on sub-sub-agents, and so on. Additionally, the new payment models—unique to all markets—when specifically applied to an ISO Company, now allow such a Tier-System to be put in place. (The same applies for an Affiliate Company). The affiliate who makes the sale may receive the same amount.

Some definitions that may be useful in understanding the present invention are provided herein. “Core” may be a percentage (%) of sale, a percentage (%) of gross, a percentage (%) of profit, a percentage (%) after a split to another outside entity, a percentage (%) of an entire account (the result of many sales vs. one sale), a percentage (%) of a pay period, a percentage (%) of a pay check or other contract, a collective percentage (%) of a sale paid by a Merchant to outside parties such as affiliates and the sponsoring Affiliate Company, or other. All amounts are example only. They may be higher or lower, at any stage. “Percentage (%)” may be exchanged with monetary amount, or other means; services, stock shares, real estate property, points, credit, tokens, etc. “Commission,” “Split,” “residuals,” “payout,” and any other like terms may be exchanged. The term “ISO” may be exchanged for “Affiliate Company,” “Bank,” “Company,” “Hedge fund,” “Clearing House,” or any other term that signifies a similar entity. The term, “Agent” may be exchanged for “Affiliate,” “Reseller,” “3rd party Agent,” “3rd Party,” “Primary Agent,” “Sub-Agent,” “Contractor,” “Sub-Contractor,” “Broker,” “Consultant,” or any other term that signifies a similar entity. “Primary Agent,” may be exchanged with a term such as, “Affiliate Company,” etc. (An Affiliate Company may be a Primary Agent to an ISO, etc.). A Sub-Agent or sub-affiliate may be a Store Owner, or a Consumer itself. A “Core” is: An amount the store (or other) is willing to give away. One hundred percent (100%) core is the full split to be divided between Top Factor. A “Top Factor” is: The entity or individual on the top of a hierarchy, after store payout. (Top Factor may be: ISO, Affiliate Company, etc.). The term may be exchanged for a Parent Affiliate in some situations or models or methods. Top Factor may also be referred to as the “Parent” such as the “Parent Company” being the top Affiliate Company with affiliates operating under it. “Primary Affiliate” is the Affiliate highest in the hierarchy, just underneath “Parent” ISO/Affiliate Company in the chain. It may be used synonymously with Affiliate in some cases, and may even be a Sub-Affiliate to another in some models. “Sub-Affiliate” is any Affiliate below another Affiliate, primary Affiliate, or sub-Affiliate. A Primary Affiliate or a Sub-Affiliate can be Affiliates-of-Sales in their own right. “Base Affiliate” or “Affiliate-of-Sale” is the Affiliate closest to the Point of Sale, who lead the customer to make a transaction. A dual sub-affiliate is when two sub-affiliates exist on one transaction, purchase, or order. This may be if two sub-affiliates each refer a customer to a store (if online affiliate tracking may show customer came from two places over a given period of time, if in store customer may use two codes for additional award). Dual sub-affiliates may be independent or cooperate together (as in a group). Both affiliates in a Dual Sub-Affiliate scenario may make [the term make refers to receiving an award] the same as each other, or one may make more than the other. Affiliate-of-Sale can be a Sub-Affiliate to another Affiliate, or can be the Primary Affiliate if no chain exists. “Middle Affiliates” are those in-between Primary Affiliate and Affiliate-of-Sale. There needn't be Middle Affiliates between the Primary Affiliate and Affiliate-of-Sale. There may also be a dual affiliate which may be two Primary Affiliates or two Sub Affiliates who refer the same customer together or each on their own. Two Dual Primaries may each share in one Sub Affiliate as Dual Primaries to that Sub Affiliate, but may be independent Primaries to other Sub Affiliates; for example, both Primaries may refer one Consumer into the system in the same month period of time and thereby be Dual Primaries to that reference, and each Primaries may have their own Sub-Affiliates outside of each other. A “Core Reserve” is the funds set aside to be shared between Middle Affiliates, after split to Top Factor and Base Affiliate. Core Reserve may be split with Primary Affiliate and Middle Affiliates, or just with Middle Affiliates (Primary Affiliate can have part of the Core, or part of the Core Reserve, or both in some cases). Parent Affiliate Company, Primary Affiliate, Sub-Affiliate, Dual Affiliates (Dual Affiliate can be two affiliates or sub-affiliate or primary affiliate or even affiliate company, etc.) may all share a consumer or merchant on a particular deal, or may be seen as Dual affiliates on those deals, as well as any other possible setup. For example; Affiliate A may give a coupon for a spoon to Consumer, and Affiliate B may give a coupon for a fork to Consumer, and both coupons are used at Merchant A; depending on the coupon, Merchant selection, and Affiliate Company's decision, both Affiliates may receive equal commission as Dual affiliates, or each Affiliate may receive a separate commission amount that may be based on the price of the product that each particular Affiliate referred.

The present invention may make use of a minimum threshold before moving on to the next payee and may make use of a maximum threshold for any one payee. It can apply to residuals, or one-time sale. The term threshold may be a trigger point to start or stop, signifying a minimum or maximum value required, as in a cap value.

The Business Model Concept alone can spread to other markets, and other areas of business including but not limited to real estate, buying and selling homes, apartment rentals, stock trading and hedge funds, health care and medical and clearing houses. It may also expand to international trade markets and may be useful for one country to help a third world country, one country to help another country, realty services, for mutual gain and investment over long-term.

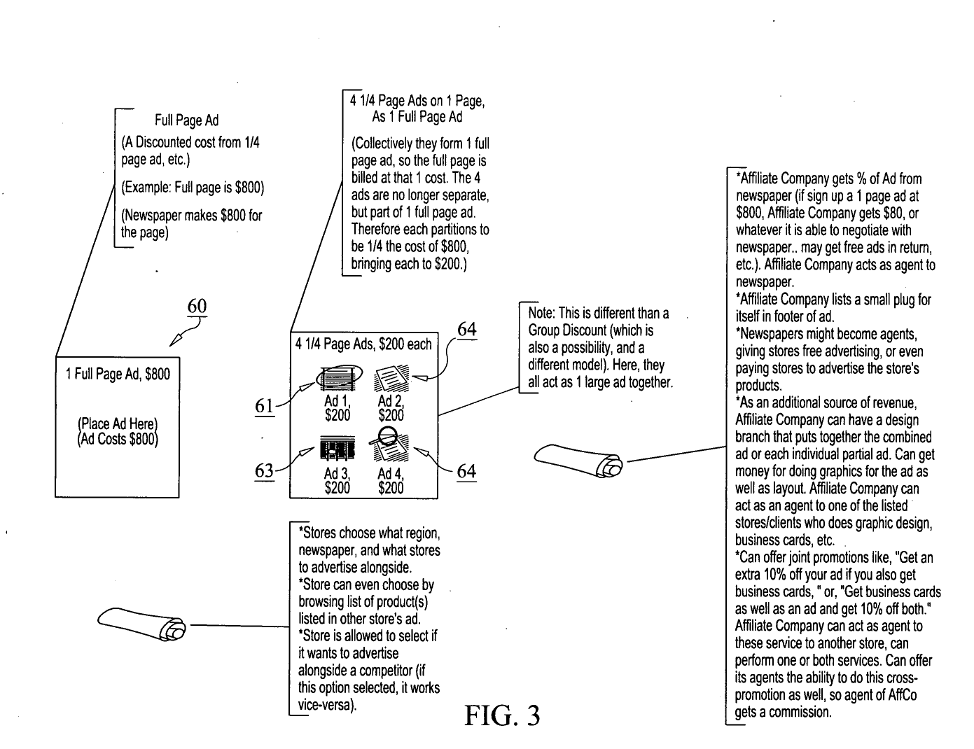

One of the purposes of the present invention is to create a computer implemented networked directory wherein at least one affiliate selects symbiotic referrals and cross promotions. For example, there may be a website where affiliates and merchants can obtain graphics, coupon generation, website design services, legal services, marketing materials and business card printing. This can be directly tied to the Affiliate Company and the Affiliate System itself—the same place a merchant establishes cross promotion in Business for Business, or creates a coupon for an Agent to print and use, can also provide them with these other services—ability to get these services via related companies. So it may be the first Affiliate Company that is not just an affiliate company, but offers cross-promotion to its other services from within the website. Also, users may be offered Adpool options. An example may be for symbiotic business to share ad spots and discounted blocks for print and radio advertisement. For example, a magazine may charge $1000 for a quarter page advertisement. The present invention creates a networked directory where symbiotic businesses may create a pooled ad. For example, a pizza store and an ice cream store in physical proximity to each other may offer ten percent (10%) off as a promotional offer for at least one consumer. The consumer may get 10% off either the pizza store or the ice cream store or both. The pizza store and the ice cream store split the cost of the advertisement one thousand dollars ($1000) to only pay five hundred dollars ($500) each. There may also be a free directory of agent's links, for agents to give to their friends. This may come in a section “Incentives and Features for Agents Provided by Affiliate Company. For example, AgentBob.AffiliateCompany.com has all of Bob's links he can give his friends. (note: agents should have an ID #, and a ‘Avatar’ or ‘Surrogate’ or ‘Screen’ name . . . So Bob is #11709, and “Bob123” . . . . Sally is #5639 and “SallySells”). This Free Directory acts as a webpage, where they can choose what categories (have a suggested default, and they can create their own, and add their own additionals like “My Personal Favorites,” or “Current Great Deals”) and going forward, let them upload their own banner and choose colors . . . and allow them to embed their directory or even just a section of a directory right into their existing site (i-frame or otherwise). For pooled advertisements, Owners can select which region/newspaper/and co-ad businesses they want to run an ad with, or they can opt to let it be random, They can specify a specific business name, or a type of business, they do or do not wish to advertise next to. The system may have a Design Team that can put the layout together and a discount may be offered if they want Affiliate Company's Design Team to design an ad for them. The same concept applies to business cards, website development, etc. We are applying the affiliate systems and methods on itself, provide a percentage (%) Discount for using other services of Affiliate Company). FIG. 3 depicts a pooled advertisement concept. In this example a full page ad (60) costs $800, and merchants have AD1 (61), AD2 (62), AD3 (63) and AD4 (64) and each pays $200. The merchants can choose what region, newspaper and stores to advertise alongside. The affiliate company may get a percentage of the $800 or free advertising. The affiliate company may also be listed as sponsoring the ad or providing the tools to create the ad with the ad, such as with a free plug advertisement of its own in the footer of the ad. The newspaper may provide this free to Affiliate Company for bringing newspaper continued ad sources, or Merchants may collectively cover the payment through their fees on their ads.

The setup of the affiliate program is to generate a referral identifier for exchange between Merchants, affiliates and consumers. This may be on and offline. This may be automatic. The initial fee to subscribe to the Affiliate System provided by the Affiliate Company may be intended to be low (for example two hundred and fifty dollars ($250)). This money goes to the affiliate company. It may be free for agents to sign up, and the agents may get a percentage of sales. There may also be a subscription based sign up for agents. There may also be the option that agents get a percentage of sales or a flat fee. The Affiliate Company may also get a percentage (%) of what the Agent gets. It is a purpose of the present invention to be lower than what competing affiliate Programs charge, to give agents more incentive to use. This also gives more money to the agent. There may also be coupon code creation, for better tracking of Agent sales. This allows for an agent to do a print ad, and not just an online link, helps assure the agent of the sale, also gives customer incentive, as customer now gets a small 2% to 5% off. There are many ways the Affiliate Company can make money. Examples may be: 1. Merchant pays per “Connection”—each ‘network’ they become a part of. 2. Merchant pays per “Venture”—each promo or other venture they embark on. #2 is the most likely. These fees can be monthly recurring for as long as the venture is active or one-time. So conceivably two Merchants can have several ventures with each other at the same time, if they have multiple coupons they are running together. An example of a Connection may be Merchant A forming a relationship with Merchant B, and Merchant A and B decide to them embark on a Venture together by running a Joint Coupon. Another example of a Connection may be Merchant A forming a relationship with Merchants B and Merchant C to form a small alliance; this may count as a separate Connection even if Merchant A and B, and Merchant A and C, already have a Connection.

One of the concerns about the systems and methods may be trust for the ShopOwner, Clerk, Merchant to use or track an Affiliate's referral, and for such a party to remember to login to the Affiliate System Network via the Merchant User Account and apply the sale and the tracking of the sale to the Agent's account. The present invention aims to solve this problem by coming up with a computer implemented system where to activate the code, or to generate the referral identifier, the customer has to login to the agent's site or onto the Affiliate Company's Affiliate System Network site (or have a call in number for those without the internet) and generate a unique referral identifier consisting of the agent's account number. Such activation of a code may occur post-purchase for the Consumer, thereby acting as a Rebate once the Consumer has finalized submitting the data for the purchase to the Affiliate and Affiliate Company. This is not necessary for the system to work, but may be an option for added protection. Consumer may opt in or out of some of the data that is sent to Affiliate Network System. For example; a consumer may not want exact product in an order to be tracked. Consumer may be able to choose to opt out in store or check a box on coupon itself, or online for all purchases, and may make use of this on their Consumer Coupon Card preferences. Consumer may receive higher award if they are willing to allow this data about their purchase be shared. Data may be unanimous. Data collected may assist Merchant in trend tracking, Affiliate in trend tracking, etc.

The present invention may also give agents their own store-front webpage with their affiliate links, where they make the money on those leads by creating a directory of shops and/or products. The term link refers to a website link. Agents may also have the option of buying in to a Reseller plan, where they get commission on Residual sales from a customer who signs up with shop owner. It may also not be bought—it may be the default for no fee to exist in order to become an Agent under that Affiliate Company to get residuals, as with ISO company plans. By example, based on potential existing reseller program, reseller pays $200/yr to resell domains and make residuals for life on customers. Also, the agent can pay a predetermined amount (for example $200/yr) to each merchant or Store Owner it wants to do this for. According to another example, the affiliate company gets ten to twenty percent (10-20%) of this $200.

There may also be a feedback and rating system (54). Customers can leave feedback on product, Merchant shop itself, and agent. Agents may leave feedback on shop owner or Merchant, and product. Shop owner may leave feedback on agent.

There may be a system of joining pooled ads (45), of forming networks and agreeing to relationships like Foundation Account Number, Pool Ads, and more. The system may provide the layout and generation of the newspaper or online ad, business card, coupon, and other materials for a promotion or venture, for a Merchant, Affiliate, or Consumer.

Affiliate Bonuses for Thresholds: Affiliates can get promos and bonuses from the Affiliate Company like a free website. Such bonuses may be achieved once Affiliate makes a certain number of sales or reaches a certain value in sales, thereby crossing a threshold that activates such bonuses to be paid. An example may be once an Affiliate makes $100 in commission from a Merchant (where the Affiliate Company would thereby make $30 in commission from the Merchant if Affiliate Company is to receive 30% of what the Affiliate earns), the Affiliate Company will provide a dot-com domain name registration for free (which may be a $10 value, thereby still allowing Affiliate Company to maintain $20 profit from Affiliate's sales, and encouraging Affiliate to use the website to make future sales to generate more revenue and commissions). By Affiliate receiving an item once a certain amount of sales have been made, it may be acting like a Partnership with Affiliate and Affiliate Company.

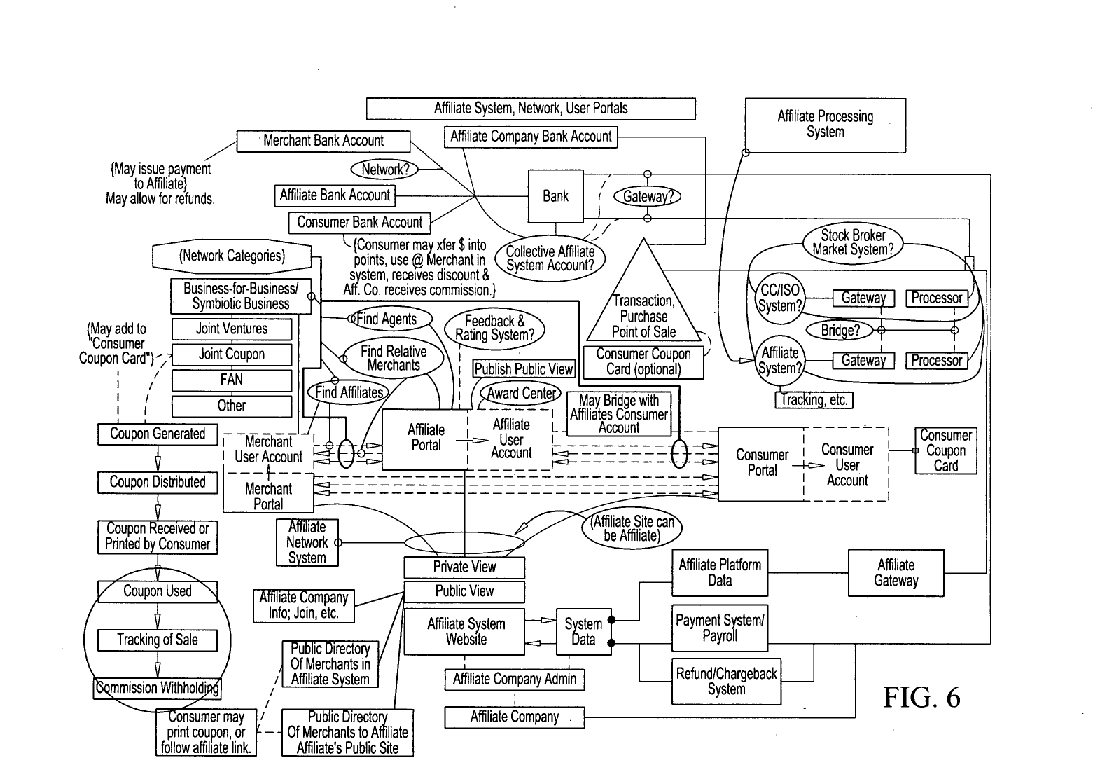

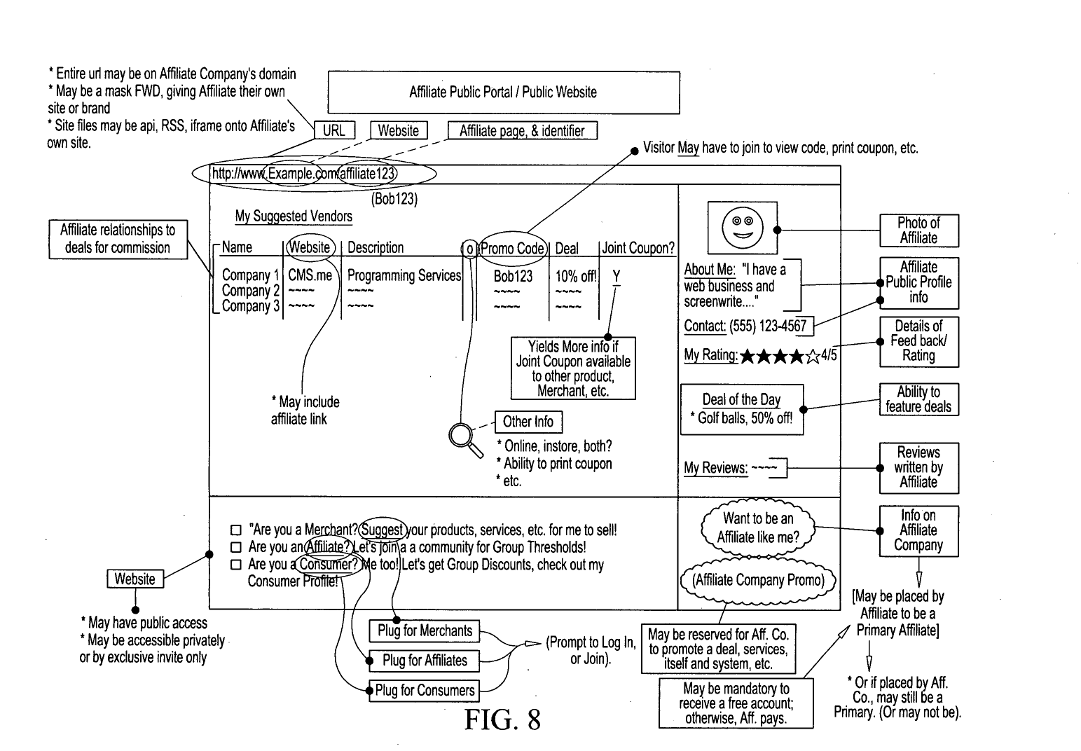

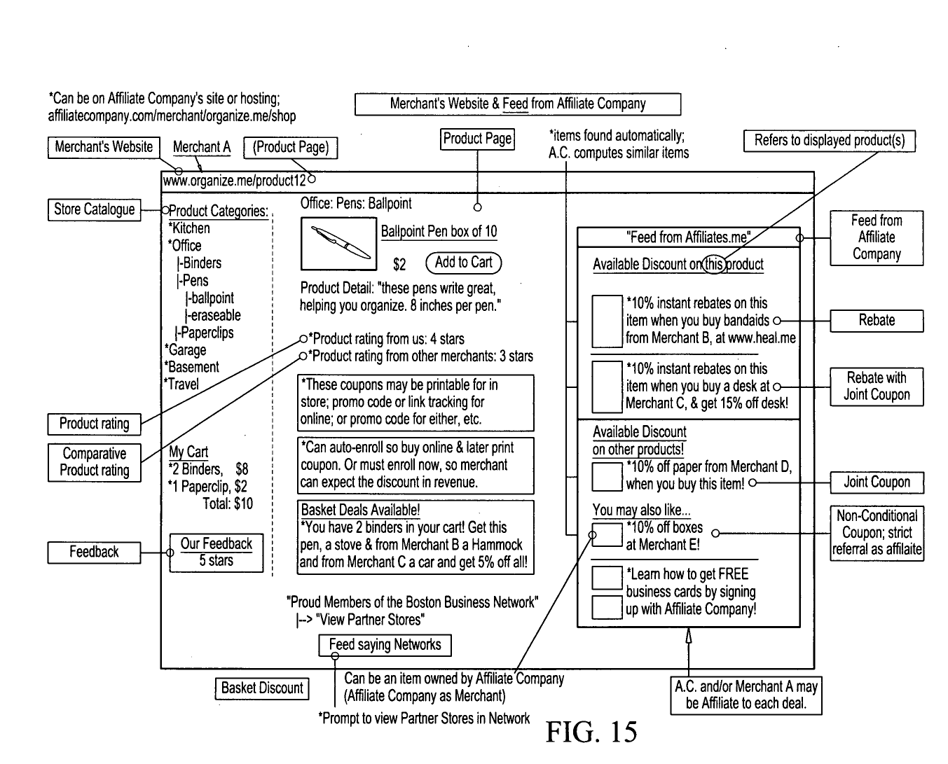

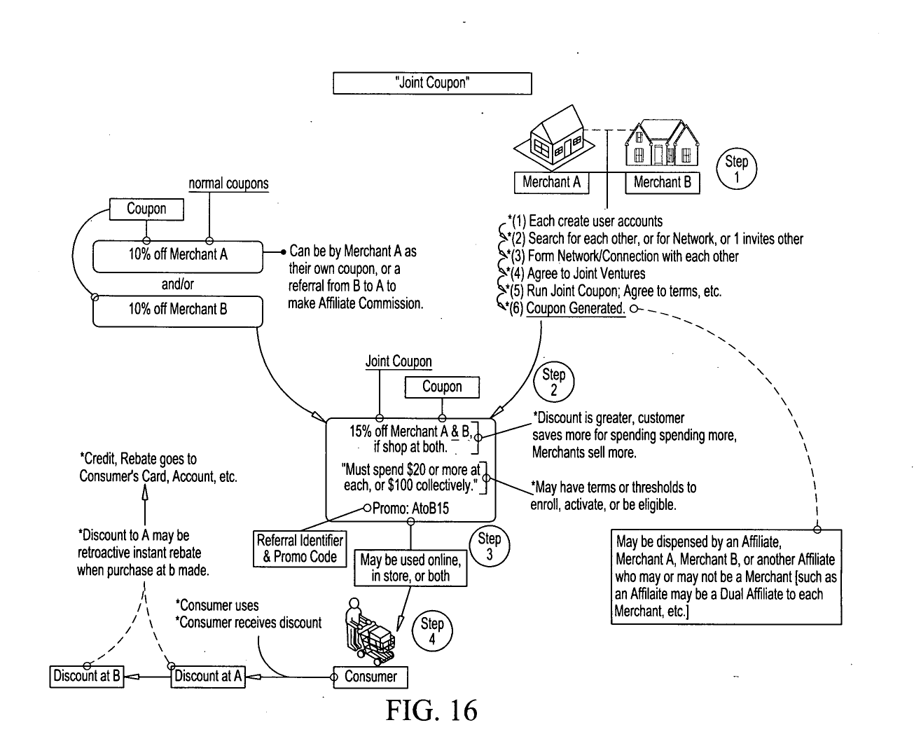

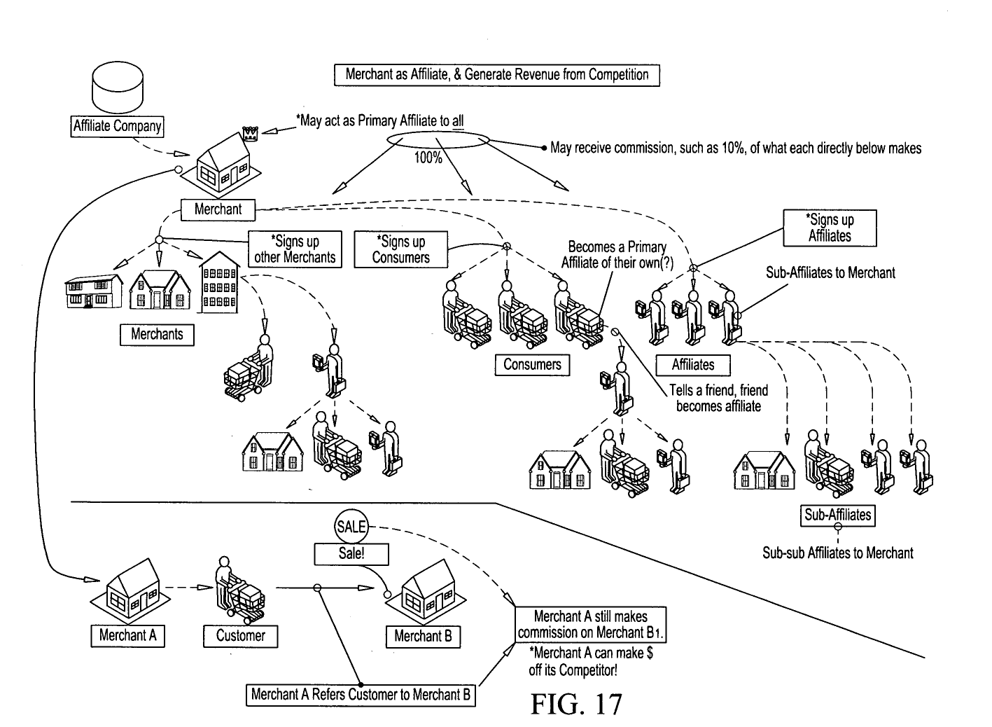

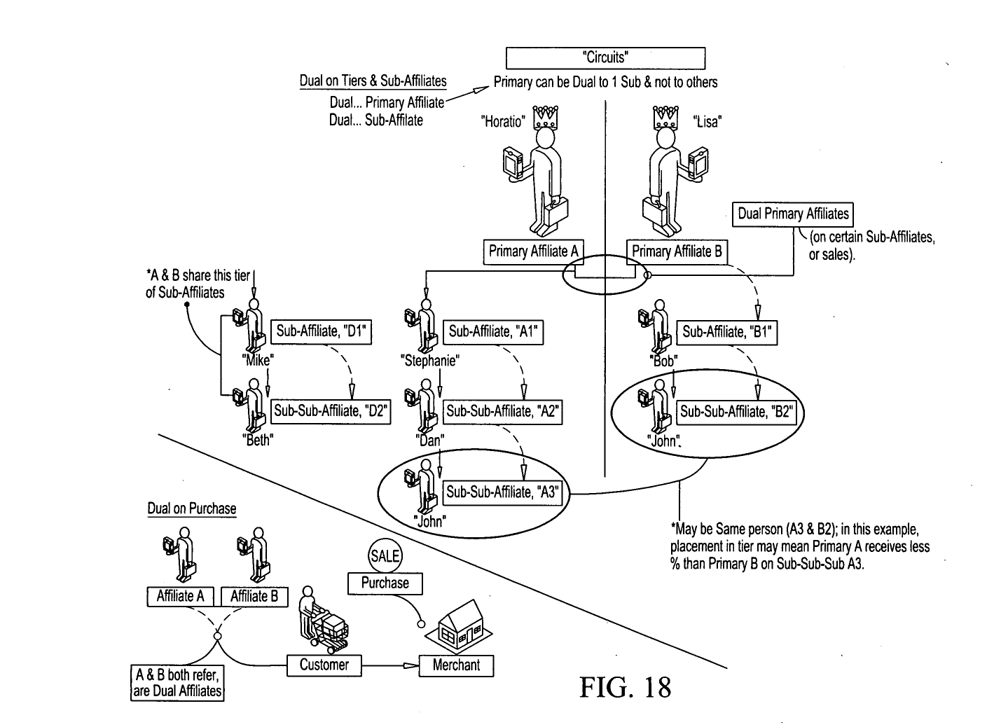

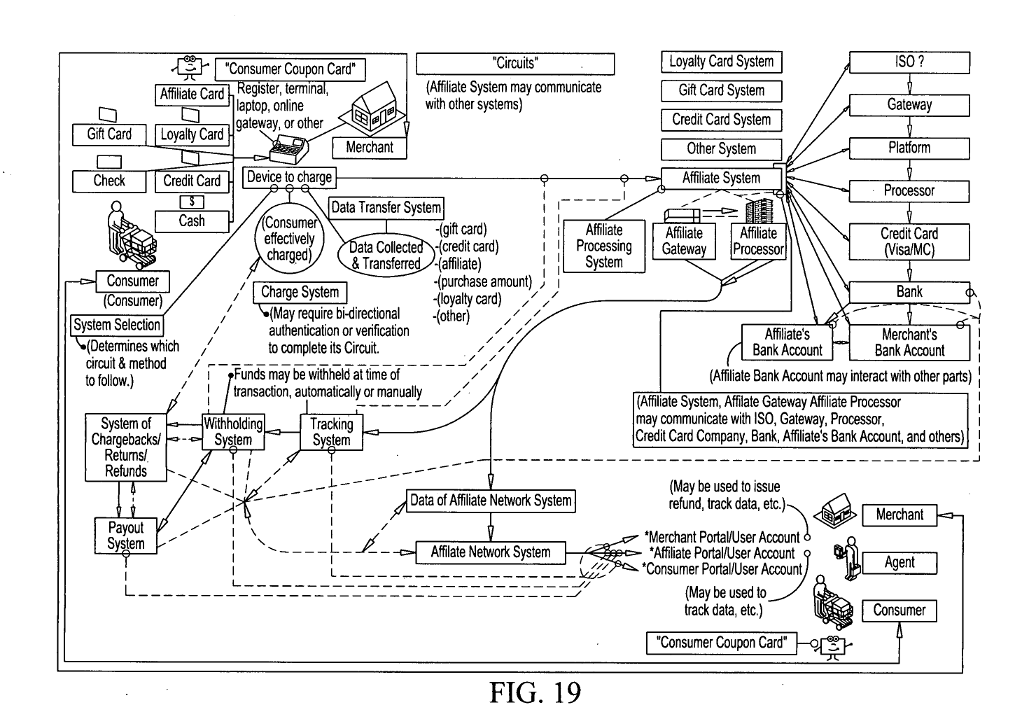

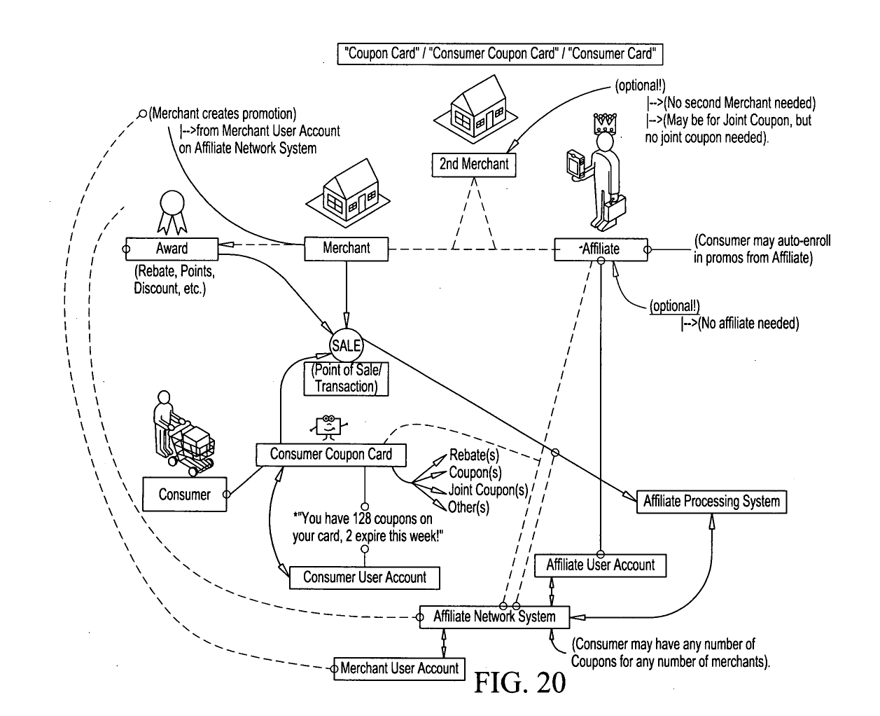

An Affiliate Public Portal is depicted by way of example in FIG. 6. Affiliates (e.g. affiliate company 199) may also have a web page directory (200) of all their “subscriptions to vendors.” They may list all the companies (e.g. 202) with links to the coupons or online links (204), so they can direct customers to their own webpage or website (206) and all listings are there for the customers. This may be individualized per affiliate. The Affiliate can embed it within their own website, have their own domain reside over the site, and more options. The entire URL may be on the Affiliate Company's domain name, or it may be a Mask FWD giving the Affiliate their own site or brand, and site files may be a feed such as Api, RSS, iframe, or other onto Affiliate's own website. The Affiliate may list all deals and relationships they have with Merchants for commissions or other award, and any website links to Merchants from Affiliate Public Website may include an Affiliate Tracking (208) method so that Affiliate receives award for any sales generated (210) after a Consumer follows those links. A Promotional Code may be provided publically, or provided to a Consumer once consumer joins the Affiliate System Network and creates a Consumer User Account. The Consumer may have the ability to print coupon from Affiliate's website, and may view if a deal is good online, in store, or both. The rating of the Affiliate may be presented by the feedback and rating system (212). The website may be publically accessible, or may be privately or by exclusive invite from Affiliate or Merchant only. There may be an optional or mandatory promotion for Merchants, Affiliate, and Consumers to join the website that promotes the services of the Affiliate Company's Affiliate System Network. To make such promotions advertising Affiliate Company optional, the Affiliate may pay for a subscription to the service or may receive the ability by reaching a certain level in sales. A space on the website page may be reserved for Affiliate company to promote a deal, services, itself and the system. Information on the Affiliate Company may be placed by Affiliate to be a Primary Affiliate to any Merchant, Affiliate, or Consumer who signs up into the Affiliate System Network as a result of those prompts, even if it is mandatory that those prompts be in place. Such prompts may be mandatory to receive a free account. By way of example, see FIGS. 8 and 15. The Merchant's website may also have a feed (rss, other) for Affiliate Company to display things from Affiliate Company as well as to display cross-promotions via the feed.

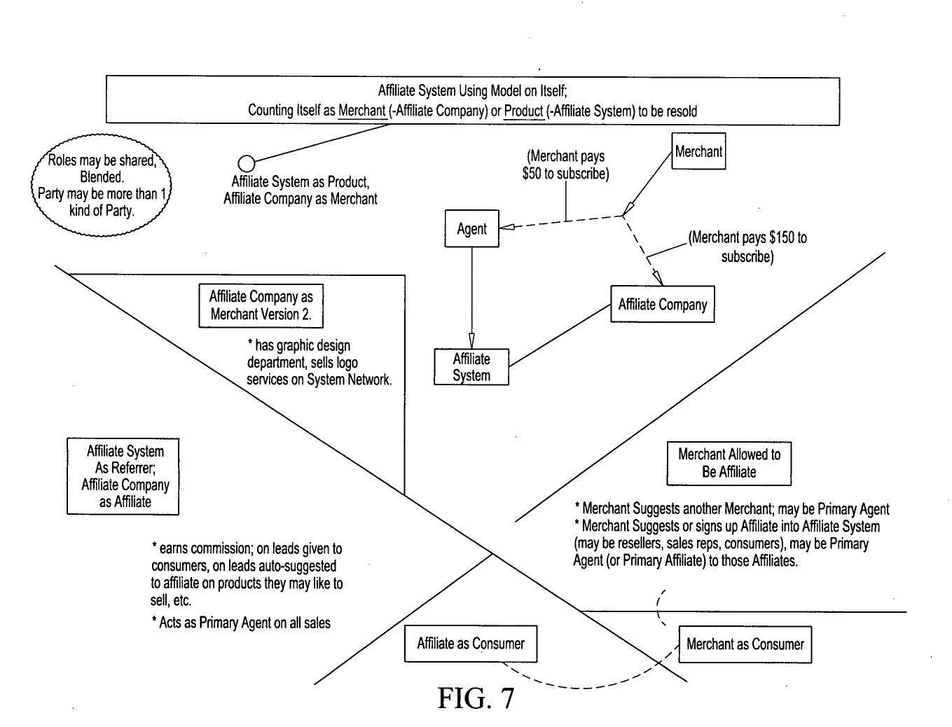

Merchant Public Website may exist, and may reside on the Affiliate System Network, or may be hosted on Merchant's own hosting and domain name. See FIGS. 6-8 as example of merchant affiliate relationships. Such a website may have products for sale by the Merchant, as a directory listing or as an entire e-commerce website where items are ready for immediate purchase, and may list Joint Coupons available with other Merchants that the Merchant may receive an Affiliate Commission on, even if the Joint Coupon is not a venture with that Merchant (it may be a Joint Venture between Merchant A and Merchant B, or Merchant A may be an Affiliate promoting Merchant B and Merchant C, or both). A website for the Merchant may have a mandatory feed that allows Affiliate Company to display suggestions to Consumers of similar items (competing products or non-competing products), and inform Consumer of available Joint Coupons or Rebates. Such promotions from Affiliate Company may provide Merchant with commission as a Primary Affiliate or Sub-Affiliate, or Merchant may participate in a Joint Venture such as a Joint Coupon or Joint Rebate, although these conditions are not necessary—it may be mandatory that Merchant allow such promotions from Affiliate Company to exist, such as for a free or discount subscription, or for participation of that Merchant in a certain network, or especially if the Merchant is hosting the website on Affiliate Company's Affiliate System Network. The present invention envisions and encompasses an Affiliate Company that turns its own model on itself The subscriptions may be resold. The Affiliate Company may take on sub-affiliates and thereby act as a Primary Affiliate itself by getting other affiliates on board. An Affiliate may be a Primary Affiliate to any other Affiliates (thereby Sub-Affiliate) that Affiliate gets to sign onto the Affiliate System; thereby the Affiliate receives a commission for each Affiliate (Sub-Affiliate) and Merchant and Consumer it signs into the Affiliate System Network, and acts as a Primary Affiliate to each Merchant, Consumer, and Affiliate that those recruits bring into the Affiliate System. An Affiliate may receive a commission or award by getting a store (Merchant) signed up on the Affiliate System (one store can sign up its neighbor store), thereby acting as Primary Affiliate and getting a commission for all sales done by Store B that use the system, or if Store B does a cross promo with Store C then Primary Affiliate Store A gets some commission etc. Another example may be a Primary Affiliate goes to Chicago and starts a Chicago branch, recruits other Affiliates. Each store that signs up pays $100/yr subscription to Parent Affiliate Company, the Affiliates of Sale get a commission on that $100 as does the Primary Affiliate. This is the first affiliate company that lets Affiliates make a commission on selling its own services. Another incentive structure may be to offer lower rates for credit card processing for agents and sub-agents; for Example an Affiliate Company may also own an ISO Company for credit card processing, and a Merchant who signs up a threshold of, by way of example, 5 other Merchants and 10 Affiliates and 20 Consumers into the Affiliate System receives discounted rate of 0.05% above base cost on their credit card processing (which may be accomplished by simply giving a base cost or a little above the base cost, or cutting the margin between the base cost and the Merchant's current rates in half), discounted from perhaps 0.20%. In this last example, and Affiliate Company is not just an Affiliate Company, it is also an ISO company in addition to being an Affiliate Company, therefore Symbiotic Business is achieved by becoming more than one type of provider and providing entirely different services that may not normally be seen as going together. (See, for example, FIG. 7).

A pooled advertisement may be where an Affiliate Company takes part of the sign-up fee, maybe $50 of it and invests in an Ad for new client. By way of example, the Pooled Ad can promote that “Shop123 just signed up its affiliate program, become an agent for Shop123 today and start making $!” This promotes the business to regular customers for products, promotes the business to prospective agents, promotes Affiliate Company. Offer customers $50 or $100 of Free Online Ad Campaign credit, to give to ShopOwners on sign-up AND to Agents on account creation.

One of the advantages of the present invention is the replicability of the Affiliate Company and the Ability to Rapidly Spread. The Affiliate Company is a shop that is listed to Agents themselves. Agents make commission on each new merchant they sign (the terms store owner, shop owner and merchant are interchangeable). Agents can have added discount to offer Store Owners; a predetermined amount (e.g. fifty dollars ($50)) extra to go towards whatever. If the affiliate makes $250 for a New Store sign up; $50 goes to sub-affiliate, and $50 goes to StoreOwner. The affiliate company only makes $150. Merchants and customers can be Agents. If the customer uses a store regularly, the merchant now gets a discount. Shop Owner can determine if agent can get discount on their own purchase. Usually, it's yes. Now customers are encouraged to tell their friends about services they like. If I know a good barber, and I know my co-worker needs a haircut, I'll remember to tell him about my barber. So now, Agents all over the country have incentive to sign up new ShopOwners. ShopOwners are encouraged to sign up their neighbors. A customer who is signed up by an Agent into the affiliate system, if customer sign ups can exist in the system, can thereby activate the Agent to be a Primary Agent, where that Primary Agent gets a commission on any future coupons/deals offered by via any other Agents. There may also be some new ideas on how the Affiliate Company advertises for example, Free Ads for Affiliate Company, Agents will invest in Online Ad Campaign (some can even use the Free Online Ad Campaign Credit we give them at sign up). A small blurb promoting the Affiliate Company may be placed in each pool ad that is published in print, radio, television, web, or other means. There may also be free advertising for Affiliate Company in ads.

There may also be a learning center on the Affiliate System Network website available to Merchants, Affiliates, and Consumers with Books and Tutorial, Online Ad Campaign Tricks, SEO methods, Marketing Materials, or trainings on things such as How to Market. There may also be a feedback rating system where customers rate the product, merchant, affiliate, and overall experience.

One of the many unique aspect in all of this, is the sub-agency pricing scheme and the Reseller pricing scheme. Also unique is having Affiliate Tracking through an ISO; online and in the real world. And having affiliate tracking in the real world, through manually logging in or through ISO or other means. Also unique is having separate business entities working together; joining the two yields a discount on the products/services of one, or the other, or both. True for the company, as well as for how the company gets businesses to work with each other symbiotically. For Example; a shoe store and a belt store may work symbiotically (“Symbiotic Business”) by running cross promotions with Joint Coupons. Another Example may be an Affiliate Company also being or owning an ISO Company; so that the Affiliate Company can give its member Merchants a discount on their credit card processing fees, or as an ISO company may provide Merchants with a discount to its subscription to the Affiliate System Network—or both sets of discounts on both separate systems (the ISO and the Affiliate Program) may exist to the Merchant.

Some of the advantages may be by offering side-businesses, affiliate company can charge less for each type of service offered, there may be near-base cost on credit card processing, near-base cost on web design services, logo creation, etc., some of which can even be outsourced, to save additional costs if needed where then in-house (to the affiliate company) designers make their money by managing others, near-base cost on all other services, each one of these side businesses wouldn't make much on its own, as it is Near-Base-Cost, but combined, it makes money. Also, the services are all related to each other. Buy into one, you now know about the others, and that provides a loose referral network. An Example may be an Affiliate Company owning a print shop, and therefore allowing the subscribing members to the Affiliate System Network (such as the Merchants and Affiliates) to receive free business cards or discounts on their printed materials. This may even allow Affiliate Company to provide bonuses of business cards to an Affiliate once a certain threshold is reached. Another Example may be the Affiliate Company receives 10% commission for any referrals to a car rental service, and alerts Affiliates, Merchants, or Consumers who browse for hotel rentals on the Affiliate System Network Directory that such a car rental service exists in the desired region where the hotel may be located. A third Example may be an Affiliate Company that owns a print shop, domain registration, ISO, phone company, lawn care service, and office supply store and therefore offer members of the Affiliate service great discounts at next-to-base cost; because the Affiliate Company has so many products and services available, it becomes a ‘one-stop-shop’ for Consumers when they need something, and likewise may provide further discounts on the Affiliate Company's own internal Joint Coupons when seemingly unrelated products and services are purchased (such as a Consumer purchasing a box of pens and ordering a lawn care service package yielding discounts on both services to Consumer).

Some of the advantages to agents may be their own directory site, a URL for their directory site, a domain name (at base cost), or a domain name for free once they reach a predetermined amount of money ($x) in sales. The agent can also choose to be a reseller (in some cases, where stores participate). Some of the promotions for agents may also be that it is free to join, free to make sales; No need to invest ANY money, free; website (Portal page) with a customizable look and feel possible. There may be a free domain name, once the agent makes a predetermined amount (for example a $60 commission). It may be required that the agent makes at least $60 annually. The amount is subject to change. The Affiliate Company may raise its minimum rates for free domain name eligibility accordingly. Affiliate Company may receive 30% of what the agent receives from the merchant. $60×30%=$18 . . . $15 covers 2 yrs of the domain, and gives a very small $3 profit on top of it in case they take the domain name and run. The two years gives them a one year buffer. The domain may also only be used for Portal Page and Owned by Affiliate Company. Once a predetermined threshold amount (such as $100 commission) is met the Agent may own the domain. An unregistered store owner may start themselves as an agent (Affiliate), then sign themselves up as a store owner (Merchant) on Affiliate Company and make the $100 commission on themselves, then get the domain name for free. Agents may be offered incentives; free domain once $100, or something every milestone in sales. Once they reach $1,000 they get their choice of mp3 player or iTunes, etc. This provides a built in reward program.

The Store Owner (a person) or the Merchant (a business) may be an affiliate, may get other stores to sign up to Affiliate Company, and get a commission from Affiliate Company for that. The store owner or Merchant may then be a Primary Affiliate to anyone that subscribes into the Affiliate System Network as a result of their promotion of the system. This may encourage a store owner to entice some of a store's energetic, loyal customers to become Agents of Affiliate Company, possibly even giving its consumers a discount on a purchase by becoming Affiliates or Consumers on the Affiliate System Network (providing Consumer with a discount or a retroactive Rebate); and providing Merchant with status of Primary Affiliate to that Affiliate or Consumer in the Affiliate System Network, where Merchant receives a commission on each purchase made by that Consumer in the system even if purchase is made at other Merchants, and Merchant may receive commission on any Sub-Affiliates that Consumer or Affiliate signs onto the Affiliate System Network. Even if a Consumer of a Merchant signs onto the Affiliate System Network as a Consumer, Merchant may receive commission on them as a Consumer, and Merchant may earn commission on Consumer as an Affiliate if Consumer ever becomes an Affiliate or if Consumer ever takes on Sub-Affiliates. A Consumer or Affiliate may be a person, business, or other entity. Customer is then an Agent in their own right but also a Sub-Agent to the Store acting as an Agent. So the store gets ten percent (10%) of everything that agent now makes, whether it is a purchase from their store, or another store, and the store may now be considered a Primary Affiliate. This means that if a customer, or sub-agent, ever starts flocking to sell the competition, the Primary Affiliate store still makes money. Conceivably, a Store could send customers to its competition for overflow and still make money. Especially if set up as a Reseller to that store. This creates friendly, symbiotic competition, where competitors actually refer to each other, and become partner businesses. A high end restaurant can refer overflow to a low-end restaurant and vice-versa; as they are different targets. An auto mechanic who excels at body shop refers clients to another mechanic who specializes in engine repair or oil changes, and vice versa. Repair is done better, by someone in that niche. This may enhance the quality of product delivered to consumer; consumer may therefore receive a better product, possibly with a discount on top. Time may then be opened up for referrer to work on other projects. Referrer still gets money from commission percentage (%). Customer possibly gets product or services for lower rate. The Customer is happy that the service is done by the right person or business. Another example may be to offer a free domain at startup. Give a choice to consumers: Free domain, or free shipping on 100 free business cards, or something else, either way, a predetermined amount of value (for example, a $7 value). This could also be for special promotions, coupon codes for agents to offer.

The feedback system allows agents to bring cost and quality to balance in order to sell. The Quality of product may be rated in the feedback system by Consumers as well as by Affiliates. If product is not good enough, customers won't buy or will leave bad feedback for the agent, product, and store owner (or Merchant). Agent enticed to sell quality stuff. Customers now know if their money cost bargain comes with a sacrifice to quality, or not. The feedback system may also track the number of and volume of sales, Profit margin, Cost of product and better business bureau.

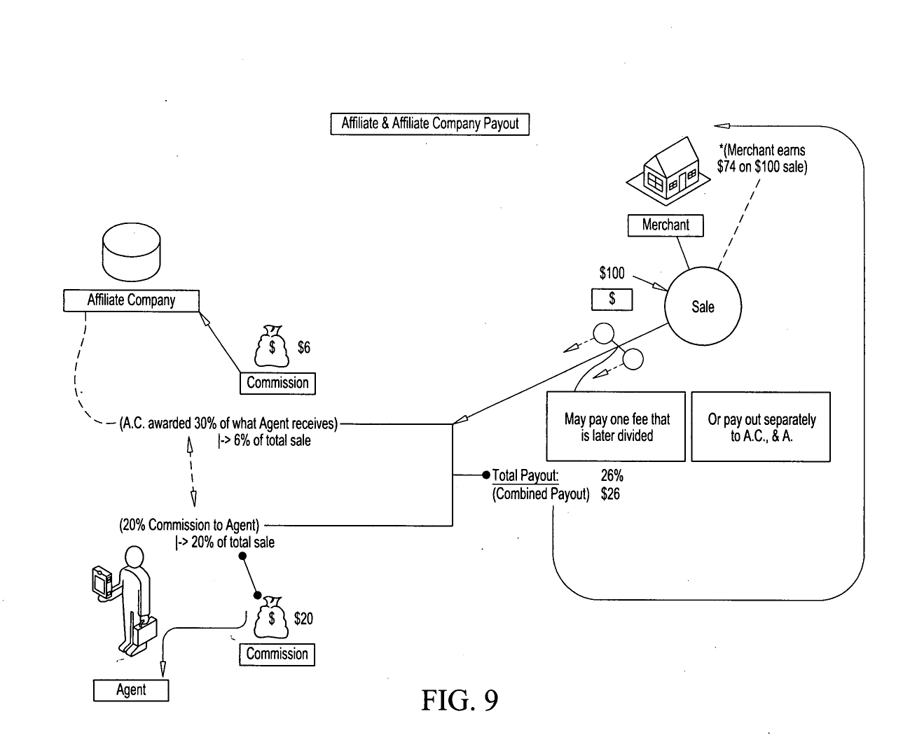

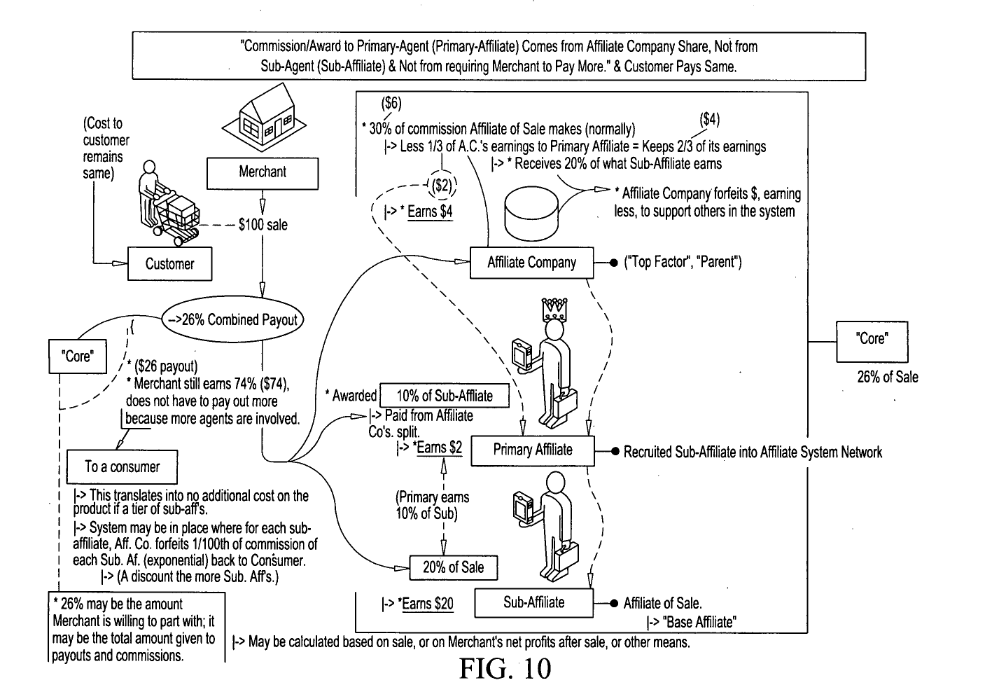

In a Basic Affiliate and Affiliate Company Payout Structure the agent gets a “payout”; paid commission or other award. Commission is negotiated by Shop Owner (or Merchant), the Commission may be a percentage (%) of each sale cost (for example, typically might be 20%). The percentage (%) of each sale's profit. Affiliate Company gets a percentage (%) of what the Agent's payout is from the Store. Typically could be 30% of what agent gets. An example of Payout and Combined Payout: If 20% commission to Agent: If a Store Owner lets an agent receive 20% commission, then agent gets $20 of a $100 sale. Affiliate Company then gets 30% of that 20% (30% of the $20) . . . being $6 that goes to Affiliate Company (Affiliate Company gets 6% of the total sale). So, the Agent gets $20 (20% of sale), Affiliate Company gets $6 (6% of sale), combined Payout is $26 (26% of sale), agent gets 20% of the Store's sale, Affiliate Company gets 6% of the Store's sale (30% of Agent's payout). This is a 26% combined payout. So if an Agent is allotted 20% by the Store, Store's combined payout of Affiliate Company and Agent is 26% of the sale. If 10% to Agent: On a $100 sale, Agent gets $10. Affiliate Company gets 30% of $10, So Agent gets $10 (10% of sale), Affiliate Company gets $3 (3% of sale), Combined Payout is $13 (13% of sale). Affiliate Company may provide Merchant with tools such as an “overhead and profits calculator” to help Merchant calculate overhead costs, and deduct overhead and payouts from gross to show Merchant final net profits to Merchant; this may be used to assist Merchant in maintaining profitability, and in determining what commission rate to offer Affiliate. By way of example, See FIG. 9. A sub agent may be the same as the agent. A sub-agent does not necessarily make less money than an agent, a sub-agent is an agent. Affiliate Company forfeits a percentage (%) of what it would make from the Publisher, and gives that to the Agent. Yes, we have just applied our own business model to ourselves, for the benefit of the Agent and Sub-Agent, allowing both to make a fair amount of money. 10% is a very solid incentive, whereas 5% may psychologically sound low, this is to be determined by the parties. 10% tells an agent “If I get 10 sub-agents, I'm making 100% of one entire Agent.” An example of Payout and Combined Payout is as follows: If twenty percent (20%) to Agent: If a Store Owner lets a Sub-Agent (who is an Agent in its own right) get 20% of a $100 sale ($20), and Affiliate Company gets 30% of what the Sub-Agent gets ($6). Affiliate Company gives 10% of the cost of the Sub-Agent's payout to Primary Agent. 10% of $20 is $2. Another way of saying it: Affiliate Company gives ⅓ of its earnings to Primary Agent; $2 is ⅓ of the $6 (and the $6 is 30% of the Sub-Agents payout). Another way of saying it (2): Affiliate Company gets 20% of what the Sub-Agent gets, Primary Agent gets 10% of what the Sub-Agent gets. So, $20 goes to the Sub-Agent, $4 goes to Affiliate Company, $2 goes to the Primary Agent. The Combined Payout is $26, Store still only pays $26 in combined payout, and no more. Store only has to pay the same combined payout of 26% of the sale; no additional payout, as Affiliate Company is the one forfeiting some of its profits to the Primary Agent and any potential mid-agents in-between the Primary Agent and Agent of Sale. The percentage may be a percentage of the sale or of a profit margin. This may be particularly useful for residuals earned on an ongoing customer in the system, that percentage (%) split (also called Core) may be profit margin on an item a store would make, not the sale value of the item a customer pays. This is the difference between Gross Profit and Net Profit. By way of example, See FIG. 10.

There may also be a sub-sub-agent arrangement. Agent does not get paid as a percentage (%) from Sub-Sub-Agent's commission on each sale. Rather, Agent gets paid from Sub-Agent as a percentage (%) of the Sub-Agents payout (rather than sale). This lets the Sub-Agent take on Sub-Agents of their own, effectively acting as Sub-Sub-Agents to the Agent. The Agent thus makes a small percentage (%) on these Sub-Sub-Agents. The Agent now has a good reason to encourage Sub-Agents to take on Sub-Agents of their own. Agents may be able to see the sales performance of its Sub-Agents and Shop Owners may be able to see sales performance. This may be the number of sales but not what particular businesses shop, it may not be confined to sales at a particular Merchant.

Currently, agents to ISO companies and Affiliate Companies (and other markets), have been generally limited to individual people. The present invention allows for the entity as an Agent such as a Store (a Merchant may be an Affiliate), Non-Profit such a Non-Profit as an Agent/Affiliate/Reseller (a Non-Profit may be an Affiliate, Primary Affiliate, or Beneficiary Affiliate) where commission or money goes to that charity. This can be a tax write-off for ISO, Affiliate Company, agent, merchant, store owner (especially if ISO or Affiliate Company has put this relationship in place), and/or customer (if Affiliate sale). Or a joint tax write-off or shared tax write-off of several of such parties. This may be applied to churches, sorority, or any other charitable organization. Affiliate Company may automatically provide or disperse forms for tax-write-off to Merchant, Affiliate, Consumer, Non-Profit and send a copy to the government, accountant, or tax software for instant deductions on taxes. Charity may be a Primary Agent, or an Elected Dual Agent or Elected Primary Agent where the Charity always gets a % of the profits for the purchase; in this way, Charity may be a “Beneficiary Affiliate.” Merchant can select the Charity, Agent can select, Customer can select; or a combination of Merchant, Agent, Customer can select; more than one Charity can be selected. For example, it is decided that 15% will collectively be given to charities from the split; a Merchant chooses “Rutgers University English Department” to benefit 5%, Agent chooses “Bonobo Conservation Initiative” to benefit 5%, and Customer chooses “Eagle Scout Association” to benefit 5%. Or it may be determined one party may have a higher designated amount allotted to the charity of their choice; For example a charity of Merchant's choosing may benefit 10%, Agent's choosing 2.5%, Customer's choosing 2.5%.

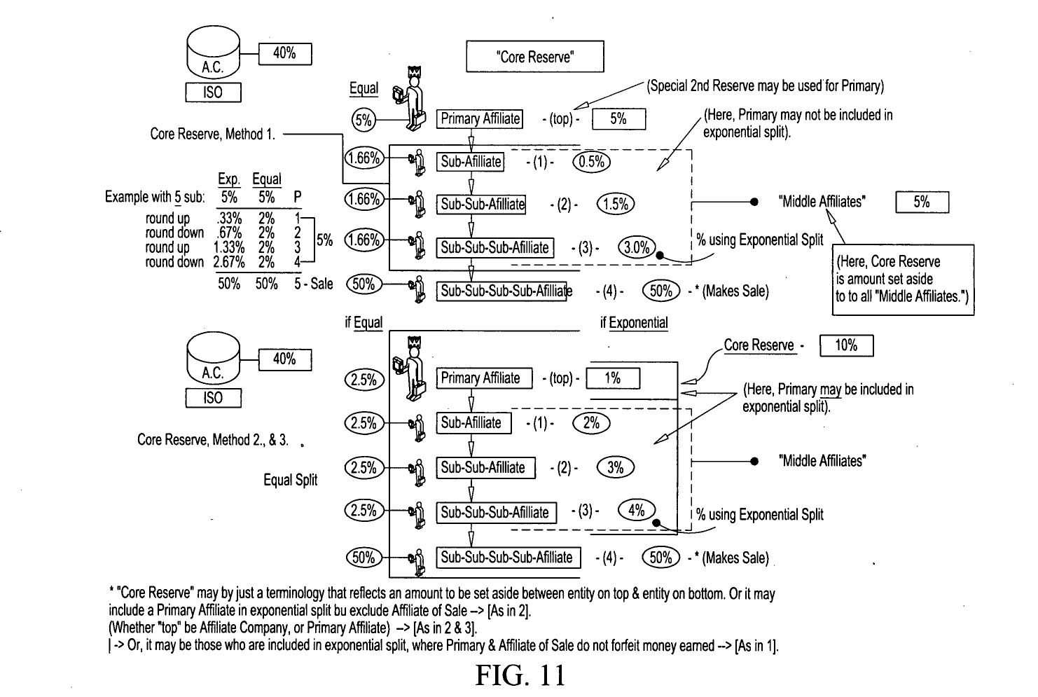

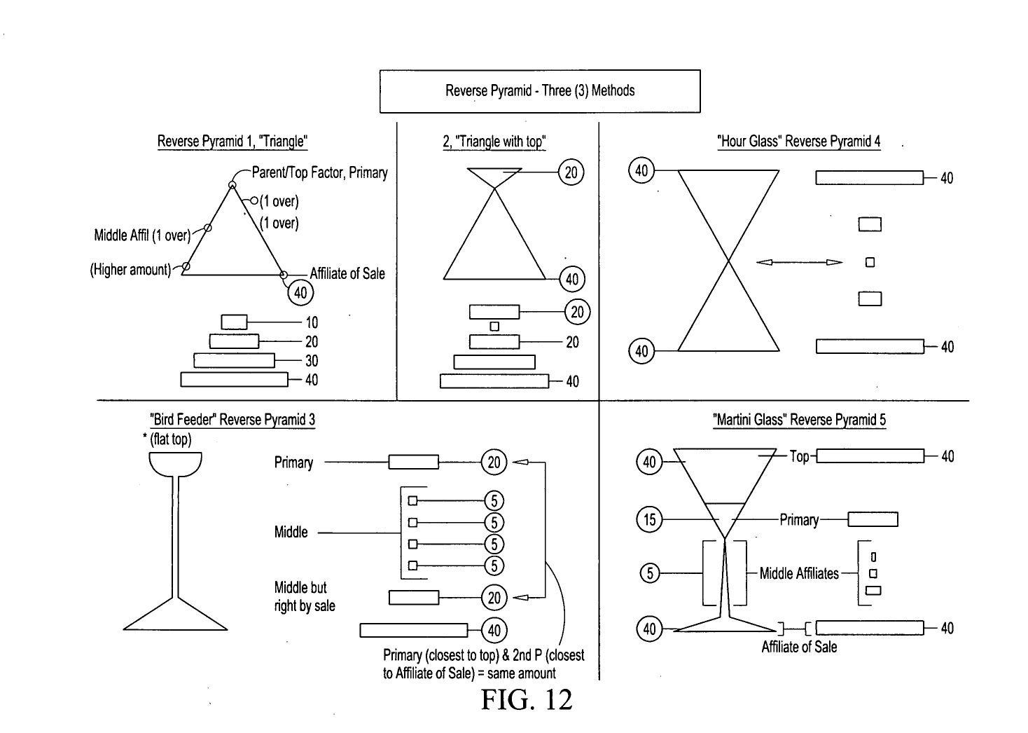

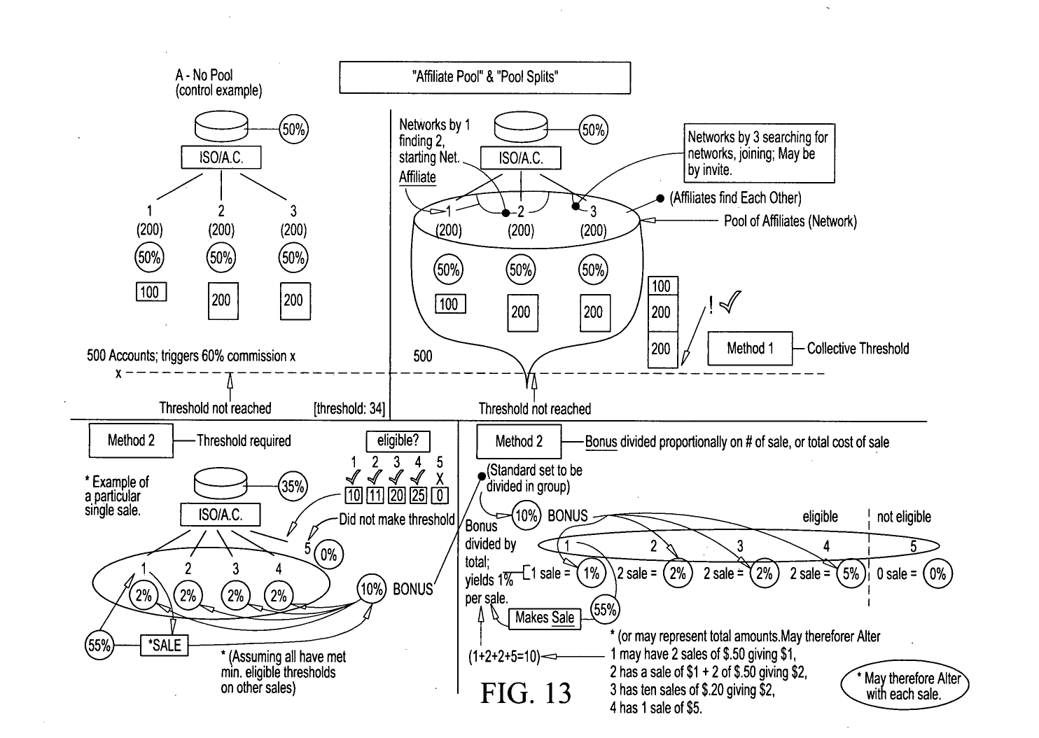

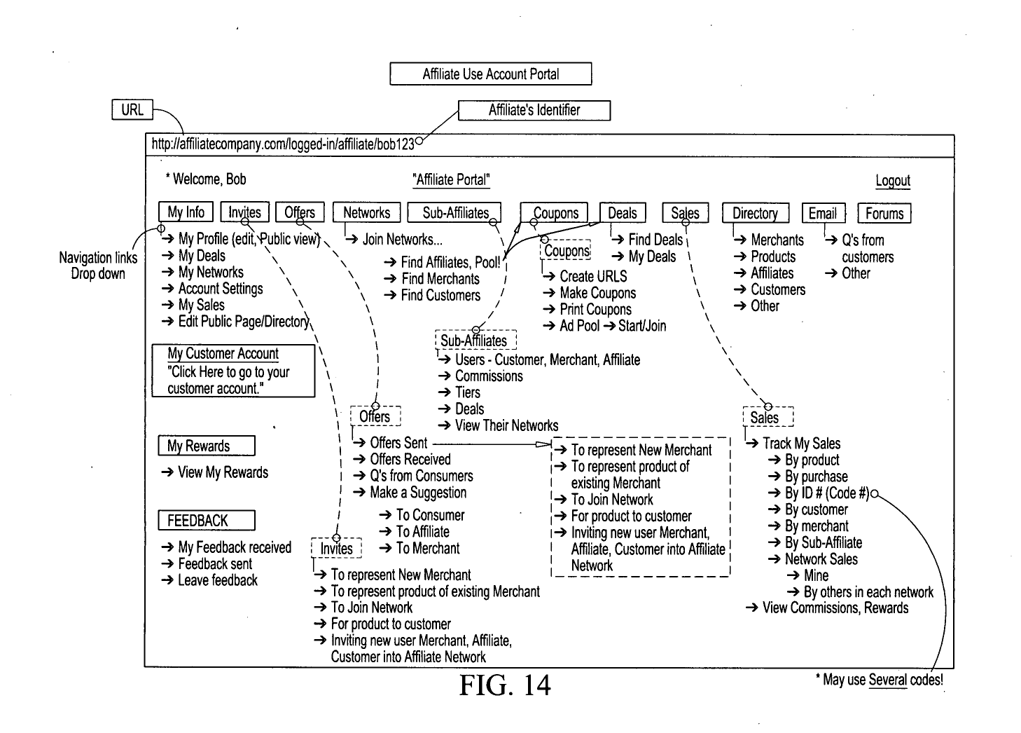

According to another method, there may be a core reserve with an Exponential Split. The ISO may get forty percent (40%) of the Core, the Primary Agent may get five percent (5%) of the Core. In this example, the Core may be any Net Profits after payouts to any 3^{rd} parties like Visa/Mastercard and Merchant materials cost. The Core Reserve may be split among Chain of Sub-Agents. For example, if the core reserve is 5%, the Sub-Agent1 may get 0.5%, the Sub-Sub-Agent2 may get 1.5%, Sub-Sub-Sub-Agent3 may get 3.0%. The Core Reserve is Split exponentially among Sub-Agents, starts closest to Sub-Agent-of-Sale, although it may start closest to Primary Agent. The Sub-Agent-of-Sale (Agent4 in this example) may get 50% of the Core. In this above example, Primary Agent and Core Reserve match, so that the Primary Agent makes the same as those others if those others are collectively combined. This needn't be the case; it can go one way or the other. Any formula may be used to derive different options for a Core Reserve split. (See FIG. 11).

By using the Core Reserve: the Merchant never has to pay out more just because there are multiple tiers of sub-affiliates than they would if there were no sub-affiliate; the Consumer never has to pay more for a product or service just because there are multiple tiers of sub-affiliates than they would if there were no sub-affiliate (as Merchant does not have to raise product cost to remain profitable, since the payouts owed to Core is not greater); Affiliate of Sale always makes the same as if there were no Superior Affiliates residing over them; and the Primary Affiliate on top may always make the same, or may be included in an exponential split with those sub-affiliates in-between Primary and Affiliate of Sale (an Affiliate of Sale is the one who makes the Sale or the one who is closest to the transaction, a Primary Affiliate is the Affiliate closest to Parent company or Top Factor, in this case the Affiliate Company). The Affiliate Company (Parent or Top Factor) covers the cost difference from its own commission for the Primary Affiliate, as well as any sub-affiliates in-between Primary Affiliate and Affiliate of Sale (the sub-affiliates in-between Primary Affiliate and Affiliate of Sale may be referred to as “Middle Affiliates”). Affiliate Company may afford to do this by an exponentially split of each sub-affiliate over the other sub-affiliate; the commission percentage (%) reduces in amount each time it goes up a tier (or another way of seeing it is the commission percentage (%) increases each time it gets closer to the Affiliate of Sale), and the amount can never surpass a certain threshold; the Affiliate Company considers and plans for a possible expense toward this Core Reserve (and/or Primary Affiliate).

Another example of an Exponential Split of Core Reserve may be derived by establishing 15 points total; giving 1 to Agent 1, 2 to Agent 2, 4 to Agent 3, 8 to Agent 4; An exponential divide that gives ½ to the Agent above in the chain (aka double to the Agent below in the chain). The core reserve may be split among chain of Sub-Agents: There may be a 5% Core, which Sub-Agent1 receiving 0.33%, Sub-Sub-Agent2 receiving 0.67%, Sub-Sub-Sub-Agent3 receiving 1.33%, the Sub-Sub-Sub-Sub-Agent4 receiving 2.67%, As one split rounds up, the next rounds down, perfectly balancing out to reach the 5% Core. This is flexible and can be changed. Any excess or loss may be taken from any Stage (Primary, Sub-Agent1, ISO, etc.), to balance out in other cases using other methods or formulas.

Another method may be a Core Reserve with Equal Split which may be split among a chain of sub-agents: For example with a 5% Core, Sub-Agent1 receives 1.25%, Sub-Sub-Agent2 receives 1.25%, Sub-Sub-Sub-Agent3 receives 1.25%, Sub-Sub-Sub-Sub-Agent4 receives 1.25%, the Core Reserve is Split exponentially among Sub-Agents. There may be more than one Primary Agent (This is applicable to any model or method in the present invention). As with everything else in the present invention: each point may be combined with another model or point.

The primary may get a percentage (%) of the Core from ISO/Affiliate Company. The Agent, or Sub Agents, in some cases, where Agent ALSO gets Core. There may be two agents at core. There may be agent trainer and agent, the Absolute Closest. There may be someone else, so three (3) get Core of ISO/Affiliate Company. Sub Agent 1 gets percentage (%) of the commission Sub-Sub Agent (Sub Agent 2) makes. On sale, and on percentage % of its Sub-Agent (Sub-Sub-Sub Agent/Sub Agent 3). Sub-Sub Agent (Sub Agent 2) earns percentage (%) of Core, less Sub-Agent 1's cut. According to another embodiment, percentage (%) of Core, Agent 1 gets percentage (%) of Core as well (2 agents). According to another embodiment, percentage (%) is divided. There may be several split options. According to one Split option, it is divided with exponential disbursement.

There may be a reseller pricing scheme in which agents can make 20% on 1 transaction, or 2% for life thereby receiving life-long residuals for the duration of the referred consumer, affiliate, or merchant in the system. This may be an option proposed to Affiliate to choose from, and may be a decision made on each deal. If money is paid to affiliate company and store to do reseller program. There may be an annual fee. There may also be a payment pricing model, with incentive and formation of residuals. If agent signs up a store, agent gets x % (of Core, or of Affiliate Company's profits) generated through that store. There may also be a relationship establishment model wherein one agent must agent sign up via another party. For example, a store must be signed up by an agent; this forces a store to find an agent to sign it up; in this example, if the Merchant wants to become a Merchant advertised of the Affiliate Network System, the Merchant must find an Affiliate to exclusively sign that Merchant on to the system. It may also be optional for Merchant to use agent in order to be signed on the Affiliate Network System, but a discount may be offered to the Merchant if the signup is done through the agent. If there is a sign up by agent the store gets x % Core back to itself. If there is a second agent, a predetermined percentage x % of the Core goes back to itself. The Agent can be a Primary Agent to that agent, or any other agents. There may also be incentives once they get a predetermined number (e.g. 10) of agents. A Primary Affiliate may receive a bonus once they reach the threshold of a certain number of Sub-Affiliates signed into the Affiliate Network System; and in another example a Merchant may receive a discount to Affiliate Company fees or a bonus from Affiliate Company once that Merchant has reached a certain threshold of Affiliates representing that Merchant or a certain number of sales sold through the system or both a certain number of sales from a certain number of Affiliates. This may be split of Core, monetary bonus, right to be a Primary Agent to those agents (or sub-affiliates), promotions like free website or other services.

The payment model may also be an exchange of services. This may be a percentage of gross and/or a percentage of profit. There may be a threshold on each (e.g. a minimum and/or Maximum). The cap (or threshold) may be regardless of years, through a certain number of years, and have a cut-off, it may also be annual, or other periodic, with a percentage (%) over that year. There may also be the option that the payment model may start with one type of pay (such as gross), and switch to the other type of pay (such as profit) at a set point (such as a dollar amount).

Groups of Affiliates may exist. There may be a pooled community of agents, and may also be referred to as a Network, Pool, Community, Group, Association, Alliance, Chamber, Union, or other such combined formation of Affiliates. Here, the Affiliates closest to the sale (those typically considered to be on the bottom) may receive a greater reward or higher commission percentages by acting as a group, than each would receive on his or her own. Additionally the Affiliate who makes the actual sale may receive a slightly higher commission than the others in the group. By acting as a Group (or Pool, Network, Community, or Alliance), the Affiliates may collectively reach a threshold sooner than they would reach that same threshold operating individually. It may be set up that those agents closest to the sale receive the highest commission, while the rest of the group receive a slightly smaller commission. There may be thresholds each Affiliate has to maintain to remain a member of the pool; this threshold may be month to month and commissions applicable only to those months. This may be a sub-agency program. For example: Collectively, 3 agents reach 50 sales per month; so they now get 70% residual split, rather than 50%. Thus the affiliate company gets 10%, each gets 60% (and not 50%). They have formed a business alliance in a way. Another Example may be; An Affiliate receives a $50 commission per sale; once that Affiliate reaches 500 consumers, that Affiliate will receive $60 per sale; but the item may be a difficult item for one person to sell 500 units of, so Affiliate may join a Pool of 9 other Affiliates, and the 10 Affiliates collectively have to sell an average of 50 units—a goal much more achievable to each individual Affiliate. Here each Affiliate only gets paid for their own sale. There may otherwise be a method where the Affiliates get paid on average, regardless of who does the sale, so that each is paid $6 per sale and that the affiliate who does the actual sales receives an additional $1 for their own sale. By providing these higher incentives for Affiliates to work as a Group, Merchants and the Affiliate Company encourage Affiliates to seek other Affiliates and possibly recruit other Affiliates into the Affiliate System Network. By encouraging Affiliates to work together, synergy may occur in several ways; Affiliates may designate tasks and responsibilities to each other, and the Affiliate Company's Affiliate Network System may provide tools for Affiliates to designate such tasks to each other. Affiliates in such a Group may likewise provide each other with energy, motivation, and support, thereby increasing the psychological well-being of each affiliate as well as potentially increasing the number of sales of each affiliate. Networks of Affiliates (Networks, Pools, Groups, Alliances, etc.) may likewise share knowledge, tips, and advice. Affiliate Networks/Groups may form Joint Coupons of their own, or may be eligible for exclusive promotions to offer consumers, or if one Affiliate has access to a Merchant that another Affiliate does not have access to then the two may form a bridge where both have access to promote that Merchant, or may be entitled to a higher commission split from Affiliate Company by subscribing into a particular network (this is another example of the Affiliate Company using the model on itself, by providing Affiliates with the incent of a higher commission if they form a Network).

A Business (or party or other entity) may be a Network or a unifier of a network itself, and thereby act as a Primary Affiliate. A Consulting Firm (possibly being a business that specializes in finding clients/customers, or finding talent/workers, or finding both) may be an Affiliate or even a Primary Affiliate, or it may be an entity that compromises a group of Affiliates (thereby acting as a Network). A Consulting Firm may be a Primary Affiliate that has the ability to form Affiliate Network(s) of its sub-affiliates. Primary Affiliate may enroll its Sub-Affiliate into a network, possibly unanimously for a higher commission for itself, and/or for a higher commission for its sub-affiliates; sub-affiliates may have the option to opt in or opt out of such a Network, or it may be mandatory (a requirement) or automatic (no option and possibly unknown to sub-affiliate) as dictated by Primary Affiliate (in this example, the Consulting Firm).

A Groups of Merchants may exist as a Network, Pool, Community, Group, Association, Alliance, Chamber, Union, or other such combined formation of Merchants. A Groups of Consumers may exist as a Network, Pool, Community, Group, Association, Alliance, Chamber, Union, or other such combined formation of Consumers.

There may also be reverse pyramid with or without a pooled community, and with or without tiers of sub-affiliates. In the example without a pooled community and without tiers of sub-affiliates; an ISO Company may receive fifty (50) percent (%) of Core, and Agent1 may receive 50 percent (%) of Core (the ISO and Agent split the Core), with Agent1 having ten (10) accounts. There may also be a reverse pyramid with a pooled community or with tiers of sub-affiliates; in an example with tiers of sub-affiliates, the ISO may receive 45 percent (%), Agent1 receives 55 percent (%) and has ten (10) accounts boarded (has subscribed 10 Merchants into ISO Company's system), Agent2 having x accounts and getting 55%, Agent3 having y accounts and receiving 55%. Sub-Agent 3a having qy accounts and getting QQ % percentage. Sub-Agent can be under Agent3, or other derivative using other plans. This may go on to Agent99 having z accounts and getting 55%. Collectively: All agents have A+B+C . . . +Z accounts. For example, if five agents each have 100 accounts, collectively they have 500 accounts, and the ISO company is willing to see them as one Pooled Community or one Combined Entity—either as Separate Accounts Collectively Pooled, or even as One Collective Account—and is willing to give that community or group better splits, commission, or residuals. In one method, Affiliates may form an Affiliate Pool to reach a threshold and allow each individual Affiliate in the pool to receive a higher commission; (called an affiliate pool incentive split); For example, if normally each Affiliate would receive a 50% split, those Affiliates may form an Affiliate Pool, and once they reach a combined threshold of 500 accounts, the split to the Affiliate increases to a 60% split. In another method, the Affiliates may form an Affiliate Pool and each affiliate receive a shared bonus of 10% of a sale each time a sale is made, where that award of 10% may be divided amongst the eligible Affiliates in the Affiliate Pool, and the Affiliate who makes the sale receive 55% instead of the standard 50%. This rewards all Affiliates in an Affiliate Pool, and thresholds may be set so that each Affiliate must meet a minimum requirement in order to be eligible to receive a share of that 10% that is split to the eligible Affiliates; thereby encouraging each Affiliate to be active. Additionally, the 10% shared split in this example may likewise be divided proportionally out amongst affiliates, so that if there are 4 affiliates in the Network and Affiliate 1 yields 1 sale, Affiliate 2 and Affiliate 3 yield 2 sales each, and Affiliate 4 yields 5 sales, giving a total of 10 sales; then Affiliate 1 may receive 1% of each sale, Affiliate 2 may receive 2% of each sale, Affiliate 2 may receive 2% of each sale, and Affiliate 4 may receive 5% of each sale, giving a total of 10% in shared bonuses. Such a threshold may be decided on the number of sales, or the value of a sale, or a combination (for example; if Affiliate 1 only makes 1 sale but it is a very big sale and worth the same as two sales by Affiliate 2, then both Affiliates may make the same in shared split. Or, if both are the same in value and Affiliate 2 did 2 sales, Affiliate 2 may receive more of the share split because Affiliate 2 lead to more transactions or more consumers or more dedication from a particular consumer). Such a threshold may also be decided by position in a tier, where those closer to the sale in the tier receive a higher commission. This may encourage any Affiliate, no matter what position in tiers, to make direct sales. Everything may be collective in this system, the percentage (%) split can apply to its own sale/its own unique separate account, or a collective pool where all accounts are joined as one. Applied to its own sale or account is likely more reasonable. This also creates the ability to form communities. It may be online (account, etc.), manual (phone, mail). Communities may be formed by various entities such as shops, store owners, agents, agent and agent friend, agent and sub-agents combine, etc. The percentage (%) amount can be part of Profit, Core, Core Reserve, etc. ISO can be replaced with Affiliate Company, or even with Primary Agent or other platform on the hierarchy. ISO and Affiliate Company may be interchanged with terms like Stock Market, Hedge Fund, or other such markets, systems, companies, or other parties or entities.

A Reverse Pyramid may be defined as a system or method whereby the Affiliate of Sale always makes as much, if not more, than Affiliates higher up on a tier of Affiliates (including the Primary Affiliate and even the Parent or Top Factor). By having a pool in a Reverse Pyramid, commission may be higher to each participating Affiliate or to the collective network of Affiliates. In this way, a network of many small sub affiliates has greater numbers in man-power (a multitude of affiliates), and therefore may have a higher likelihood of forming a network/pool than others closer to top of the chain, and are the ones making the sales or closer to those making the sales, so receive a higher commission. Although, a network may be formed of any one in a part of tier; such as a Primary, two sub-affiliates, and four sub-sub-affiliates forming a Network together. Network Tier Thresholds may be in place; such as once an Affiliate makes a certain number of sales, they may form a network with others who have met that eligibility. Network Tier Restrictions may also be in place; such as only primaries being allowed to form networks with other primaries, or only sub-affiliates in 3rd tier and lower may form affiliates with each other, or any sub-affiliate lower than a 5th tier cannot form a network with someone above a 3rd tier level.

The present invention also envisions discounts for the collective group. There may be a foundation account, for discount, from 100 separate businesses (as in a business alliance; needn't be a shopping mall, can be completely separate); join together (as in a caucus) and choose a service, for a group discount collectively. As with all other aspects of this invention, this may apply a reseller/or a continuous residual plan to this pricing model.

There may be a percentage of profits as deferred payment with interest pricing model. In exchange for services or products, a percentage (%) of profits as deferred payment with interest and threshold or cap (In place of $ for services at point of sale /exchange). This may be used to start up a business without giving ownership away, without stock, without venture capital and can limit to time period, too. For example, 7% annually for 3 years.

There may be a collective percentage (%) pricing model. In this model, a collective percentage (%) is achieved with a percentage (%) to their contribution. This may be less percentage (%) to Primary Agent or core. There may also be a split. Some examples, may be: Example A: 1 agent on his own gets a 50% split; and 10 agents operating individually and on their own each get their own 50% split. But if they form a collective Group, that group may go for Collective Incentives—the Group may receive a 60% split, where each individual agent still gets their individual 50% and that extra 10% Collective Bonus can be distributed amongst the other agents in that group (it may be distributed evenly, or proportionally based on performance or contributions). There may be milestones (a Collective Goal aka Collective Incentive Point) to reach the Collective Bonus; for example 500 customers signed up—There may be 3 agents; 2 submit 200 customers over time and the third submits 100 customers, collectively reaching that goal of 500 customers-individually, the goal may otherwise be more difficult to reach or may take far longer to reach-therefore forming a Group to reach a Collective Goal helps individual agents achieve something, perhaps collaboratively or perhaps independently with just the title of a group, that may otherwise be difficult to reach-allowing each to benefit with a higher revenue or bonus share. Note in this; this can be a combination of Agents & Sub Agents to form a Group, etc. (Some new terms in this may be a Collective Goal aka Collective Incentive Point, and a Collective Bonus which would be a bonus awarded to a group). This would mean having a system in place, like Business-To-Business, where Affiliates/Agents can partner up and form groups with other Affiliates/Agents and may be a system where Agents can manage and monitor their Sub-Agents. This system/method encourages Agents to work together, to form Sub-Agents, to make sales themselves and to have Sub-Agents making sales—collectively reaching a goal of earning more revenue for the Agents, and reaching the Merchant's goal of selling more products (or subscribing more customers, or whatever the sale is)—this boosts bulk sales; not necessarily by lowering cost on product by selling items in bulk or wholesale, but by encouraging a bulk sales team to exist and operate and sell the items to customers—everyone is happy, a win-win-win. Customers can be direct end users, or can themselves be in bulk such as wholesale recipients-any scenario for customer can exist. The focus here is on the Sales Team.

There may be a secondary agent system pricing model. This is not an agent with sub agents, but another agent who gets part of that percentage (%) as part of the core sale, or payout core. Another scenario may be that two agents both refer a customer. One could be how if two people refer a customer, the agent closest to time of sale receives the commission. The two affiliates in this example may operate as a Dual Affiliate, both sharing in the sale. Another situation may be the affiliate being a Beneficiary Affiliate, as with a designated charity receiving a percentage (of what an affiliate would receive, or the affiliate company would receive, or of what the Merchant would pay out, or other) of the affiliate reward.

If an Agent introduces a new customer to this Affiliate System, that Agent may serve as a Primary Agent and thereby get a commission on every purchase that customer ever makes, even via deals sent to the customer by other agents. This is different than Secondary Agents, but similar in concept in that the Primary Agent is not above the other agent in the ‘chain of agents’ between the affiliate company and customer but can be alongside it. An agent who signs up a customer into the system can be seen as a Primary and thereby above all other agents to that customer, or can be seen as a second side-by-side agent like the Secondary Agent model or Dual Agent model. Signing a customer into the system consol could be a number to itself, where the consumer is introduce to the Affiliate System Network website where they may create a Consumer User Account. Same could be said of signing a store up and having that store attract others such as its own customers into the system.

There may be built in safeguards for the system. For example, if two agents are both advertising for the same entity and one ad goes out, they both share residuals. The two bid as one, so they aren't competing. Another option is to rotate ads, each gets equal percentage (%) of the time and the same amount. This allows an affiliate company or a company wishing to sell products/services to rotate its agents (rotation done automatically via computer system or manually with store owner oversight); deems Agents, and different URLs (if have reseller account, etc.). This may help encourage the formation of Affiliate Networks, where Affiliates form Groups, thereby increasing the ad exposure a particular Affiliate receives with that Group.

It is intended that the present invention creates and facilities symbiotic relationships. This may be by acting as one big shopping mall, even if not physically close to each other. This provides many advantages, such as, synergies, businesses “scratching backs”, forming new marketing strategies together, the ability to consult each other on business costs (phone services, credit card processing—can even be agents to each other) and even expansion to new businesses. Businesses may embark on Joint Ventures such as Joint Coupons, Joint Coupons may be coupled Rebate Coupons, Cross Promotion, Foundation Accounts, Pooled Advertisements, and more. This creates Symbiotic Business; businesses operating together, synergistically and symbiotically, increasing the livelihood and productivity of the other business, and possibly even relying on the relationship with the other to survive. There is also the business to business services exchange, including, business card printing, ads, flyers, graphics team, website. The businesses may be willing to put their time in free, or provide products or services at base cost, discounted cost, or free services (less materials) in exchange for percentage (%) of sales (by a secondary agent). This may be according to time and/or percentage (%). There may be a cap or threshold based on percentage (%) over time and interest. There may also be a maximum level cap or threshold. One example of symbiotic business may be an entire town with each Merchant on an Affiliate System providing a gift certificate with a value of $30 to a consumer once that consumer reaches a collective $300 in sales from various Merchants. Here the town forms a Network and may act as Primary Affiliate, or the Merchants may form the Network themselves and may designate the township as a Beneficiary Affiliate if they wish. Additionally, each participating Merchant may receive a discount on their local taxes from the township.

Foundation accounts may act like pooled ads, getting a percentage (%) off once get a predetermined number x get together and form a relationship or Network. Another example may be to get a percentage (%) off if a friend is referred. There may also be a residual option. There are several scenarios, by way of example, that may be residual options Option 1, Example A: 10 merchants get together and host 1 newspaper ad; collectively they get 10% discount, as in a Pooled Advertisement. Option 2, Example A: Merchant ‘Y’ refers Merchant ‘Z’ to do a joint ad (aka pooled ad)-Merchant ‘Y’ gets 20% off (a greater discount to Merchant ‘Y’ as Merchant ‘Y’ made a referral and acts as both an Affiliate to the ad and as an advertiser on the ad), Merchant ‘Z’ gets 10% off (merchant Z need not get a % off, but, having a % off gives an incentive to join the ad Merchant ‘Y’ is a part of). Merchant ‘Z’ need not join Merchant ‘Y’s ad for either to get a discount—they could do separate ads on their own, where this acts like a standard affiliate, but the commission to Merchant Y can be taken as a discount % or price off of Merchant Y's own ad (“Refer a friend to advertise with us, and we will take 10% off your next advertisement price” or “Refer a friend to advertise with us, and we will take $x or x % of your friend's ad off the price of your next ad” . . . or “Have your friend run a joint ad with your ad, and you both receive 20% off the final cost of that ad”) Option 3, Example A: By “Residual Option”, this means if Merchant ‘Z’ keeps coming back taking ads out as a continued client (of the newspaper, billboard company, TV advertiser, etc.), then Merchant ‘Y’ can collect residual commission, thereby Merchant ‘Y’ acting as an Agent or Reseller of “Advertising/Newspaper Company's” service or product.

There may be pool ad sharing such as “Coupon Partnerships” “Affiliate Marketing”/“Joint Marketing,” “Joint Coupons”. There may also be partnerships with Newspapers. For example, the affiliate company gets free ad, or affiliate gets a percentage (%) of each full page ad Affiliate Company sells—our business model applied to Affiliate Company as an agent for the newspaper (Affiliate Company has accent and Networks of Merchants, that Affiliate Company is in a great position to provide newspaper with pooled ads). Newspapers can also be Agents; they can pay for the ad, giving a free ad in exchange for a commission, or a mix of a lower-cost charge to Advertising Store/Agent in exchange for a share in the commission from the sale. Newspaper gives free ad, it acts as agent. For example, on a 15% off coupon, newspaper gets about 5% of order as commission.

The affiliate tracking system may take many different forms. There may be a coupon, there may be an e-Coupon given to a live store. There may be a coupon code associated with an associated. There may also be a GiftCard generated, the customer can print the gift card which has bar code or number as agent ID, the then store scans in (or manually enters at register or later at home). A coupon or other identifier may be displayed on a mobile phone as an image, or may be sent via a mobile phone as a text or other method of transmitting data. An agent can also place a coupon directly in newspaper ad, the trick is linking it to transaction terminals, which may be accomplished through bar codes, agent codes, affiliate identifier, keywords, etc. as well as a code that is formed by a combination of any of these (such a combined code may form one new code, or may take each separate code and just bond the codes together into one long strand). There may also be a safeguard for Cash with a rating system with agent and store owner. Also, the Customer can do rating online for additional 2 percentage (%) back or for other award. This may come from AFFILIATE COMPANY. There may be a contract with the AFFILIATE COMPANY and/or store owner; agreement to be honest about reporting. The Customer can see coupon online, print, and use in a Physical Store, the agent can now print coupons in newspapers; to use in store (or online). Store owner can manually enter into terminal or other device, which may send it along the same gateway system without the credit card data or it may send it along any other system including a new Affiliate System, Affiliate Gateway, and/or Affiliate Processor. Note that data transfer can be sent along the payment system used for credit cards, or another separate data exchange system. A store owner can manually enter it online (from within the store, or at home, etc.). There may also be a third 3^{rd} party service that enters these in (daily, weekly, etc.). If no system exists the store owner can login online (daily, weekly, etc.) and the customer gets a rebate; enters code in online after sale. Merchant, or consumer, or both may log into a User Account on the Affiliate System Network to issue the rebate to Consumer and/or to issue payment to Merchant (by having both Merchant and Consumer log into their own User Account, it may provide checks-and-balances to ensure Merchant is always honest. Consumer may receive extra rebate or additional bonus award for reporting the rebate to the Affiliate System Network). This rebate to consumer may be credited to a credit card, mailed to the customer or an account with credits established.

Tracking may be: by credit card; automatic with new gateway system or piggy-back; manual (if cash and/or no system); store owner online or by phone. It may also be tracked by region and/or elements. Tracking may be by store ID (in system), or by credit card gateway (or other data transfer means from point-of-sale to Affiliate System). It may be automatically applied to customer's credit (if purchase from 2^{nd} store, discount for 2^{nd} store is instantly applied, and rebate for 1^{st} store is instantly applied to Customer's credit card, or Customer's credit account). Customer Credit Accounts can be a feature of the system and may work as one overarching reward program which may have incentives for the life of the account.

Affiliate Cards, and the entire Affiliate System may residing outside of a credit card system as its own entity (it may be on an existing system or may be on its own). There are two systems: (1) An affiliate processing system is for back-end data gathering from store and sorting. Information travels from the Affiliate Gateway to the Affiliate Platform to the Affiliate Processor (does the tracking of data and processing of it). (2) An affiliate network system, which is an online website for Merchants to find other Merchants and form ventures, Affiliate to enroll or apply for promotions to solicit to Consumer, Merchants to form Alliances, Affiliates to form Alliances, Consumers to form Alliances. Data gathered in the affiliate system may interact with an affiliate network system so those parties in the affiliate network system can view tracking and reports of the data. The affiliate network system may also be used to do things such as a Merchant issuing a refund, which may require the affiliate system to work in reverse to issue a consumer a refund and withdrawal that set of money from Affiliate's escrow account. The affiliate processing system and the affiliate network system may be in communication with the affiliate tracking system.

The feedback system may consist of checks and balances. A balance may be that the customer can get rebate online, after purchase. There may be an agent ID #, or Alias Name, or other code (or bar code) printed. That data may be used in-store to give percentage (%) to agent. The percentage (%) to agent can come via credit card settlement, instantly at Point-of-Sale. Or, the Agent Commission can be instantly put at intermediate account supervised by ISO or Affiliate Company for 3 days, 30 days, 60 days, or any amount of time to allow the credit purchase to post and to allow for potential returns. While in such an intermediate or Escrow account, interest may be earned, and the benefits of that interest may be awarded to Consumer, Merchant, Affiliate, Affiliate Company, a designated Charity, or a collective split among all such parties.

Businesses now help each other by promoting each other and cross promotion, talking to each other, sharing ideas, sharing best services (business consulting to each other); such as sharing the best phone carrier, Best VoIP service in the area, etc. Also, they may give feedback, give feedback by actions, if quality low and price too high, customers won't shop at the other store and won't like the relationship. Tell Store 1, Store 1 stops going with Store 2; instead promotes Store 3. Store 2 thus enticed to offer better quality and comparable prices. Merchants may receive Affiliate commissions for their referrals to services, or these referrals may be advice free of Affiliate commission.

Joint coupon codes may apply to complementary businesses, such as a restaurant and an ice cream shop, an ice cream shop and a café, a framing center and a photographer. Also, businesses that do not appear at first glance to have complementary business, such as the auto mechanic and the masseuse. There may also be joint coupons by group of businesses and/or unique targets, such as an entire street, entire city, region, store type, etc. The joint coupon may also provide increased promotional offers. For example, if a consumer shops at Store A, they get 10% off, if they shop at Store B they get 10% off. If the same consumer shops at Store A and Store B, they get 15% off each store. In this way a Symbiotic Business encourages a Consumer to spend more, in order to save more at each store, thereby satisfier the consumer and encouraging savings while at the same time encouraging spending. The merchant may set that duration and minimum/maximum per store. Store A may also act an affiliate to store B (and vice versa). In that example, the consumer may get an increased promotional offer from Store A to Store B, and store A receives an affiliate reward for consumer's purchase at Store B.

There is also a referred concept, where, by example, you get a friend to buy, use code APPLE, you BOTH get 10% off. Applies discount to first person, like a rebate, after first person then goes and gets their friend to buy. This may be used for restaurants, movie recommendations, etc. and keeps it going like a chain. This may show up on the customer's receipt. The coupon may be, by way of example, on (a) customer's order if customer refers a friend, (b) on customer and customer's friend's order, (c) on customer's friend's order, and customer gets Commission of friend's order (% or $ or credit or other token—which can be applied to Customer Affiliate Account or to their Credit Card account/credit). It may be applied to customer's order, credit, store credit, account, etc. This turns a customer into an agent. There may also be a rebate system with a rebate on receipt, on customer order, or online. There may also be a list of stores. For example, one thousand ($1k) this month=20% credit, cash back, etc. at any participating store in . . . [in the world, in a set region, at a specific participating store]. There may also be a Tier System: For example $500=10% discount, $250=5% discount. In this example, the consumer is encouraged to spend more. If they spend $250 they get a 5% credit, if they spend $500 they get a 10% credit. This may also be pro-rated exponentially, for example, $500=10%, $250=4%. This boosts the economy and increases spending, as well as savings. A Consumer may be treated as an Affiliate, but still labeled a Consumer and instantly receive a rebate on their past purchase once the referred friend makes the purchase. This kind of Instant Rebate may be issued, implemented, and executed by the Affiliate System, Affiliate System Platform, and Affiliate System Gateway.

There may be combined joint coupon and referrer coupons. This may coincide with a Joint Coupon; “Get 10% this purchase, and your friend gets 10% off their purchase from this store OR one of the ‘listed’ partner stores”. So the second person can buy from any store in that mall, on that street, in that town, or at the bowling alley after dinner, whatever partner business the first shop has teamed this up with. The first referring business to the second business can get a percentage (%) commission of that referral sale, as they are acting as an agent to the business. Coupon expiration dates would thus coincide with length of business-business relationship. This may act as a Joint Coupon, after a Referral. (A mix of a Joint Coupon, and Referrer coupon). A first referrer should get more than second, should act as an agent (if ice cream shop refers to high end lobster restaurant, the latter makes more money from the relationship). There needs to be a system to decide who is the first and second referrers were, for example, in a printed ad. The System tracks the time of purchase to determine who first and second. If paid by cash, you may have a stamp section . . . 2 boxes. 1 for first, 2 for second, and they initial or stamp. Then the second reports to AFFILIATE COMPANY and to other. Customer, to get discount from first, could get a cash advance from the second, which has to be paid back by the first. The Customer may also get a voucher, which goes back to the first. Or gets a coupon from the first, and the discount from the first is applied to the second (but if percentage (%) off from the first exceeds the overall cost of the second, customer would have to get cash from the second, or return with voucher to the first . . . or gets an item such as a gift card or gist certificate; up to the store owners to feel out what words best. This may be a gift card that can be redeemed for cash. If an agent puts the coupon, how the split works may be agreed upon and determined between the parties.

Display snapshot of Store Owner's site may be placed in Merchant's profile on the Affiliate System Network website or the website of the Affiliate Company. Store Owner provides URL to Affiliate Company of what to use for snapshot of Store's website. Affiliate Company recrawls Store Owner's website every 6 months, or on their request (one per month request may be the maximum). Or, automatically generate a snapshot image of a site in real-time. For customer to get percentage (%) off: Like Mail-In Rebate, customer has to login to Consumer User Account on the Affiliate System Network at home to activate, after purchase. It may also be activated by purchase to get unique#. This helps track the agent's sale (a confirmation, in case store owner's didn't go through). There may be a link to ISO gateway new data field, there may be a link to online shopping cart function at checkout confirmation/order success/order total after payment.

There may be incentives for the feedback system. For example, there may be a percentage earned x % (suggested 2%) back as a customer if Consumer completes a review (of product, agent, store) at Affiliate Company's website (such as AFFILIATE COMPANY.com); enter order # and store #, or a unique identifier, or scan the receipt at a device such as a bar code scanner on the side of the Consumer's laptop. It doesn't need to be from the Merchant's site or Affiliate's site. It plugs Affiliate Company, the terminal joined in to Affiliate Company. This may be in real time, which may be batched out instantly. Customer instantly gets percentage (%) discounted to their purchase when complete the rebate. The rebate system may be an ISO and money may be offered up front; like a loan (we get a number risks). $0.02 per trans less if have AFFILIATE COMPANY plug (plug=advertisement, shout out, promo, or even promo code to another Merchant or product where Affiliate Company may receive a commission as an Affiliate itself) at bottom of receipt. A promo on a receipt may be an affiliate identifier from the Merchant printing or advertising, where that Merchant may be an Affiliate. There may be a paid advertisement on a receipt that Merchant A gives to a consumer, where another Merchant B may pay to advertise on that receipt and Merchant A and Affiliate Company share in the revenue from that advertisement, or share in the revenue from the sale that advertisement leads to (where it may act as an Affiliate code that the Merchant and Affiliate company share in as Dual Affiliates—in this scenario, a Merchant and the Affiliate Company may be Dual Affiliates and on an equal level). Each of the specific monetary amounts are for example purposes only, the amounts can be any amount. The purpose was to give a rebate to Merchant(s)—or Agent(s) depending on what the coupon or ad is soliciting—if there is an advertisement or promo for the Affiliate Company on the coupon or on the advertisement.

It is envisioned that physical coupons may be tracked via credit card processing, or on a Gift Card system, or a Loyalty card system, or a new Affiliate Card system, or a new Affiliate System, or other system, or a combination of any of these systems. Alternatively, the agent can still print ads; runs ad with coupon code and the store owner manually enters in online. The trust and feedback system in place, helps assure honesty. There should also be a dispute council of Affiliate Company in place and optionally a contract with Shop Owner at account signup.

The agent can print ads with their WEBSITE and PORTAL PAGE listed, for example saying something like, “Coupon code available from [my site]”. This would send people from their newspaper and over to their computer to buy online, rather than letting them take the coupon into the store. When a system is in place to print coupons and take into a physical shop (based on honesty or by machine tracking), then Agents are now encouraged to print ads with their own portal web page. Another way is to give CUSTOMERS a rebate code to enter in online for their percentage (%) off. Alternatively, the rebate system is tied directly to the Merchant Vendor Gateway. Joint coupons could have first store provide first 5 digits, and second store provide last 6 digits to complete the code. The number of digits is a sample/example. Summary of just one factor of this document: Withholdings; Revenue to Agent can be withheld at the time of Purchase at Point of Sale and put in an Escrow account for 30 days for purchase to clear without chargebacks or refunds, or revenue to agent may be provided by merchant or ISO or other later. This may be accomplished via funds coming from revenue from order (Merchant—and/or existing or future funds in Merchant's bank account), ISO and the credit card system that charges the card (funds coming from the system that takes money from customer's card and deposits it to merchants account), and/or “clearing house”, or other. According to the present invention, this may comprise the steps of withholding at least a portion of either the affiliate reward or merchant reward at the time of Purchase at Point of Sale to provide withheld funds; maintaining the withheld funds in an Escrow account for a predetermined period of time; releasing the withheld funds after the predetermined period of time wherein chargebacks have not been made.

There are different ways to track the referral of a Sub Agent to an Agent. For example, if an agent takes an ad out looking for Sub Agents, or refers a friend, It is an object of the present invention to prevent Agents from later declaring someone is a Sub-Agent of theirs, if that Sub-Agent joined on their own. This may be prevented online by following track with clicks. In Person this may be prevented by providing incentives; money, extra Online Ad Campaign, website, discounts in 1^{st} year of sales (a bonus 2%). In Person: a Primary Agent can login and submit Sub-Agents name and some contact info to help identify; in advance, or within a set number of days (for example, 3 days) after referral. The Sub Agent on login, or in email or phone call, gets confirmation asking for who referred. The Sub Agent can be asked to provide Coupon Code (Agent Identifying Coupon Code), which tells Affiliate Company the referring agent and Sub-Agent is asked on login, “Who referred you to us? Type their name, type their ID, or search for their ID/Name”. Another object is to prevent Primary Agents from Name Squatting. The problem of name squatting may be that an agent looks up new agents in the database or in a directory such as a phone book, writes in and claims them as their own Sub-Agent. The agent may look up names in the phonebook or other database, and enters them (thousands of names for an entire town, odds are a few will eventually be agents). This may be solved by asking sub-affiliates on sign-up if they have been referred by someone (another Affiliate, Merchant, or Consumer). Another way to solve this may be to require and force Affiliates to be referred by an existing Affiliate, creating an exclusive invite-only system of Affiliates, where the new Sub-Affiliate must enter in their Superior Affiliate's name. In a sub agent referral: From 2 Primary Agents, it is an object of the present invention to track which Primary Agent gets the affiliate reward. For example, you may have two Primary Agents which both refer someone as a Sub-Agent. (Let's say your housemate refers you at breakfast, and later in the day your co-worker also refers you). In many cases, it will go to the Primary Agent who is freshest in the Sub-Agents mind. The Most Significant may be the most recent referral, the most memorable (familiarity from a friend or relative, or a very unique sales pitch they can't forget). This is similar to what happens if two Agents refer one Customer independently. They can split the sale equally as Dual Affiliates. They can also split the sale 60% to the most significant, 40% to the other. There may also be a customer Sale Referral: From 2 Agents or more. The scenario may be that the Customer clicks on 2 links that month for a store, from 2 different agents. In-Store: would only take 1 coupon code; ok if by newspaper, but if have to search around and print from an Agent's Portal Page. Some solutions are to share the sale, split the sale equally, split the sale 60% to the most significant (probably the most recent), 40% to the other.

Another object of the present invention is to prevent an Agent from becoming their own Sub Agent. This would allow an Agent to create a Sub Agent account they make sales from, leaving the Agent account alone/dormant to do nothing but collect the extra residual from the Sub-Agent. There may be a system in place that prohibits you being a sub agent to yourself. There may also be a limit; once they reach a certain money amount in payout, they can be a Sub Agent to themselves. This may require a cap on derivative payouts. For example, there may be a limit to the number of sub agents. There may be a Sub-Agent program only applicable to Resellers, or applicable as its own Pay Program, where they have to pay $50/yr. The shop Owner may be an Agent in Joint Ads. For example, Shop Owner 1 is an Agent, puts out Joint Coupon for its own business (Shop 1) plus Shop 2. Gets percentage (%) from the sale of Shop1 (itself) AND Shop2. Some possible solutions, may be that both stores can be Agents. This creates an equal opportunity system and actually rewards the one who advertises more, and who refers customers to the other. This provides further incentives. Store owners can additionally set different rates for Joint Coupon sales . . . . They can let the agent make 10% from each store, or 20% from each store. They can let the agent make 10% from one store, and 20% from the other, both stores may have to agree to the other stores percentage (%) out to the agent, both stores may have access to see what the other is paying out to the agent.

It is also envisioned that there may be affiliate site coding, where an Affiliate link goes to AFFILIATE COMPANY, and forwards to shop site (for tracking). Cookie-less, except for sale. There may also be tracking by I.P. address (in addition to cookies, and other). Also, customers may be tracked by, for example, store, amount and items. It may be possible to see combined amounts from two particular stores, and offer percentages (%) off both (maybe towards next purchase). There may be customer tracking at the terminal. This may be tracked when the consumer uses the card, the Name and credit card number sends info to a processing database, and the processing database filters by name, and credit card, into their unique account, even if the consumer uses a different credit card with a different banking system and links those purchases to the same customer. This helps the stores track money by customer, and may do so without a giftcard/store card. This also allows offering of a coupon once the customer reaches a certain amount. Like a rewards card for that particular store, or group of stores, or even by a particular product.

There may be a shopping cart program company, (a maker like Zen Cart or Magento), that has their ID built into the cart, with the cart maker acting as an agent if they partner with the Affiliate Company to sell the affiliate service or membership or subscription into the Affiliate System Network. The shopping cart company then acts as a reseller of Affiliate Company's product of membership to the Affiliate System Network, bundled into their cart. The shopping cart can have webmaster ID coded in at set up/install in the back end (webmaster as sub-agent to shopping cart company). Shopping Cart has store owner code that can be built in. Stores may also be provided with an affiliate program from their own site. Once a webmaster or Merchant installs the shopping cart, they can see or activate a module that directly connects the Merchant's e-commerce site with the Affiliate System Network of the Affiliate Company.

The feedback system, which may be on the affiliate company website where the Customer, Agents, and Merchants can all have accounts and therefore a user account interface, may also have a “wanted section” in which a customer, shopper, etc. posts desired service, product, business-type, etc. Agents skim through postings (online or kiosk for in-person), and notify customer (by email or a reply-posting or other) of the agent's suggestion which may be the best deal/best product/lowest-cost, etc. Agent may supply a coupon code (with or without their affiliate ID); an agent can receive a commission through the tracked coupon, a store owner can put out a coupon without having to pay a third party agent's commission, etc. The posting can have the option of specifying location/region, budget, time frame/deadlines, and other classifications. This effectively lets someone else do the shopping for the shopper (or the stock analysis for the stock bidder, etc.); and allows either a commission for the service to be exchanged as a finders-fee, or allows an agent/affiliate to receive commission on the sale as with an Affiliate Program.

The present invention also envisions that the tracking system tracks if a return happens, it credits the store owner back the commission (doesn't let the customer keep that discount percentage (%) or the agent keep the commission) . . . and if a joint-coupon between two businesses, it gives the promotional percentage (%) back to both businesses. For example, if a consumer goes to a mall, and wants 20% off a new leather coat from Stacy's, so to get that they buy $200 worth of socks from Mears clothing store . . . at the point of the second purchase, it applies the percentage (%) off to my credit card by tracking it through a means such as an ISO Company gateway or manually through the second Merchant owner going into their Merchant User Account on the Affiliate System Network. Three weeks later, the consumer returns the socks and gets the $200 back, but has kept the 20% off the leather coat. So, the system needs to not let the customer keep the 20% off the leather coat . . . it needs to bill the customer back for that, unless the $200 in socks becomes store credit and is not a true return.

There may also be a volunteer management system (on website, on User Account interface on the Affiliate System Network, or any other means), volunteers join site, listing their skill sets; easily searchable by a site administrator, several administrators load projects, project descriptions, qualifications, etc. Volunteers browse for work/projects available and sign up, administrator confirms and assigns project to volunteer. Can assign several to work together. Volunteer works on project. This may involve content management.

There may be an E-Commerce portal, such as Magento™ or Zen Cart™, that allows the administrator to track affiliate identifiers. This may reside on Merchant's website. An example of a new component or portal for a portal shopping cart: Customer enters in coupon code that acts as both an identifier for an Affiliate referral and an activator for a discount to the customer. The Merchant logs in to an administrator “Admin” consul, where Admin consul may be a customized portal that shows a breakdown of coupon codes used, the discount to customer, the commissions owed to Affiliate, revenue to Merchant after customer discount and affiliate commission are deducted, and possibly other information such as net profit where overhead may be calculated and deducted as well. Merchant may also have a consol where they deduce payments made to the affiliate, thereby reflecting a history of payments made and subtracting payouts from amount owed. A payment interface may exist on the Merchant's site, on a third party site, on Affiliate Company's site, or an integration with software such as Quickbooks™ on Merchant's computer or in a control panel on Merchant's bank account profile. Payment interface may allow Merchant to pay affiliates directly, or by downloading data such as via text file or excel sheet from Merchant's website, and uploading it to a payroll service or bank account that would send funds to affiliate. A reverse tracking system or a signal sent from payroll service or payment interface may then cause payments to be reflected in History of the Admin consul, to signify payment has been paid and assist in bookkeeping. Funds owed to Affiliate may be sent to escrow to protect Merchant in case of chargebacks or refunds. There may also be an Affiliate Portal, where affiliate may log in to its own account to see sales using its coupon code, commissions owed, commissions paid to date. The Affiliate Portal may reside on Merchant's site, or it may reside on Affiliate Company's website, or it may reside on a software and program interface on Affiliate's computer, or it may reside elsewhere. The module on the Magento™ cart or Affiliate system may combine several of these different components together, allowing referral identifiers to be tracked, refunds to customer to be accounted for and a proportional amount deducted from commission owed to affiliate, funds sent to escrow, future deductions put in place, and more.

One application of a reward to consumer system may be to receive higher value in reward than the amount invested. A Consumer may receive a higher value in reward than the amount they invest in the initial purchase. For example: A consumer wants to gamble online, and buys a Wedge device for $5 from the gambling website or from a third party vendor. The customer then receives $10 credit towards the gambling website. The Wedge device may plug in to a USB port on consumer's computer, allowing consumer to then swipe their credit card, or it may be a finger print reader device that identifies the customer by their finger print and uses that identification to charge the customer's credit account with the credit card company or a system such as a credit or point system with the Merchant's website; thereby providing Merchant with more assurance that the customer is the person they claim to be, or the credit card used on the site is valid. Merchant may negotiate lower rates with the ISO or Processor or Credit Card Company or other entity, as a result of having such device that deters fraud. Measures may be in place where consumer must purchase $50 to activate their account, thereby the $10 is a credit deducted from payment or added to gambling credits customer has available. Or Merchant may simply give away $10 credit and have customer pay $0, or only charge enough to cover overhead, as the customer may be likely to be satisfied with the system and gamble more money, and the customer spreads the network.

Tier-Affiliate System and Core Reserve: Concept of More Sub Agents yielding a less expensive product to Consumer. Instead of a tier of affiliates where final cost to consumer becomes more expensive by mark-ups of each affiliate, the final cost becomes less expensive the more sub-affiliates that exist. For Example A: A Consulting firm normally charges 25% fee on top of a talent's annual salary of $100,000 to a client who is looking to hire that talent, where the Consulting firm discovered the talent and client approached Consulting firm to fill a position at client's office. However, Client approaches Agent A to staff the position, and Agent A goes to Consultant firm to staff the same talent. Consulting firm charges Agent A only 10% of talent's salary, and Agent A charges a total of 20% to client (Agent A keeps 10% of talent's salary for itself, Consulting firm receives 10% of talent's salary), ultimately saving client 5% over what client would have paid in commissions had client gone directly to Consulting firm. This scenario encourages a network of Agents to make sales competitively, thereby allowing Agents to stay in business and grow their business with an edge over the parent Consulting firm. The Consulting firm benefits by having multi level marketing spanning a much wider reach than the Consulting firm would have reached on its own, and potentially saves the Consulting firm on advertising costs and other overhead, as the Agent acts as a means of advertising to solicit clients. This relationship does not necessarily have to be a secret to the client that the Agent is not the parent Consulting firm; if client is receiving services of parent Consulting firm at a discount they would most likely be satisfied knowing the final cost was a discount because of the Agent's role, rather than final cost being an increase because of the Agent's role. One loophole exists, where an existing client of Consulting firm learns of Agent A and that a discount of Consulting firm's services can be achieved via Agent A, and therefore Client goes directly to Agent A resulting in Consulting firm making 15% less commission than it normally would. This may be prevented by Consulting firm having a non-compete with Agent A and Client, among other preventative measures. Or this loophole may be desirable to Consulting firm, as Consulting firm may use this as a marketing strategy; where Clients feel they are making a great deal by going to Agent, thereby Client feels they are getting a bargain and more likely to act upon the deal, and Consulting firm has a network agents to resell its services—thereby providing enough work and incentive to Agent to afford a living and continue in the business of reselling Consulting firm's services.

A Radio Frequency Identifier (RFID) as well as the scan at the Merchant's counter may be used to go through the system (the system may be credit card system, gift card system, loyalty card system, or new affiliate system). This may be in place of a coupon and a coupon code, or in tandem with them. A product or a coupon may have a device that can send a frequency signal, such as a Radio Frequency Identifier Coupon, which may be deciphered and read by a receiving device. Data transmitted may be the discount amount, product information, affiliate identifier, commission to affiliate, and more.

Coupons and Referral Identifiers Displayable by Multiple Means: Mobile Phones May be one way. Mobile phones may be used to convey the coupon by displaying the coupon to be scanned, this is a mobile phone coupon. A coupon may be delivered by sending a signal (such as a text or a signal similar to a RFID signal or any other means) to a device (such as register, terminal, laptop, or other), this is a signal delivered coupon, or any other means. The mobile phone may therefore connect directly to the internet or email or text system to gather the referral identifier information, or it may download it; this may be done in real time while customer is in the store, or it may be done in advance.

Coupons and Referral Identifiers Receivable by Multiple Means: Mobile Phones May be one way. Mobile phone, scan gun, or other device may be used by Merchant to scan a coupon, or receive a signal from another device. Coupon may be scanned as a physical coupon, or an electronic coupon residing on a Customer's mobile phone. A Merchant's mobile phone may receive a signal (such as a text or a signal similar to a RFID signal or any other means) from customer's mobile phone that carries a referral identifier to apply a discount to customer's purchase, track commission owed to affiliate, and more.

The Referral Identifier may cause or convey: discount awarded to a customer, signifier of which affiliate is associated with a coupon, commission that should be awarded to affiliate, and more. Customer may receive award by discount on purchase, points in a point system, or any other award. For example, the Customer downloads a coupon to their iPhone mobile phone from Bob the Affiliate's public portal on the Affiliate Company system. The coupon gives them 10% off the purchase if using cash or credit card, or it gives the customer 10,000 points towards credit in the Affiliate Credit System if they use it in tandem with their Affiliate Card, which can be used for store credit at that store or at any other store, thereby allowing the customer to choose what purchase discount would be applied to by pooling it in this collective Affiliate Credit System and giving the customer the option to receive a cash discount.

The Affiliate System may be its own unique system independent of the credit card system. It may be a new system that allows the tracking of Joint Coupons, Affiliate Coupons, and all other elements of the Affiliate System. It may make use of parts of existing systems such as credit card processing systems, gift card systems, loyalty card systems, online e-commerce systems, and others or it may be entirely new and unique to itself. It may use any means of delivery including but not limited to wireless, Ethernet, wifi, phone, cable, mobile phone signal, radio signal, laptop, or other means of communicating information and data. This system should be able to work fully outside of the credit card processing equipment or system; both in-store, and online. This may be used if a store does not accept credit cards or it may be used if a store does accept credit cards and simply operates as a separate system. It may be a system used where data is not sent along with credit card data, but is instead sent to a system specifically made for the Affiliate data to be sent to. For Example 1: Merchant A does not accept credit cards in their shoe store, only cash, so that no existing setup of the credit card system is in place. Representative of Affiliate Company helps Merchant install equipment to allow the tracking and all components of the Affiliate System to work. This may be, for example, a personal computer or terminal with internet. Merchant A chooses a refurbished terminal that uses an Ethernet cable for a high-speed internet connection to communicate data back and forth with Affiliate Company. The terminal may both swipe an Affiliate Card, and have a scanner on it to read coupons, and also provides a manual keypad for Merchant to use. For example 2: Merchant B opts to go with their own laptop communicating wirelessly, where Merchant has a special Wedge device that plugs into a port on the laptop to accept swiped Affiliate Cards, or Merchant has a device to scan coupons that reside on printed paper or on a Customer's mobile phone, and also has a manual interface via an online gateway that Merchant can access via wireless connection to the internet.

Award or token of payment may be Store Credits, Store Points, Affiliate Credits, and/or Affiliate Points monetary value, any other. The award may be greater if Store Credit or Points is selected as a means of compensation if used at the Merchant that the Affiliate made sales to. It may also be greater if used as Store Credit or Points at another Merchant in the Affiliate System, or another Merchant that Merchant A has built a network or partnership with in the Affiliate Company's Business-for-Business system. Awarding higher value may be encouraged and achieved because funds may be placed in Escrow account where interest is earned. Such interest may be shared with Merchant, Customer, Affiliate, Affiliate Company, other parties, and any mix thereof. This provides incentive to Customer and Merchant. Interest may offset the cost of giving higher discount to Customer at second purchase. Or the cost of giving a higher discount may be offset by Affiliate commission earned to Affiliate Company by fees collected from first and second Merchant for their use of the Affiliate System services, and thus Affiliate Company covers the cost of the higher discount from some of the earnings Affiliate Company has made from those purchases. Award of a higher value may also be achieved, the Merchant receiving commission as an Affiliate if Customer makes a purchase at another Merchant using the credit earned from the first Merchant. A threshold may be reached to allow an Affiliate to use their own coupon codes to receive discounts, and possibly discounts and an affiliate commission on top of the discount, on the affiliate's own purchases as a customer. This threshold may be for each particular Merchant, or the collective merchants in a network, or all merchants in the Affiliate System. In the situation where two stores are operating on their own Store Credit system, a system that connects the two to add and deduce credits may be put in place, which may be part of the Affiliate System. For example 1: Affiliate Bob receives 10% commission in sales, and has referred $1,000 in sales to Merchant A shoe store, therefore Bob has earned $100 in commissions. He may receive this as a check distributed by Merchant, Affiliate Company, Affiliate System, or other such entity. Or, Bob may opt for Store Credit to Merchant C. By opting for credit, Bob may receive a higher award value, such as $110 in Store Credit to Merchant A to buy $110 value of shoes plus any potential additional discount Bob may receive on his own purchase as an Affiliate to Merchant A, in place of a $100 commission check from Affiliate Company. Bob may have also reached a certain threshold, such as $1,000 in sales at Merchant A, that allows Bob to utilize coupons for his own purchases at Merchant A. For example 2: As in Example 1, Bob earns $100 in commissions. Merchant A tells Bob he may use this as credits towards a purchase at Merchant B and receive $110 off the purchase at Merchant B. Merchant A may hand Bob a coupon to take to Merchant B as with a Joint Coupon or a straight Affiliate Coupon, or the credit may be tracked via the Affiliate System automatically at point of sale. Merchant A and Merchant B may have pre-arranged a Joint Venture through the Affiliate System's Business-for-Business Merchant portal that Merchant A will receive an affiliate commission for the referral, or Merchant B will incur some of the cost of the commission Bob has earned from Merchant A (acting as a rebate on the commission owed to the Affiliate), or a mix of both a referral and a rebate on the commission owed Bob. Bob then receives $110 on his purchase at Merchant B as a Consumer by using the credit. This credit may also be in the form of a Points System, where a monetary value is converted into an arbitrary set of points, such as $1 equaling 1,000 Affiliate System points, and the points may be converted back into a monetary value at Point of Sale. Or the price of an item may be proposed to a Consumer in terms of Points by the Merchant, such as a Merchant telling a Consumer that a shirt costs 10,000 Affiliate Points (or $10 in $1 represents 1,000 Affiliate Points). Example 3: Bob may use his credit towards a purchase at any Merchant in the Affiliate System network.

Affiliate Credit or Affiliate Points System: Rather than each store having their own Store Credit or Store Points system, or in addition to a Store's own system, an Affiliate Credit or Affiliate Points System may exist within the Affiliate System. This may allow Points or Credits earned by Customers (such as from making purchases, or from discounts on a purchase) or earned by Affiliates (such as from commissions on sales) to go towards a Collective Credit System or Collective Points System, which may be an Affiliate Credit System or Affiliate Points System.

Affiliate Card: Is a new unique card that can be used in a system by a consumer, in place of a credit card, gift card, loyalty card, store card, or other card or it may be used in tandem with a credit card, gift card, loyalty card, store card, or other card or a certificate such as a gift certificate, or a coupon. It may be used to track data including but not limited to; referrals and commissions to an affiliate, product price and other details of items in a purchase. It may also be used by a customer to save or record information such as discounts, available credit, and more. Customer may add credits or points to the card; this may be done via a Consumer Portal on Affiliate Company site, Merchant site, or other site, or it may be accomplished by other means including but not limited to consumer swiping a card at their computer by a Wedge device to add points or credit to the Affiliate Card. Data may be saved on the actual card much like how a SIM card in a phone contains a chip that stores the data, or it may act as a credit card where the card contains an identifier and communicates with a network to add or reduce value in an off-site account, or it may use any other means. Points or credits earned on the card may be applied to that specific store, or may go towards a Collective Credit System or Collective Points System. They may be redeemable for rewards or usable to purchases at a specific merchant, or towards purchases anywhere—including but not necessarily limited to other Merchants on the Affiliate System Network. The number issued to a consumer in the Consumer Portal of the Affiliate System Network may be unique as a customer, or it may share the same number if customer is also an affiliate. Discount eligibility to the consumer may be an award to the consumer if the consumer is also an affiliate in the system (although this is not a requirement); and this may apply to awards earned from soliciting sales for that merchant, or awards earned from other merchants in a network where the merchants have formed a partnership or alliance in the Affiliate Company Business-for-Business system, or from any merchant in the Affiliate Company system. Award to consumer may apply to that purchase, or consumer may opt to reinvest that award amount towards purchases at other merchants. All of these features may be accomplished with or without an Affiliate Card; an entity may be used in its place such as a physical coupon, gift card, loyalty card, credit card, store card, or other means. For Example: A customer may log in to his or her account on the Consumer Portal of the Affiliate Company website, where consumer has a consumer identifier of 1234000 in the affiliate system as a consumer, affiliate, or both. This particular customer is also an affiliate, and they use the same number to receive their discounts as a consumer as they do to receive awards as an affiliate. Consumer searches the directory of coupons available for a particular shoe store Merchant A, and enrolls in a coupon that provides 10% discount to the purchase. The coupon is automatically added to their account, thereby allowing consumer to go into said shoe store and swipe the Affiliate Card, where the Affiliate Card then interacts with the Affiliate System database and alerts merchant that consumer is eligible for the discount or automatically applies the discount to the purchase. Consumer may opt to have the value of the discount applied to that purchase, or consumer may opt to have this apply to a separate purchase at a belt store from Merchant B in the Affiliate System. Merchant A and B may have formed an alliance allowing this relationship to happen, but this does not have to be a requirement.

A consumer may be an affiliate, and an affiliate may be a consumer. They may share the same identification number in the Affiliate System, or they may have a separate identification number in the Affiliate System for each role. If they are separate numbers, a way of merging the two into one control panel and sharing information or data from one account type to the other account type may exist. For example 1: Bob is a consumer and an affiliate. He signs in as Bob 123 and has access to his consumer account, and affiliate account. When he makes a sale as an affiliate, that commission or award may be put towards points and redeemed by Bob as a customer to receive a discount towards a purchase at a particular Merchant's store. For example Bob makes sales as an Affiliate for shoe store Merchant A. Bob receives a discount on his own purchases at shoe store Merchant A. This may be a set percentage (%) of each purchase, or it may be an amount equivalent to the commission value Bob would have been awarded. Bob may opt to receive a cash payout, or he may opt for store credit for possibly a greater value of what the cash payout would be to Bob. For Example, Bob makes sales as an Affiliate for shoe store Merchant A totaling $1,000 and receives 10% commission, totaling $100 commission to Bob that may be redeemed as $100 cash payout or $110 credit to a purchase as Merchant A. Rather than put the $110 towards a purchase at Merchant A, Bob puts the $110 towards a purchase at a book store Merchant B, as Merchant A and Merchant B have engaged in a network on the Affiliate System allowing such a venture and relationship to take place. This allows Affiliate and/or Consumer to reinvest the discount and use it elsewhere. According to another example, a Group Network may be formed from multiple merchants in the Affiliate System, where Bob buys shoes from Merchant A, a belt from Merchant B, a hat from Merchant C, and pants from Merchant D to receive an award of free pants from Merchant F. This may be achieved by a points system, credit system, tracking system, cash transfer system, or any other method or system. These purchases may be tracked by use of the Affiliate System, Affiliate card, and more. Funds, points, credits, or other tokens or value signifiers may be transferred through the system so that appropriate deductions are in place, and appropriate compensations to each Merchant are awarded so that all parties in the system are compensated appropriately (affiliate, consumer, merchant, ISO if available, Affiliate Company, and possibly more). Awards and discounts may be retroactive, where a consumer applies a discount towards a past purchase. A retroactive discount may be especially useful in the case where a Consumer purchases a gift from Merchant B to give to a friend with a gift receipt, and have the discount apply as a credit to the Consumer's own purchase made earlier that day at Merchant A, thereby preserving the discount for their own expenses even if receiver of the gift decides to return the gift for a lesser amount. However, Merchants may decide to prevent retroactive discounts in the advent of a return.

A discount meant for one purchase, may be applied to another purchase. A discount a consumer would receive towards a particular purchase may be transferable or applied to another purchase. This may be from one purchase within one store, applied to another purchase within that same store, or it may be from the purchase within one store applied to the purchase within another store. It may be online or in store, or other means. According to one example, a consumer prints a ten percent (10%) off coupon for a shoe store Merchant A. Consumer's purchase is at Merchant A is $100, yielding a $10 discount. Consumer may apply the discount towards that purchase, however Consumer opt to have the $10 converted into a points system, such as Affiliate Points. If $1 is 100 Affiliate Points in the Affiliate System, Consumer has just opted to have 1000 Affiliate Points added to their Consumer Account on the Affiliate System. Consumer then goes to book store Merchant B (a Merchant also in Affiliate System) and buys a book valued at $10, and Consumer uses the 1000 Affiliate Points with a $10 value in the Consumer Account towards the purchase, thereby paying $0 to receive the book from Merchant B. Merchant B may be compensated from a payment system of Affiliate Company. A benefit to Merchant B may be that this bypasses the credit card system, potentially saving Merchant B fees, and assuring that funds are there for Consumer and helping to negate fraudulent credit card charges. Merchant A and Merchant B may even have a special symbiotic relationship in the Affiliate System, where Merchant B is willing to sell the book for only $9 thereby the Consumer would still have 100 Affiliate Points in the Consumer Account eligible for additional purchases.

The points system may also be a Collective Credit System or Collective Points System. The Affiliate System may allow for awarding, deduction of, or tracking of token, where token may include store credit from one store, or from a community of collective stores. These Merchant stores may be in the Affiliate Company system, and may be a Network of Businesses within Affiliate Company System. Credit or Point may transfer from cash into credit or points to be greater than the initial award value. This may additionally extend to Joint Coupons, and other entities of the Affiliate System. A Merchant who allows the credit or point to go towards the collective system, where it may be used for a purchase with another different Merchant, may receive a rebate on the discount that first Merchant gives to a Consumer or that Merchant may receive an affiliate commission or other award. By allowing the credit or point to go towards a collective system, the Merchant may automatically enroll in a Joint Coupon program and automatically receive an Affiliate commission. Example 1: Customer Bob makes a $100 purchase at Merchant A, and by use of an offer, such as an Affiliate Coupon given by an Affiliate, a Joint Promotional coupon given by a Merchant, an in-store coupon available on the tag of the merchandise, or other means, Bob receives the option of getting 10% discounted (a value of $10), or the value of the discount applied as credit towards the Merchant or towards a collective system. That credit may be applied to purchases at other Merchants. Example 2: Customer Bob purchases $100 with a coupon for 10% off at Merchant A, and instead of applying it as a $10 discount on his purchase at Merchant A, Merchant A allows Bob to have $11 credit in the Collective Credit System, where Bob may make a purchase from Merchant B, Merchant C, or any Merchant in the Affiliate System. This provides Bob with $1 more towards his other purchases than he would have had in cash value applied to his purchase at Merchant A. Merchant A may have the incentive to provide this as an option to Bob because Merchant A may receive a commission from Merchant B, or whichever Merchant Bob uses the discount towards. It may be that Merchant B (if Merchant B is where Bob makes his purchase that he applies the credit towards) covers $2 of this credit, thereby Merchant A only covers $9 of the original discount instead of the full $10; in this scenario Merchant A has received an affiliate commission of sorts because Merchant A only discounts $9 instead of $10, and Merchant B has received a sale that may have been encouraged by the credit Bob had available. Or, Merchant A may receive a straight commission from any referral or Joint Coupon, or any other relationship that may exist in the Affiliate System. According to another example, Merchant A allows Bob's $10 discount (from 10% off an order of $100) to go towards the collective system, where Bob then uses the credit or points towards the purchase of a used $3,000 motorcycle at Merchant C's online store, where Bob receives $11 off the purchase. The relationship may be that: If Merchant A did not suggest the purchase to Bob but only allowed Bob to take the discount elsewhere, Merchant A receives $1 back; and if Merchant A did suggest Bob to the used motorcycle shop, Merchant A receives $1 back plus 10% of the $3,000 purchase from Merchant B as those two Merchants have worked out the deal on the Affiliate Company's Business-for-Business Merchant Portal. The $1 that Merchant A receives back in this scenario may be paid from the Affiliate Company itself, as the Affiliate company may generate interest on the credit while it sits in escrow waiting to be used, or Affiliate Company may earn this token from commissions Affiliate Company collects from Merchant B for the use of the credit.

Affiliate System may reside or make use of Existing Systems to accomplish and implement affiliate in-store tracking, joint-coupon tracking, payment withholding system, and all other parts of the affiliate system. The Affiliate System may make use of an existing or customized system, including but not limited to systems of: credit card processing system, Gift Card system, Loyalty card system, Gift Certificate system. Or the system may be a new Affiliate Card system, or a new Affiliate System with or without Affiliate Cards. The system may rely on a hybrid system that utilizes parts of existing systems in new ways, and parts of a new system, jointly working together to accomplish all aspects of the Affiliate System.

Methods of Integrating and Introducing Affiliate System: The new Affiliate System as it relates to elements such as joint coupon tracking and in-store coupon tracking may be introduced as a new Affiliate Platform, may make use of an existing gift card system, may make use of an existing credit card system, ISO system, or gateway, may make use of any other system, or it may make use of a combination of systems. As the new Affiliate System relates to stock market and other forms of trade and exchange, the existing stock systems, markets, online portals such as Forex, and other systems may be used. According to one method, there may be the introduction of a new “Affiliate Platform” which may operate directly with a Processor such as First Data, Elavon, or Heartland, or it may be at a lower level in the processing flow such as with an ISO or Gateway, or it may even be a Gateway software on the Merchant's terminal, laptop, hosting server, or other device. For practicality, all Merchants in the Affiliate System may be on the same platform. One way to have Merchants operating on the same platform may be to have all Merchants on one platform, a new “Affiliate Platform.” A second way to achieve the effect of Merchants operating on the same platform may be to have a module, portal, gateway, or other means to interface with existing Platforms to bridge them to one new “Affiliate Platform.” This interface may join one or several Platforms to one “Affiliate Platform.” For example, transaction data from Merchant A on the Omaha Platform may pass through a gateway connecting Omaha Platform to the Affiliate Platform. According to another example, transaction data from Merchant A on the Omaha Platform passes through a gateway connecting Omaha Platform to the Affiliate Platform, and transaction data from Merchant B on the Nashville Platform passes through a gateway connecting Nashville Platform to the Affiliate Platform, thereby allowing Merchant A and Merchant B to be on a unified compatible Affiliate System via the Affiliate Platform, which may assist with those two merchants interacting and running Joint Ventures such as Joint Coupons, and assisting in the tracking of affiliate commissions and distribution of awards and revenue from one Merchant to the other. A third way to achieve the effect of Merchants operating on the same platform may be to have a module, portal, gateway, or other means to interface with existing Platforms to bridge them to each other, which may in turn by joined to an Affiliate Platform. An example may be a module that allows the Omaha Platform and Nashville Platform to interact, and those interactions may then be sent to the Affiliate Platform, or those interactions may reside between the Omaha and Nashville Platforms without a separate Affiliate Platform. Multiple systems, gateways, and platforms may be used in the Affiliate System, or alongside the Affiliate System, in various ways. An example may be Merchant A using an Authorize.net online Gateway for e-commerce, and Merchant B using an in-store terminal that sends data to an Omaha Platform; both systems may send to the collective Affiliate Platform, and may make use of an Affiliate Gateway to collect, transfer, and communicate data back and forth between each system and the Affiliate Platform. The Affiliate Platform thereby acts as a bridge joining the two separate systems and allowing them to interact and function, which may be used to make the Affiliate System function. Information communicated on the Affiliate System may be all day, or a portion of the data, and the other portion of the data may reside on a separate system. For example; credit card data may be sent through the traditional means of accepting credit cards, while affiliate coupon data may be sent through a separate Affiliate Tracking system; or the data may be sent together on the same system. Information may be sent and distributed through separate channels, gateways, and platforms or may all be sent via the same channel, gateway, and platform. Therefore, the system may operate on multiple platforms, and multiple gateways if needed. A method and system of verifying and communicating data such as an invalid or valid credit card, rebates, chargebacks, and other entities may be in place regardless of if the entire process resides on one Affiliate system, or if multiple systems are used to process a charge and transmit affiliate data. A new Affiliate Platform may function by allowing data to flow through network(s), and in the case where a credit card is used then a credit card may be processed and charged on the same system or on a separate system that works in tandem or cooperates with the Affiliate System. The Affiliate Platform may provide new functions, or may make use of existing functions, systems, and equipment to achieve the Affiliate System. Method B: Use of existing Gift Card System may be an effective way of implementing the Affiliate System. A module, gateway, platform, plug in, customizations of certain functions, or other means may be established to utilize the existing Gift Card System to achieve the results of the Affiliate System. This may be true for all elements and features of the Affiliate System, including but not limited to coupon tracking, joint coupons, a commission and payout system, a points or credit system, a cash system, symbiotic business and business-for-business, and any other features. Another method may be to use an existing ISO company setup, or Gateway, or other system or interface may be an effective way of implementing the Affiliate System. A module, gateway, platform, plug in, customizations of certain functions, or other means may be established to utilize the existing ISO system, Gateway, or other system or interface to achieve the results of the Affiliate System. This may be true for all elements and features of the Affiliate System, including but not limited to coupon tracking, joint coupons, a commission and payout system, a points or credit system, a cash system, symbiotic business and business-for-business, and any other features.

Applications to Other Systems including Stock Market, Trade, Real Estate, and Other Markets may exist. A market such as a stock market, a business such as a brokerage or hedge fund, or a system such as Forex.com may make use of the Affiliate System, or the new Economic Models introduced by the present invention. One way may be that a Stock Broker may be a form of an Affiliate, where that Affiliate may take in Sub-Affiliates, thereby the Stock Broker may recruit Sub-Stock-Brokers and receive a commission which may be awarded as a momentary value or as shares of stock, and the Stock Broker may be seen as a Primary Affiliate in a reverse pyramid commission split. The Reverse Pyramid commission split may be in effect where stock brokers who make the trade receive the best commission in the chain of other brokers above. By buying into one stock, a Consumer, Trader, or Broker may receive a discount on the purchase or trade of another stock, allowing for the method of a Joint Stock Discount or Joint Stock Promotion. Preventative measures may be put in place so that a competitor of a company does not promote a discount on a short sell of the competition, thereby there may be a safety measure that may thwart any possible attempt to lower the value of a competitor's stock. Companies in the stock market may form Symbiotic Business Relationships in a system similar to Business-for-Business, where those companies may then form Networks or Alliances that offer a new item of Stock Package or Stock Baskets. A Stock Package or Stock Basket may be a collective combination of various stocks from the respective various companies; in a way this may provide a product or even a single unit of trade that encompasses several stocks, which may provide the benefits of a Mutual Fund in a small, singular item or package. Another example may be by buying Stock A, a broker receives a discount on Stock B. Another concept of the present invention relating to stocks, may be that an award to an affiliate or points owed to a consumer may be exchanged or transferred to Stock, and likewise Stock may be transferred to Affiliate Points, which may in turn be converted into a Monetary value, or the Stock may be traded for services or products from a Merchant. Real Estate Agents may likewise be Affiliates in the Reverse Pyramid model, or in the Affiliate tracking model, or in any of the other models. International trade markets, even countries themselves, may utilize models of this patent. For example: countries may be seen as Affiliates in international trade; the Unites States runs a Joint Coupon with Russia, and they tell China that if China cuts down on greenhouse gas emissions from its cars (a “Political Coupon”), China may receive a Discount in the tax rate charged to China for imports and exports. Or the United States and Russia may tell Canada that if Canada buys Canada's oil supply from Russia, and purchases its gold reserves from the Unites States, Canada will see a 3% increase in its land ownership of the first 100 miles along the border of northern Alaska. Another scenario may be a country like the United States forming an Alliance with Spain to help a third world country like the Congo, where both make donations to the Congo and receive a reduction in debt owed to China on the bonds China holds, or a tax deduction of some sort, or for a mutual gain and investment in the Congo over the long-term. In this example China may trade the US bonds for bonds in the Congo, thereby giving bonds back to the Unites States to forgive the debt owed by the Unites States to China, while the United States donates some of its technology to the Congo, which increases the long-term value and potential of the Congo, and therefore increases the value of the bond China now has invested (and traded to receive) in the Congo; all three countries benefit and use resources of different elements and types to form this Symbiotic Relationship. Customer posts what they want, such as the product they desire, on their Consumer User Account page or on a directory page within the Affiliate System Network. A customer, shopper, etc. posts desired service, product, business-type, etc. Agents skim through postings (online or kiosk for in-person), and notify customer (by email or a reply-posting or other) of the agent's suggestion . . . which may be the best deal/best product/lowest-cost, etc. Agent can supply a coupon code (with or without their affiliate ID); an agent can receive a commission through the tracked coupon, a store owner can put out a coupon without having to pay a third party agent's commission, etc. The posting may have the option of specifying location/region, budget, time frame/deadlines, and other classifications. This effectively lets someone else do the shopping for the shopper (or the stock analysis for the stock bidder, etc.); and allows either a commission for the service to be exchanged as a finders-fee, or allows an agent/affiliate to receive commission on the sale as with an Affiliate Program.

The Affiliate System Website Interface may include Portals, Network Categories, Network Types, Venture Types, and other elements, as well as functions such as payroll, ability to transfer funds (including but not limited to monetary value, points, or credits), ability to generate coupons, and other components of the Affiliate System. There may likewise be portals and interfaces for the Affiliate Gateway, and portals and interfaces for the Affiliate Platform, for management and maintenance of the Affiliate System—these may be accessible via the Website Interface, or may be accessible on their own systems. Website Interface may integrate with Affiliate Gateway, Affiliate Platform, and additional gateways and portals, as well as outside systems. Data sent through the Affiliate System may be stored and that data displayable in a manner where it may be interacted with by different types of users such as Admin, Merchant, Affiliate, or Consumer. For example, an Affiliate logs into the Affiliate Portal on the Affiliate Company's website, where they view the number of sales and commission amounts they have made instore and online. The data that is displayed to the Affiliate has arrived to the database on the website after properly passing through the Affiliate Gateway and Affiliate Processor. In this example the Affiliate has made $10,000 in sales with 10% commission yielding $1,000 to the Affiliate. The Affiliate tells the system to convert $100 into Affiliate Points, where $1 equals 10 Affiliate Points, and where use of Affiliate Points at a participating Merchant on the Affiliate Network yields a bonus 10% in Affiliate Points, ultimately giving Affiliate 1,100 Affiliate Points for use at a Merchant on the network (a $110 monetary value if used with a Merchant on the Network, rather than a $100 value). The Affiliate then tells the website to automatically wire the remaining $900 into Affiliate's bank account as directly accessible monetary funds. The Affiliate then browses the Merchant Network part of the Affiliate Network, selecting a new Merchant to enroll with or begin a new relationship with. The Affiliate is automatically accepted into new Merchant's plan because that Merchant has allowed automatic acceptance from Affiliates of a particular status, and Affiliate has met those requirements because of their excellent sales record that has crossed a certain threshold in sales, commissions, or other. Affiliate notes that Merchant A has a Joint Venture with Merchant B, and Affiliate opts in on a cross promotional Joint Coupon where Merchant A, Merchant B, and Affiliate may receive a commission from Merchant A and/or Merchant B for the sale. Affiliate posts this coupon on his Public Affiliate Site, such as example.com/Bob123, where friends and family of Affiliate or the public can view and print eligible coupons, and such public visitors to the site may also follow links for the same coupon for online purchases thereby allowing affiliate tracking by cookies or other online means. Once the coupon is used in-store, or a purchase is made after a customer follows the online link, Affiliate sees the purchase in their online Affiliate Account after logging into the Affiliate Portal. Affiliate must wait 30 days to receive awards from commissions earned on those purchases, where the value may be placed in an Escrow account. The option may exist where Escrow period may be reduced if credits will be used towards a purchase by Affiliate at that Merchant, or at another Merchant on the Affiliate Network. From Affiliate's Account, Affiliate then decides to make and print business cards from their control panel, and orders the business cards from a Merchant on the Affiliate Network, thereby Affiliate Company may receive a commission on the sale of those business cards as Affiliate Company provided the customer to the Merchant by advertising Merchant's services to the Affiliate or by simply having the components in place that allowed Affiliate to search for print shops on the Affiliate Network (the Affiliate Company provided the Merchant to the Customer, and the Customer to the Merchant, through the Affiliate Network on the Affiliate System).

Multiple Portals and User Interfaces may exist on the website of Affiliate Company or Affiliate System Portals and user interfaces may include but are not limited to Affiliate Company Admin Portal, Merchant Portal, Affiliate Portal, Consumer Portal, and other portals may exist such as ISO Portal, Bank Portal, and others. The website may interact with system data such as the data from an Affiliate Gateway and/or an Affiliate Platform, a payroll or payment system, a system for refunds or chargebacks, and any third party or other systems, to transfer funds/points/awards/tokens/stocks/bonds in the system. The website may provide formation of and agreement to contracts and other forms of engagement allowing Merchants, Affiliates, Consumers, and other parties to form these types of relationships. The Affiliate Website may make suggestions to Affiliate, Consumer, or suggestions to Merchant based on purchase history of a Consumer, or based on products sold by Affiliate or products offered by Merchant, or based on other data; therefore Affiliate Company may receive extra commission for providing this Lead. An affiliate company could provide leads to earn extra commission. A feedback or review system may likewise be accessed from within the user interface of the Merchant, Affiliate, Consumer, or other. Merchant Portal may be the online interface where Merchant logs in from laptop, mobile phone, or other device to access the Merchant User Account. From the Merchant User Account, Merchant may utilize the Business-for-Business (aka Business 4 Business, or Symbiotic Business) application where the Merchant can search for other Merchants to form Joint Ventures with, such as Joint Coupons or Cross Promotions. Merchant may use the interface to generate coupons, affiliate links, join in pooled advertisements and create ads for those advertisements, find affiliates, and other tasks. Merchant may form communities, pools, or networks with other Merchants. Merchant may search for and engage services of another Merchant, and may receive discount, or both Merchants may agree to do a trade for services of equal or similar value. Merchant may update their account settings, payment options, public profile, private network profile, upload products into an online database or storefront, and more. Affiliate Portal may be the online interface where Affiliate logs in from laptop, mobile phone, or other device to access the Affiliate User Account. From the Affiliate User Account, Affiliate may utilize the Affiliate-for-Merchant application where the Affiliate can search for Merchants to promote the products of. Affiliate may also use the system to form pools, communities, or other networks with other Affiliates in an Affiliate-for-Affiliate system. Affiliate may also receive offers from Merchants or groups, communities, networks, or alliances of Merchants to promote products of those Merchants. Affiliate may likewise receive inquiries from Consumers, such as a Consumer asking where a deal may be for a snowboard, and Affiliate may likewise search and find a deal within Affiliate's existing network (or Affiliate may form a new relationship to provide Consumer with what customer desires), and Affiliate may provide a coupon and/or a product suggestion and/or a suggestion of a particular Merchant or network of Merchants to Consumer. Similarly, Affiliate may browse for Consumers, such as by recent purchases of a Consumer, or Affiliate may browse a “help me find” directory where Consumers have posted what they are seeking. Affiliate System Website may automatically search such directories and provide leads to Affiliate, and Affiliate System may therefore Affiliate Company may receive extra commission for providing this Lead to the Affiliate. Affiliate may use the interface to generate coupons, affiliate links, join in pooled advertisements of other Merchants or Affiliates and create ads for those advertisements, find Merchants, find Affiliates, and other tasks. Affiliate may form communities, pools, or networks with other Affiliates. Affiliate may publish a public or private directory, such as in a newspaper ad or on a unique website, where Affiliate may refer Customers or Customers may subscribe to such a directory of Affiliate's promotions. Affiliate may visit the Stats section where they may view history and detailed tracking results, as well as view commissions earned. Affiliate may visit the Award Center where they may designate how and when to receive awards, where they may have the option to reinvest an award to earn interest in an Escrow savings account or convert award from one asset type to another such as money into points and vice versa, points into stock and vice versa, stock into money and vice versa, credit into money and vice versa, and other options. If Affiliate is also a Consumer, Affiliate may have their Affiliate User Interface combined with their Consumer User Interface, allowing many additional options such as the ability for Affiliate to apply awards received as a Consumer (such as points received or reinvested from the discount amount on a purchase) towards their Affiliate commissions earned. The vice-versa may also be true, where an Affiliate may transfer awards earned as an Affiliate into an award usable as a Consumer (such as transferring $100 in Affiliate commission into 1,000 Affiliate Points useable as a Consumer, and receiving an extra 100 Affiliate Points by using a Merchant in the Affiliate System Network). Consumer Portal may be the online interface where Consumer logs in from laptop, mobile phone, or other device to access the Consumer User Account. From the Consumer User Account, Consumer may search for products, deals, Merchants, Affiliates, or other desired entities. Consumer may use the interface form communities, pools, or networks with other Consumers, which may help those consumers receive Group Discounts; such Consumers or Groups of Consumers may then receive alerts from Merchants, Affiliates, other Consumers, or from the Affiliate System Network itself that notify Customers of particular Group Deals at Merchants on the Network. Consumers may view their history of transactions such as purchases, trades, or exchanges. Consumers may transfer awards from one type to another, such as transferring Affiliate Points into redeemable Cash. For Example, a Consumer may receive 1,000 Affiliate Points for each purchase over $100 in the month of January from any participating Merchant in the Affiliate System Network, in addition to receiving 5% discount from a Joint Coupon promoting a pool of Merchants in a particular town; 1,000 Affiliate points may a cash value such as $10, and in this Example Consumer has earned 10,000 Affiliate Points by spending $100 at 10 Merchants ($1,000 spent collectively by Consumer); consumer converts those Affiliate Points into cash by logging into their Consumer User Account, and after 30 day Escrow period consumer receives a check for $100 plus $1 from the interest money earned while in Escrow savings during the thirty day hold. Consumer may likewise opt to use their Affiliate Points towards a purchase at a Merchant in the Affiliate Network System or within a specific Network of Merchants (such as the Merchant Network of that same town the promotion was in), and may receive a higher award by using those Affiliate Points towards a Merchant in that Network (such as 11,000 points instead of 10,000 points, which may be in addition to other discounts applied to the same purchase). Consumers may receive offers from Affiliate, Merchant, or Affiliate System in their account or by email, and Consumer may opt in or out of such notifications, alerts, and suggestions. Consumer may likewise filter what kinds of deals are offered, such as only allowing a particular product or a discount over a certain threshold (or a sale amount under a certain threshold) for a particular product, or only allowing deals to be offered from a certain Affiliate or Affiliate Network, Merchant or Merchant Network. Consumer may select such Affiliate or Affiliate Network/Alliance, Merchant or Merchant Network/Alliance, or may rely upon Affiliate of Merchants in high standing and rankings from feedback generated from others such as other Consumers. An example of an offer sent to a Consumer may be a notice that says, “With the item you just purchased, there was a Symbiotic Coupon/Joint Coupon, did you know that? Now you can get it as a rebate on the first purchase you have just made as well as a discount on the second purchase you may now make with this coupon.” Furthermore, a product for purchase at Merchant B may require consumer to purchase that item at Merchant A, thereby allowing Consumer to receive exclusive access to a product, and such relationship may be notified to Consumer in the Consumer's User Account such as with a message saying, “If you buy this refrigerator, you will have access to buy this new convertible hybrid car 6 months before the car is released to the general public for purchase.” With Advanced Purchase Tracking in the Affiliate System, a Consumer may be alerted just prior to the point of sale (or the moment when a purchase or trade may be about to occur), such as an alert of a Dual Coupon Code or Joint Coupon Code that would allow Consumer to receive a discount if two products are purchased (from one Merchant, or several Merchants); these products may reside in the same store, or may reside at multiple locations. Such an alert may be achieved by methods such as a radio identifier, a scan gun that accompanies the Consumer while they shop (such as hand-held or on the shopping cart); or for online purchases each website of each Merchant participating in the Affiliate System may have a designated space that would allow a Deal (such as a discount with a Joint Coupon or Second Purchase Coupon) to be displayed; such display on Merchant's website may be achieved by any means such as manual entry by host Merchant (which may come with an incentive to host Merchant such as being a Dual Agent with Affiliate Company on the lead, or an incentive such as a discount on host Merchant's fees within the system), or by Affiliate System and Affiliate Company sending information via a feed such as through an Api feed, RSS feed, iframe, or other such method. Merchants may be required to designate a set amount of space on their websites for such a feed, or may opt into it for an incentive such as ability to be a Dual Agent or ability to receive Discounts on Affiliate System fees. Participating merchant websites may have an Api feed or RSS feed for Symbiotic Deals across the Affiliate System. Alerts sent to a Consumer may be Merchant A acting as an affiliate to Merchant B, or the Affiliate System and Affiliate Company acting as Affiliate to Merchant B with use of Advanced Purchase Tracking (and may require a Symbiotic Relationship or pre-negotiation with Affiliate Company and Merchant in the system, or may require no pre-negotiation where Affiliate Company may have full right to simply opt in to any existing promotions eligible to Affiliates; or Affiliate Company may benefit by only collecting the fees related to the sale occurring through or as a result of the Affiliate System, which may be a portion of what an Affiliate would normally collect). Alerts may be received by Consumer User Account, as well as by email, text, phone call, printed on receipts after purchases or trade, or other means.

Network Categories may be used to find others and form relationships, ventures, deals, or other such engagements. Relationships within Network Categories may be formed via a Merchant User Account, Affiliate User Account, Consumer User Account, or other. Relationships may be suggested to the parties by others in the Affiliate System, or by the Affiliate System itself (which may be based on data such as products a consumer has purchased or Merchants an Affiliate has solicited to Consumers, or by using technology to determine what kinds of relationships similar parties have engaged in on the Affiliate System Network). Network Categories may include: Merchant(s) finding Merchant(s) (which may be called “Business-for-Business”, “Symbiotic Business”); Affiliate(s) finding Affiliate(s) (which may be called “Affiliate-for-Affiliate,” and for Example may allow Affiliates to strive for Group Thresholds or Group Goals that may yield higher commissions or additional awards once threshold achieved); Affiliate(s) (or Networks of Affiliates) finding Merchant(s); Merchant(s) finding Affiliate(s) (similar to Affiliates finding Merchants); Consumer(s) finding Affiliate(s); Affiliate(s) finding Consumer(s); Consumer(s) finding Consumer(s) (where Consumers may form a Consumer Network, Consumer Pool, or Consumer Alliance to receive Group Discounts, Community Discounts, or Pooled Discounts—this may be similar to how Merchants may form such Networks and relationships with other Merchants, and Affiliates may form such relationships with other Affiliates); Consumer(s) finding Merchant(s) (or Consumers finding Groups/Networks of Merchants, or Groups/Networks of Consumers finding Merchants, or Groups/Networks of Consumers finding Groups/Networks of Merchants); Merchant(s) finding Consumer(s) (or Merchants finding Groups/Networks of Consumers); and any other possible categories. Seeking parties or seeking relationships with parties is thus different from Consumers seeking deals, or Consumers seeking products; although the two concepts may be interrelated, such as with a Consumer being alerted that a particular item of interest has a discount through a particular Affiliate. An individual or Group/Network may search for another individual or Group; such as a Network, Group, Community, Pool, Alliance, or other bulk formation of more than one party being searched for and discovered by an individual party or other Groups/Networks seeking a particular product, exchange, trade, relationship formation, joint coupon venture, or other such partnership, deal, or exchange.

Network Types may be between two parties (where a party may be an individual, or a Group/Network/Pool/Alliance), or it may be between multiple parties. An Example may be ten or more Merchants forming a Business Alliance; A Network may be formed by region including but not limited to a street, town, city, or by type such as a product line of clothing, food, entertainment, and any other types, fields, or other possible factors. Networks and individuals (parties) may embark on Ventures, Relationships, Contracts, or other such engagements. Venture Types may be Joint Coupons, Foundation Accounts for discounts, or other such relationships. An example of a Venture for Affiliates may be a pool of ten agents reaching a higher collective goal to receive a higher residual split.

The Affiliate System may apply the model to itself in several ways, especially by allowing roles to be shared or blended, where a Party in the system may act as a different Type of Party. A party type may be an Affiliate Company, Affiliate, Merchant, Consumer, or Other. One method of the Affiliate System applying the Model to itself may be that the Affiliate Company act as or count as a Merchant, and the Affiliate System or enrollment on the Affiliate System behave or function as a Product. This would allow Affiliate Company to give a reward to an Affiliate for signing up Merchants and Consumers into the Affiliate System, and furthermore an Affiliate may be considered a Primary Agent (or “Primary Affiliate”) to each Merchant and Consumer so that Affiliate receive a commission on every sale and purchase by, for, or to Merchant and Consumer. Affiliate Company may allow Affiliates to resell services of the Affiliate System, potentially even allowing Affiliates to carry their own brand or label as a reseller under a different company name. For Example: Merchant A would normally pay $150 to subscribe and enroll in the Affiliate System if signed up directly through the Affiliate Company; however Merchant A receives a discount of $50 by going through Affiliate A, so that Merchant pays only $100 to join Affiliate System, and Affiliate Company in turn pays Affiliate A a commission of $50, so that ultimately Affiliate Company makes $50 instead of $150, Affiliate A makes $50 instead of $0, and Merchant pays $50 instead of $150. The Merchant may have a greater incentive to pay to join the Affiliate System Network in this method because the Merchant may act more impulsively at a deal, than at the regular retail value. The Affiliate Company may have a greater incentive, even though it does not make as much profit on that exact deal, because the method may lead to the Affiliate System spreading like wildfire through the encouragement of Affiliates to promote and sell the Affiliate System itself. Also by allowing Affiliates to promote and sell Affiliate Systems and other services of Affiliate Company, an Affiliate may be introduced into the role of being an Affiliate, where the party (person, business, charity, hedgefund, or other) becomes an Affiliate in the Affiliate System and may continue to make more sales of subscription to the Affiliate System and sales of products provided by other Merchants. Additionally, jobs are created by the formation and encouragement of Affiliates, which helps grow the economy, thereby producing more eligible Consumers, and yielding more purchases where commissions may be earned. A second example may an Affiliate starting an office in Chicago, and therefore being a Primary Affiliate to anyone that office subscribes in that region; and the Affiliate's office may even carry the brand of “Bob's Business for Business Solutions” rather than “Affiliate Company Name” (assuming the Affiliate name is “Bob” in this example). The Affiliate may receive an award such as a sign up bonus, or even may receive residuals as a Primary Affiliate to each party Affiliate subscribes or enrolls into the Affiliate System. The Affiliate Company may list itself as a Merchant with its services as a product within its own Affiliate System or Affiliate Network, as well as within the system or network of another outside Affiliate Company, such as on the network of a competitor. The Affiliate Company may even allow other Affiliate Companies and other Affiliate Systems to be listed as Merchants and products on its own system. A second method of the Affiliate System applying the model to itself may be that the Affiliate Company act as or be considered an Affiliate, and/or the Affiliate System act as or be considered a Referrer. The Affiliate Company may be considered an Affiliate within its own Affiliate System, or within a separate Affiliate Company's outside Affiliate System. The Affiliate Company may advertise products of its Merchants in the User Accounts of Merchants, Affiliates, Consumers, or Other or on public pages of the Affiliate Company Website, where Affiliate Company may earn commission on products sold through such advertisements of goods or services. Affiliate Company may likewise own a company such as an ISO company, print shop for business cards, domain registration company and receive profits on its own goods sold through this mass-advertisement network. Affiliate Company may put measures in place to deter competition with Merchants in the Affiliate System, so that Affiliate Company does not take away from business that could go to the Merchants who are subscribed in the Affiliate System. A third method of the Affiliate System applying the Model to itself may be that a Merchant may be an Affiliate. A Merchant may subscribe other Merchants or its own customers, where Merchant may be a Primary Affiliate to those it encourages to enroll in the Affiliate System Network, allowing Merchant to receive commission on every future sale or transaction from one of those Merchants, Affiliate, or Consumers introduced into the system. A fourth method of the Affiliate System applying the model to itself may be that an Affiliate may be a Consumer, and likewise a Consumer may be an Affiliate. A fifth method of the Affiliate System applying the model to itself may be that a Merchant is a Consumer. Other methods may exist, there may be many combinations.

Merchants may form Product Baskets, combining items of multiple businesses into one conglomerate product. This may be achieved through Business-for-Business system in the Affiliate System Network.

The entire system applies to online merchants and in-store merchants. The system may be on an existing Auction system; such as an online Auction site, where a purchase from one Seller may yield a discount to a second Seller, with the ability to have a Retroactive Rebate.

Business-for-Business does not need an Affiliate System to exist. It may allow a Cross Promo to form without commissions, sales agents, and/or joint coupons. Business-for-Business, Ventures (such as Joint Coupons), and all other aspects may apply to online Merchants, in-store Merchants, and both. Joint Coupons may be used online, in-store, or both. For Example, Merchant A may be an online store, and Merchant B may be an in-store business, and the two may run a cross promotion and a Joint Coupon with each other. The system also does not need Consumers to exist; it may be Trade between brokers, services exchanged between businesses in a fair trade, etc.

A Rebate Coupon may act as a Joint Coupon, or may be used as a Merchant-acting-as-Affiliate where the Merchant may give a coupon to a product customer may like without having a Joint Coupon connection in place. A Rebate Coupon may be offered to a Consumer giving a rebate to a purchase from Merchant A, and a discount to Merchant B, if Consumer makes that second purchase at Merchant B. This rebate coupon may be delivered to Consumer after the sale of the first purchase at Merchant A. The rebate coupon may be delivered on a printed receipt, in Consumer's User Account on the Affiliate System Network, on the price tag or product tag of the item, in materials or literature that accompany the product, as a coupon in the store's bag, as a coupon printed on the store's bag, on a slip of paper on a box shipped to the merchant, on the postage stamp placed by the mailing company (where the mailing company may receive a commission as an Affiliate or a Dual Affiliate), or any other means. The Rebate Coupon may be used online, or in-store for both receiving credit on the first purchase at Merchant A, and in the second purchase at Merchant B. The Rebate Coupon may be shown to only one of the two Merchants for both Rebate and Discount to be applied, or it may be shown to both, or it may be entered into the Affiliate System for both Rebate and Discount to be applied. A Consumer may buy a product online, see the Rebate Coupon at the end of the purchase, where the details or Merchant advertised on the Rebate Coupon may be determined by data gathered from the Consumer's geographical area, cookie sessions, Consumer purchase history, or other. This Rebate Coupon may be delivered by Merchant A, Affiliate Company, or both, and either or both parties may receive and affiliate commission on the use at second sale. A Rebate Coupon may be a Retroactive Rebate, where it automatically applies the discount after the purchase has been made, and this may occur at the exact point of sale at the second purchase.

By way of system definition, the Credit Card Company deals with consumers, and has banks that deal with consumers. Examples of credit card companies may be Visa, Mastercard, Amex and Discover. A Processor is a Company that does the actual processing. Manages the Platform. All Tier one (1) Processors have many Platforms, Gateways, or both. Examples of Tier1 Processors include: First Data, Heartland, Evalon (formerly Nova). A platform is a System that charges the card and does the actual processing. Platform is for industry specific kind of processing, and can be seen as the software that allows it to happen. It is run by the Processor, processors like FirstData use at least 15 platforms. For example; one platform for restaurants, another for gas stations. See it as the “receiving” and data execution side of a transaction, the side the Charge is actually done on. Different platforms include Omaha, Nashville, Memphis, etc. A Gateway allows Payment Card Industries compliance (PCI compliance) for IT based transactions, encryptions, and security. The portal between the transaction, and the platform. In some cases, such as an ecommerce site, there may be a portal on the ecommerce site that then sends a feed via an api to the Gateway, and the Gateway in turn sends the data on to the Processor. It is the interface that also allows a Merchant to log online via a Gateway like Authorize.net, and manually charge a credit card. See it as the data gathering side of a transaction, the side the Merchant or Customer interacts with. Examples of platforms are Authorize.net, Getty, etc. A bank deposits money from Visa/MC to Merchant's account, etc. There are also Equipment Companies which are outside companies that produce equipment and technology. These may operate with internal software (for example; a Gift Card system may use its own internal Gateway). There are also Gift Card systems; in this case, entire systems and equipment, altering the processing flow and using a credits or point system or other docketing system or fund addition/subtraction system. There is terminal equipment which may be Wireless (refurbished phone, or other device) or in Store (may use phone wire to connect or Ethernet connection), etc. The terminal equipment swipes the credit card. Cash Registers; may plug into Terminals, or be combined with them, etc. There may be Scan guns and software; Software and equipment to scan barcodes and process the data. There may be a Wedge which Plugs in to a computer USB device. The wedge may be used by Merchant to swipe a physical credit card at their computer, or can be used by a consumer when placing an online purchase (allows consumer to swipe physical credit card for online orders.

An Independent Sales Organization (ISO) deals with Merchants (sends Merchants monthly statements), and with Agents who solicit the Merchants. Connects Merchants terminal with a gateway and/or platform via a Processor, often determining the best platform to put the merchant on. Agents solicit Merchants, brings them to the ISO Company, often negotiates rate for Merchant and for ISO Company, lands the deal with the Merchant and signs them up to process. A Merchant runs a business, finds customers, charges the cards of the consumer. A consumer, runs the economy and buys things that keeps Merchant and everyone else in business.

The present invention may operates directly with Processor, or may be at a lower level in the processing flow such as with the ISO or Gateway, or even may be a Gateway software on Merchant's terminal or laptop or hosting server. This provides practicality by providing all Merchants to be on the same platform. All Merchants may be on one (1) Platform; a new “Affiliate Platform”. Alternatively, there may be a module to interface with existing Platforms to bridge them to one new “Affiliate Platform” (A Gateway joining one or several Platforms to one “Affiliate Platform”). According to another embodiment that may be a module to interface existing Platforms to have them cooperate together (A Gateway to join two or several Platforms with each other). The New “Affiliate Platform” functions and allows data to flow through network, and in the case where a credit card is used for a credit card be processed and charged.

The present invention is intended to work in conjunction with, or customize functions of existing Gift Card systems, existing gateways and/or ISO Company Setups.

As a general summary, all examples herein are simplified version of the true flow of how entities such as a credit card are charged, and are to simplify the illustrations of the true nature of this patent: affiliate tracking in-store and online, cross-promotion tracking in-store and online, joint coupon tracking in-store and online, withholding payment for an affiliate at the exact point of sale both in-store and online, issuing a rebate to a consumer instantly at point of sale both in-store and online, businesses finding other businesses and forming networks and joint ventures, and other key initiatives of this patent. Terms such as “Processor Gateway” may be interchangeable with similar terms such as “Gateway,” “Payment Gateway,” and possibly even “Platform” or “Processor.” In addition to such a Gateway(s) or Platform(s), there may be an additional Affiliate Gateway, Affiliate Processor, or both involved in the process.

Terms have been abbreviated as such: where “PG/PPF” may be “Processor Gateway” and/or “Processor Platform” and may or may not be used always with the phrase “and/or ISO/P”; where “ISO/P” may be an “Independent Sales Organization” and/or “Processor”; where “AG” may be an “Affiliate Gateway”; where “AP” may be an “Affiliate Platform” or an “Affiliate Processor”; and where an “Affiliate” may be an Agent, Affiliate, Referrer, Reseller, among other such entities.

Steps may come in different orders and sequences, and may be combined with other steps or other elements and other systems. Different methods may require different steps within them to happen. Certain parts of a system may or may not be used, and may or may not be present for the other components to exist or other events to occur. For example: Payment by Cash with an active credit card system at a Merchant's store counter may be different than Payment by Cash without an active credit card system in place at the Merchant's store counter. For another example: a Gift Card system may alter the steps need in ‘Section D, Method 1, option A’ (where a Data Packet may be first sent to Processor Gateway and/or Platform and/or ISO/P along with credit card data, and then second to an Affiliate Gateway and/or AP ); in this example, the Affiliate Data gathered from the Affiliate Identifier on a coupon or on an Affiliate Card may be sent along with data on a Gift Card system or on a Gift Card itself, in place of or along with a credit card system.

Multiple systems may be in place, including but not limited to: a system(s) of a Merchant Charging a Consumer; a system(s) of Transferring Data (such as affiliate data, purchase data, and payment information); a system(s) of Withholding Funds; a system(s) of Transferring Funds; a system(s) of Tracking; a system(s) of Credits, Chargebacks, Refunds, and Returns; a System of Payouts.

A System of Store Charging Customer may be included in a System of Transferring Data; or it may be an entirely separate step and process. The purpose may be to charge a consumer, collect money from a consumer, or other means of exchanging a token. This may be done via Credit Card, cash, Gift Card, Loyalty Card, a new Affiliate Card, Gift Certificate, or any other means.

A System of Transferring Data may provide the purpose of Data Collection and Data Transfer to Processor Gateway and/or ISO/P, Affiliate Gateway and/or Affiliate Platform and/or Affiliate Processor. There may be various methods of transferring such Data or Data Packets through various servers and computers. Data may be a coupon code, affiliate code and/or an affiliate identifier, price, commission, and/or any and all other information, and may be a Data Packet or a Data Package. Desired data may be tracked, providing the ability to track affiliate data, cross-promotional data, commission data, and/or coupon code tracking, among other possibilities. There may be several methods of transferring data. Withholding and Fund Collection may integrate into all method steps, or may occur after the circuit of transferring data is complete, or at any other point in the overall process of the Affiliate Processing System or Affiliate System. Chargebacks and Refunds may likewise occur at any point in the Data Transfer circuit, and may occur as an add-on to a Data Transfer circuit or may occur after the Data Transfer circuit is complete, as well as after other circuits are complete. A Payment System may add on or occur after the Transferring Data circuit is complete, as well as after a Chargeback and Refunds circuit is complete.

One method of a System Transferring Data to the Affiliate System may be via being transferred along with Credit Card data to a Processor Gateway and/or ISO/Platform/Processor and/or an Affiliate Gateway, Affiliate Platform, and/or Affiliate Processor. One option of this first method may be a Data Packet sent to a Processor Gateway and/or ISO/P first (1st), then second (2nd) to an Affiliate Gateway and/or Affiliate Platform and/or Affiliate Processor. A second option of this first method may be Simultaneously to Processor Gateway (and/or ISO/P) & Affiliate Gateway and/or Affiliate Platform and/or Affiliate Processor. A third option of this first method may be Data Packet sent 1st to Affiliate Gateway and/or Affiliate Platform and/or Affiliate Processor, then 2nd to a Processor Gateway. A fourth option of this first method may be a Manual option or other means, such as a Merchant entering the data on their laptop in the store. A second method may be a system to Pay by Cash while a system such as a Credit Card System is in Place; this may operate on a Credit Card System, Gift Card System, Affiliate Card system, Affiliate System, Manual, or other. One option of this second method may be the Use of a Credit Card System to transmit Data, while another option may be a manual entry. A third method may provide a Manual system; where there may be Payment by Cash with No Credit Card System in Place. One option of a Manual system may be data Entered by Store Owner (or by Customer—there are several options), and a second option may be to exclusively have a new Affiliate Gateway and/or Affiliate Platform and/or Affiliate Processor system. Such a new Affiliate Gateway and/or Affiliate Platform and/or Affiliate Processor system may make use of existing equipment such as a terminal, cash register, laptop, mobile phone, wedge; or it may require new equipment to be manufactured; or a mix of both. A device or software that Identifies which System, Method, or Circuit to follow may reside on existing equipment such as terminal or cash register, or may reside on new Affiliate Equipment; and it may communicate with a database of Processor Gateway, ISO/P, and/or Affiliate Gateway and/or Affiliate Platform and/or Affiliate Processor. Existing equipment such as terminal or cash register can be pre-programmed to identify the network setup the system is on, or it can seek it each time, or other.

When the consumer gives a coupon to the merchant, and the merchant swipes that coupon in, a system on a device at the point of sale (such as a software on the terminal or register) will recognize that an Affiliate Coupon has been used, and will determine if it will use the circuit of an existing credit card system, or the circuit of the affiliate system; and will determine if consumer is paying by credit card (which may mean funds instantly withheld at time of transaction by withholding a portion of that credit card charge and putting it to an Affiliate escrow account) or by cash (which may mean funds allocated from Merchant escrow account and into an Affiliate escrow account). It is also envisioned that every step of the invention may be performed on computer coupled to a network. Also, it is envisioned that that the present invention provides methods and systems for transforming referrals into an award of at least one promotion between a consumer, merchant, and at least one affiliate.

One method of a System Transferring Data to the Affiliate System may be via being transferred along with Credit Card data to a Processor Gateway and/or ISO/Platform/Processor and/or an Affiliate Gateway, Affiliate Platform, and/or Affiliate Processor. One option of this first method may be a Data Packet sent to a Processor Gateway and/or ISO/P first (1st), then second (2nd) to an Affiliate Gateway and/or Affiliate Platform and/or Affiliate Processor. A second option of this first method may be Simultaneously to Processor Gateway (and/or ISO/P ) & Affiliate Gateway and/or Affiliate Platform and/or Affiliate Processor. A third option of this first method may be Data Packet sent 1^{st} to Affiliate Gateway and/or Affiliate Platform and/or Affiliate Processor, then 2^{nd} to a Processor Gateway. A fourth option of this first method may be a Manual option or other means, such as a Merchant entering the data on their laptop in the store. A second method may be a system to Pay by Cash while a system such as a Credit Card System is in Place; this may operate on a Credit Card System, Gift Card System, Affiliate Card system, Affiliate System, Manual, or other. One option of this second method may be the Use of a Credit Card System to transmit Data, while another option may be a manual entry. A third method may provide a Manual system; where there may be Payment by Cash with No Credit Card System in Place. One option of a Manual system may be data Entered by Store Owner (or by Customer—there are several options), and a second option may be to exclusively have a new Affiliate Gateway and/or Affiliate Platform and/or Affiliate Processor system. Such a new Affiliate Gateway and/or Affiliate Platform and/or Affiliate Processor system may make use of existing equipment such as a terminal, cash register, laptop, mobile phone, wedge; or it may require new equipment to be manufactured; or a mix of both. A device or software that Identifies which System, Method, or Circuit to follow may reside on existing equipment such as terminal or cash register, or may reside on new Affiliate Equipment; and it may communicate with a database of Processor Gateway, ISO/P, and/or Affiliate Gateway and/or Affiliate Platform and/or Affiliate Processor. Existing equipment such as terminal or cash register can be pre-programmed to identify the network setup the system is on, or it can seek it each time, or other.

One method of a System Transferring Data to the Affiliate System may be via being transferred along with Credit Card data to a Processor Gateway and/or ISO/P; this may be along with Credit Card data, Gift Card Data, Loyalty Card data, Gift Certificate Data, or any other data. OPTION A may be a Data Packet sent to a Processor Gateway and/or ISO/P first (1st), then second (2nd) to an Affiliate Gateway and/or Affiliate Platform and/or Affiliate Processor. First data may be sent to a Processor Gateway and/or ISO/P. Second the data packet may be sent from Processor Gateway and/or ISO/P to Affiliate Company (or outside database for storing this data). Third, a System of Withholdings may then occur to withhold, collect, or transfer funds for the Affiliate and Affiliate company. Fourth, a Tracking System of affiliate, store owner, PG/PPF, and AG and/or AP to view Trackings. Fifth, a System of Credits, Chargebacks, Refunds, and/or Returns may be in place to interact with a Tracking System and Withholding System. Sixth, a System of Payouts to Affiliate, PG/PPF or ISO/P, Affiliate Gateway and/or Affiliate Platform and/or Affiliate Processor may be in place. It shall be noted that steps three through six (3-6); System of Withholdings, System of Tracking, System of Credits/Chargebacks/Returns/and Refunds, and System of Payouts; may be combined with other steps, or other elements, other methods, and other systems. A complete circuit for “Method 1, Option A” may be as follows: First; A Coupon may be swiped (with a bar code or otherwise), keyed in, or identifying data entered or recorded in any other way. Second, a System Selection may occur to provide Identification and Selection of what system and method shall be used to process and transmit data (such selection can be manual, or automated by machine or system), thereby selecting the proper circuit to follow. System Selection may be activated by coupon swipe or bar code alerting equipment or system, or activated manually, or by any other means. Third; If there is no credit card system in place, or purchase is not done with credit card, another method may be used. If a credit card (or gift card or loyalty card) is in place, information may then be sent to Processor Gateway and/or ISO/P and/or Affiliate Company. A typical method of charging a card may occur, where data may be sent to Processor Gateway and/or ISO/P with info such as the Credit Card number, Purchase Amount, Merchant ID, any other data (such as Customer name, order number), and a Data Packet that may include an Affiliate Code, Price, and any other information. Or, a typical method of charging a card may occur, with the addition of an Affiliate Gateway and/or Affiliate Platform being combined as the same gateway of the Processor Gateway and same platform as the Processor Platform, or may occur as a separate additional Affiliate Gateway and/or Affiliate Platform. Fourth; A card (such as credit card, gift card, loyalty card, or Affiliate Card) may be authorized. Authorization may be accomplished by a process or a process similar to a Processor Gateway sending and receiving encrypted data from the Merchant, then sending data to a Platform, then sending data to a Processor and/or Merchant Bank, then sending data to a Card Network (such as Visa, Mastercard, Discover, American Express), then sending data to the Consumer's card-issuing bank (such as CitiBank, Chase, Wells Fargo, Bank of America), then a response of approval or decline and a possible authorization number being transmitted back to the Platform or Processor or Processor Gateway, then the Platform or Processor or Processor Gateway sending the approval with authorization number or decline response to the Merchant. Fifth; A card (such as a credit card or gift card) may be charged effectively if a charge is authorized. Sixth; If a charge is authorized, data may be sent in two directions, and it may be different data sent in each direction. If a charge is authorized and competed, data may be returned to store signifying the charge was authorized and completed, and Data may be simultaneously sent to Affiliate Gateway and/or Affiliate Platform and/or Affiliate Processor, containing Data Package. Data sent to Affiliate Gateway and/or Affiliate Platform and/or Affiliate Processor may contain only Data Package, or may contain more data. If a charge is not authorized and is thereby declined and rejected, data may still be sent in two directions, and it may be different data sent in each direction. If a charge is not completed or rejected or declined; data may be sent or returned to Merchant signifying charge was not authorized; and a notice of decline simultaneously sent to Affiliate Gateway and/or Affiliate Platform and/or Affiliate Processor; and the Affiliate Gateway and/or Affiliate Platform and/or Affiliate Processor may purge the Pending data from its system, move it in a temporary database, or allow it to remain in Pending for a set period of time. Seventh; an Affiliate Gateway and/or Affiliate Platform may update the status of a successful order and any activate any remaining processes to proceed, or they may signify an order has been declined and thereby communicate that the remaining process remain idle or cancel. Eighth; other Systems such as Payment Withholding, a Payout System, a Refund/Chargeback System, and a Tracking System may occur. Option B may be a Data Packet sent Simultaneously to Processor Gateway (and/or ISO/P) & Affiliate Gateway and/or Affiliate Platform and/or Affiliate Processor. A summary of this option may be as follows: First, data may be simultaneously sent to a Processor Gateway (and/or Processor Platform), at the same time it is sent to an Affiliate Gateway (and/or Affiliate Platform and/or Affiliate Processor). Second, the Affiliate Gateway and/or Affiliate Platform and/or Affiliate Processor may therefore need a “confirmation” of charge once circuit completes. Third, a System of Withholding to withhold, collect, and transfer funds for the Affiliate and Affiliate company may occur. Fourth, a System of Trackings to track sales to Affiliate, from Merchant, PG/PPF, and AG to view trackings. Fifth, a System of Chargebacks, credits, refunds , and returns may be in place and may interact with the Withholding system to thereby take funds from escrow and return those funds to Consumer. Sixth, a System of Payouts may occur to pay the Affiliate, Affiliate Company, ISO/P, Processor Gateway/PPF, and other parties. These steps may come in different orders, and can be combined with other steps or other elements and other systems. A complete circuit for Option B may be as follows: First; a referral identifier such as a coupon may be swiped (bar code or otherwise), keyed in, or identifying data entered/recorded any other way. Second; System Selection may occur to Identify and Select a system, circuit, and method to follow (this selection process can be manual, or automated by machine or system). One way this may be automated, may be activation by the coupon swipe or a bar code alerting equipment or system. Third; There may not be a credit card, gift card, loyalty card system in place; or there may be such a system in place. If such a system is in place, data may be sent to Processor Gateway and/or Processor Platform (and/or ISO/P company) & simultaneously sent to Affiliate Gateway and/or Affiliate Platform and/or Affiliate Processor and/or Affiliate Company. The Affiliate Gateway may be combined as the same gateway of the Processor Gateway, and the Affiliate Platform may be combined as the same platform of the Processor Platform; or they may be separate and have a bridge to communicate data between the two. A typical method of charging a credit card may occur, where first the data may be sent to a Processor Gateway (and/or ISO/P ) & to Affiliate Gateway and/or Affiliate Platform and/or Affiliate Processor containing credit card #, purchase amount, merchant ID, other data (such as customer name, order number), and a Data packet (which may include affiliate code, price, and other info) (note that an Affiliate Gateway and/or Affiliate Platform and/or Affiliate Processor may not need to receive ‘a’ Credit Card number, or full number. Processor Gateway may not need to receive ‘e’ affiliate code). Next the data may be saved by the Affiliate Gateway and/or Affiliate Platform and/or Affiliate Processor; such as being flagged in a “Pending Mode” or in a separate intermediary database, and the exact timing and location of this can fluctuate in the process. Fourth; a credit card may be authorized in a manner similar to a Processor Gateway sending and receiving encrypted data from merchant; then a Platform acts upon the data; then a Processor and/or Merchant Bank process that data; then a Card Network (such as Visa, MC, Discover, Amex) process the data; then a Consumer's card issuing bank (such as CitiBank, Chase) process the data; then a response of approval or decline may be sent to the Processor Gateway (and may be sent simultaneously to an Affiliate Gateway at this point); then the Processor Gateway may send response of authorization or decline to Merchant (and may be sent simultaneously to an Affiliate Gateway at this point). Fifth; the credit card is charged (effectively) if authorized. Sixth; Data may be simultaneously sent in two directions, and may be different data in each direction. If the charge is authorized and completed; Data may be returned to store or Merchant signifying the charge was authorized and completed; at the same time, Confirmation may be simultaneously sent to the Affiliate Gateway and/or Affiliate Platform and/or Affiliate Processor; then the Affiliate Gateway and/or Affiliate Platform and/or Affiliate Processor may update data from “Pending” to “Confirmed” status, or may push data from an intermediary database to a primary database. If the card is not charged or completed (such as if rejected); Data may be returned to the Merchant signifying the charge was not authorized; At the same time, a Notice of decline may be simultaneously sent to the Affiliate Gateway and/or Affiliate Platform and/or Affiliate Processor; and the Affiliate Gateway and/or Affiliate Platform and/or Affiliate Processor may purge the Pending data from its system, move it in a temporary database, or allow it to remain in Pending for a set period of time. Seventh; the Affiliate Gateway and/or Affiliate Platform and/or Affiliate Processor may update the status of the order as successful and allow remaining processes to proceed, or if the order declined the remaining processes may remain idle or may be cancelled. Eighth; other system may activate, such as Payment Withholding, Payout System, Tracking System, and others. Option C may be a Data Packet sent first (1^{st}) to Affiliate Gateway and/or Affiliate Platform and/or Affiliate Processor then second (2^{nd}) to Processor Gateway and/or Processor Platform and/or Processor. A Summary of Option C may be: First; data may be sent to the Affiliate Gateway and/or Affiliate Platform and/or Affiliate Processor first (1st). Second; Data may be sent to the Processor Gateway and/or Processor Platform and/or Processor second (2nd). Third, the Affiliate Gateway and/or Affiliate Platform and/or Affiliate Processor may therefore need a “confirmation” of charge once circuit completes. Fourth; a System of Withholding to withhold, collect, and transfer funds for the Affiliate and Affiliate company may occur. Fifth; a System of Trackings to track sales to Affiliate, from Merchant, PG/PPF, and AG to view trackings. Sixth; a System of Chargebacks, credits, refunds , and returns may be in place and may interact with the Withholding system to thereby take funds from escrow and return those funds to Consumer. Seventh; a System of Payouts may occur to pay the Affiliate, Affiliate Company, ISO/P, Processor Gateway/PPF, and other parties. These steps may come in different orders, and can be combined with other steps or other elements and other systems. A complete circuit for Option C may be as follows: First; a referral identifier such as a coupon may be swiped (bar code or otherwise), keyed in, or identifying data entered/recorded any other way. Second; System Selection may occur to Identify and Select a system, circuit, and method to follow (this selection process can be manual, or automated by machine or system). One way this may be automated, may be activation by the coupon swipe or a bar code alerting equipment or system. Third; Information and data may be sent to the Affiliate Gateway and/or Affiliate Platform and/or Affiliate Processor. The Affiliate Gateway and/or Affiliate Platform and/or Affiliate Processor may be combined as the same gateway of the Processor Gateway. A typical method of charging a credit card may occur, where first the data may be sent to a Processor Gateway (and/or ISO/P ) & to Affiliate Gateway and/or Affiliate Platform and/or Affiliate Processor containing credit card #, purchase amount, merchant ID, other data (such as customer name, order number), and a Data packet (which may include affiliate code, price, and other info) (note that an Affiliate Gateway and/or Affiliate Platform and/or Affiliate Processor may not need to receive ‘a’ Credit Card number, or full number. Processor Gateway may not need to receive ‘e’ affiliate code). Next the data may be saved by the Affiliate Gateway and/or Affiliate Platform and/or Affiliate Processor; such as being flagged in a “Pending Mode” or in a separate intermediary database, and the exact timing and location of this can fluctuate in the process. Fourth; a credit card may be authorized in a manner similar to a Processor Gateway sending and receiving encrypted data from merchant; then a Platform acts upon the data; then a Processor and/or Merchant Bank process that data; then a Card Network (such as Visa, MC, Discover, Amex) process the data; then a Consumer's card issuing bank (such as CitiBank, Chase) process the data; then a response of approval or decline may be sent to the Processor Gateway (and may be sent simultaneously to an Affiliate Gateway at this point); then the Processor Gateway may send response of authorization or decline to Merchant (and may be sent simultaneously to an Affiliate Gateway at this point). Fifth; the credit card is charged (effectively) if authorized. Sixth; Data may be simultaneously sent in two directions, and may be different data in each direction. If the charge is authorized and completed; Data may be returned to store or Merchant signifying the charge was authorized and completed; at the same time, Confirmation may be simultaneously sent to the Affiliate Gateway and/or Affiliate Platform and/or Affiliate Processor; then the Affiliate Gateway and/or Affiliate Platform and/or Affiliate Processor may update data from “Pending” to “Confirmed” status, or may push data from an intermediary database to a primary database. If the card is not charged or completed (such as if rejected); Data may be returned to the Merchant signifying the charge was not authorized; At the same time, a Notice of decline may be simultaneously sent to the Affiliate Gateway and/or Affiliate Platform and/or Affiliate Processor; and the Affiliate Gateway and/or Affiliate Platform and/or Affiliate Processor may purge the Pending data from its system, move it in a temporary database, or allow it to remain in Pending for a set period of time. Seventh; the Affiliate Gateway and/or Affiliate Platform and/or Affiliate Processor may update the status of the order as successful and allow remaining processes to proceed, or if the order declined the remaining processes may remain idle or may be cancelled. Eighth; other system may activate, such as Payment Withholding, Payout System, Tracking System, and others. Option D may include other means such as Manual. A Merchant may have a system or laptop where software or a gateway may gather information via manual entry from the store clerk, or customer, or both.

A second method of a System Transferring Data to the Affiliate System may be via Payment by Cash while a System (such as a Credit Card System, Gift Card System, Loyalty Card System, Gift Certificate System, Coupon System, or Affiliate card System) is in place; (herein “Section D, Method 2”). The purpose of this may be to accept payments by cash or other hand-delivered tokens, and make use of the existing system (such as a Credit Card System) to transmit data and allow for tracking of data (such as Affiliate referral identifier, Customer identification, and other information). Option A may provide Use of a Credit card System to transmit Data, and a system similar to “Method 1” may be used. A complete circuit may be as follows: First; A Coupon may be swiped (with a bar code or otherwise), keyed in, or identifying data entered or recorded in any other way. Second, a System Selection may occur to provide Identification and Selection of what system and method shall be used to process and transmit data (such selection can be manual, or automated by machine or system), thereby selecting the proper circuit to follow. System Selection may be activated by coupon swipe or bar code alerting equipment or system, or activated manually, or by any other means. System selection may identify if there is no credit card system in place, if there is a credit card system in place, and if a consumer paying by cash may make use of a credit card system or not. Third; A typical method of charging a card may occur; however rather than credit card data transmitted, Affiliate data may be transmitted; where data may be sent to Processor Gateway and/or ISO/P with info such as the Purchase Amount, Merchant ID, any other data (such as Customer name, order number), and a Data Packet that may include an Affiliate Code, Price, and any other information. Fourth; information may then be sent to the Affiliate Gateway and/or Affiliate Platform and/or Affiliate Processor. This may also be the Processor Gateway and/or ISO/P company. Data may be sent simultaneously to PG/PPF and/or ISO/P at the same time sent to AG/AP, or AG/AP can receive first (1^{st}), or PG/PPF can receive first (1^{st}). (See Method 1 options A, B, C). Fifth; Data may be saved in the Affiliate Gateway and/or Affiliate Platform and/or Affiliate Processor, and/or in the Affiliate System. Sixth; data may be sent to the Merchant or store; Confirming the affiliate sale/commission was tracked (As in other sections of this patent, Merchant or store owner may log in via portal to update or modify any settings, and can be tracked by affiliate and affiliate company, etc.); Data may be sent via PG/PPF and/or ISO/P system, AG/AP system; If there is an error (such as loss of connection to AG/AP system or PG/PPF system): An error message to store may be sent to store, PG/PPF, AG/AP (may be to any and all parties that can receive such message), and Data may be stored in-store manually or by a data system in store. There may be in store equipment such as terminal or cash register, other equipment, etc. Data may be stored in PG/PPF or other database. Seventh; other system may activate, such as Payment Withholding, Payout System, Tracking System, and others. OPTION B may include other means such as Manual. Even if Credit Card system is in place, store owner/merchant or Affiliate Company or other party may elect to process manually. A Merchant may have a system or laptop where software or a gateway may gather information via manual entry from the store clerk, or customer, or both. OPTION C may be the use of any other system.

A third method of a System Transferring Data to the Affiliate System may be via Payment by Cash without a traditional Card System in place (such as a Credit Card System, Gift Card System, Loyalty Card System, Gift Certificate System, Coupon System) is in place; (herein “Section D, Method 3”). The purpose may be if a consumer pays with cash, and no credit card system is in place, to allow tracking of affiliate data and other information, as well as to allow withholding and payouts. Option A may be manually entry be Merchant /store owner, or by consumer. A complete circuit may follow other methods; briefly listed here are abbreviations to highlight the differences: First; a consumer may pay with cash. Second; a Coupon may be swiped at the register containing an Affiliate Identifier. Third; a Selection System may identify the merchant's store identification number in the Affiliate Network System, as well as the Affiliate's referrer i.d. Selection components and program to make this work can exist on equipment such as a terminal, cash register, merchant's laptop, special box, or other equipment. Fourth; Data may be stored and sent. Data may be saved in an Affiliate Gateway and/or Affiliate Platform and/or Affiliate Processor, and/or Affiliate System. The Merchant may then go online using a lap top and enter in a promo code, reference number, affiliate identifier, purchase amount, and other information. The time period for the merchant to do this may be any time; during transaction, after transaction, daily, weekly, etc. To accomplish this, the Merchant may Log in to Affiliate Network System via Merchant Control Panel, and access their unique Merchant User Account. The merchant may also accomplish transmission of data via phone call, texting, email, and any other means. The merchant and consumer may both enter in data, or only one may enter in data. The consumer may enter data in the store via a special register or designated laptop or a designated wireless device such as a terminal or phone, or may return home to log into the Affiliate Network System and access their Consumer User Account via the Customer Control Panel or access a Coupon Reporting tool; where the consumer enters in coupon code, promo code, affiliate identifier, and any other data. Incentives may exist for the consumer, such as the award of a discount, rebate, or gift certificate. Such an award may be mailed by Affiliate Company (or Merchant, or Affiliate, or other), and may be deducted from the amount Affiliate Company withholds (or calculated into cost Affiliate Company receives from Merchant, etc.—There may be several means of calculating withholding cost Affiliate Company Receives). Another incentive to Consumer to submit Tracking data may be the entry of Consumer into a sweepstakes drawing upon data submission. Fifth; other system may activate, such as Payment Withholding, Payout System, Tracking System, and others. Sixth; Withholdings and Payouts may be deducted from Merchant's bank account, or an escrow account, so that even if a Consumer pays with cash the money may be ensured to be available to the Affiliate and Affiliate Company, and the money may be instantly deducted from Merchant's account at time of payment or soon thereafter (and paid directly to Affiliate and Affiliate Company, or placed into another escrow account for Affiliate and Affiliate Company). Option B may be the exclusive use of an Affiliate Gateway and/or Affiliate Platform and/or Affiliate Processor on a new, unique Affiliate System. The purpose may be to essentially bypass systems such as a credit card system as listed in other methods; this may be done for stores that do not have credit card systems, or to keep data and transactions operating on separate systems for any reason (including but not limited to any security concerns that may be associated with using a credit card system). This may achieved by using special equipment, terminals, a laptop, and may be on a network like that of a credit card company only no credit card needs to be charges. There may be a purchase with use of a credit card on the credit card system, and simultaneously use of affiliate data tracked on the affiliate system, if a credit card is needed for a purchase. The Merchant/Store owner may still have funds instantly withheld or transferred from a bank account. The Affiliate System may be connected to a banking system like how a PG/PPF system and bank system operate, or it may be setup differently. The Merchant may be Exclusively connected to the Affiliate System via unique equipment (such as a special terminal, or special box, or refurbished cash register, or laptop with a gateway or software, or wedge, or mobile phone with scanning capabilities to transmit coupon images or data from identifiers); which may be on a connection such as a wireless, or Ethernet, or phone connection, or any other connection or way of transmitting data. An Affiliate Gateway may send data to an Affiliate Platform, which in turn may send data to an Affiliate Processor, which may send authorization back to Merchant to complete the circuit, along with a system of Withholdings, a system of Returns, and a system of Payouts.

There may be a System of Withholdings (herein “Section W”); where the purpose may be to withhold, reserve, collect, and/or transfer funds to the Affiliate and Affiliate Company. Funds may be monetary amount, or a points token, or other award to an Affiliate, Affiliate Company, or other party. This may be different than the system of withdrawing funds from a customer's card and placing it in the merchant's bank account, or it may reside on the same system and circuitry and operate as one system. This may be on the same system as a credit card system, or be built into the same system, to intercept the payment, transfer or reroute a portion of the funds from a consumer's purchase. Or this may operate on a different system (such as an invoice system where payment is received after store owner receives the full money from the charge). This may be used to withhold Commissions, and serve as a Collection System for Payments, and a system to Transfer Funds for Collections and Payments. Payment may be withheld for Affiliate, Primary Affiliate, Sub Affiliate, Affiliate Company, ISO, Processor, Bank, Credit Card Company (Visa, MasterCard, etc.), Merchant, Consumer (such as for an award like a gift certificate, rebate, or discount towards a second purchase), taxes (to provide instant tax payment to the government for any party that would receive the funds), and any other party. The PG/PPF may be the same system as the AG, or the two systems may be separate where the Affiliate/Referrer and Affiliate Company may be on the AG system but may use the PG/PPF system to receive funds. This may be separate from ISO/P withholding payout). This may be on the same system as ISO/P; as the ISO/P may be the Affiliate System, the Affiliate System can be the ISO/P. This may be on a separate system other than ISO/P, such as that of a bank, or other. Method 1 of Withholdings may be Funds withheld at Time of Transaction. Method 2 of Withholdings may be Funds withheld manually. Method 3 of Withholdings may be funds withheld partially manually. Method 4 of Withholdings may be funds withheld periodically. Any other method may also exist.

Method 1 for a System of Withholdings (“Section W”) may be Funds Withheld at Time of Transaction. Funds may be monetary amount, or a points token, or other award to an Affiliate, Affiliate Company, or other party. The purpose may be to instantly withhold and reserve commissions and fees due to Affiliate and/or Affiliate Company and/or any other party. This may be provided by Affiliate System without requiring Merchant to calculate, channel, or pay funds manually. However, a manual system may still exist as an optional approach, and there may be a choice between automatic or manual withholdings where the Merchant, Affiliate Company, ISO/P, and/or others in the process may choose. Manual may also serve as a backup strategy in case of system failure with the automated system, and may exist as an alternative means of achieving the process. A Refund System may be manual or automatic, to provide Credits, Chargebacks, and Refunds. Withholdings may be placed into an Escrow account, where interest may be shared among different parties such as Affiliate, Merchant, Affiliate Company, Consumer, Bank, and other. Chargebacks, returns, refunds, and the like may be withdrawn from funds that were reserved by the Withholdings system. In this way, even if there is a chargeback and funds were returned to Consumer, interest earned while funds were in Escrow may help Merchant offset the costs associated with the loss from the chargeback. Fund Withholding may happen at any step such as after a charge is authorized, before deposit reaches Merchant's bank account, or any step in the process. Fund Withholding may occur at any time such as Point of Sale (the exact moment a purchase is made by a consumer at a store counter or online), Daily batches, or periodically. Funds Withheld may come from many sources or one source; such as a bank account, after funds have been collected from a credit card company such as Visa or MasterCard (which may be similar to how some ISO/P companies collect their funds from the merchant); or may come directly from the credit card company; or may come directly from Merchant/Store's bank account, after Merchant collects funds from credit card company or consumer (regardless of if payment comes in form of cash or credit or points); or another account that may be created to collect funds and then disperse those funds. Funds may be dispersed to a Merchant's bank account, where “bank account” may refer to any type of account or system of holding funds, such as a Paypal account, trade account, points system, etc. Funds may be dispersed to the Affiliate Company (Affiliate Company may have another collective account that collects and disperses it to each affiliate's respective account, may have an account per unique affiliate, or other). Funds may be dispersed to an Affiliate Company's Collective Affiliate Account, where the Affiliate Company may have a collective account that collects and disperses funds to each affiliate's respective account, may have an account per unique affiliate, or other. Funds may be dispersed to Affiliate; which may be the Affiliate's Affiliate account in Affiliate System and may be an actual bank account, a points system in their Affiliate User Account, or a docketing/recording system, or a system such as Paypal; or Affiliate's Bank account outside of the Affiliate System; or a mixture of several of these, similar to how there may be both a Paypal account and a Bank account. There may be an escrow account different from where funds are deposits to or withdrawn from by PG/PPF and/or ISO/P. Funds may be taken from account of bank and/or ISO/P, that would be used to also pay Merchant's bank account. Funds may come from a bank and/or ISO/P and/or the account, and even Merchant's own company (for example: How an ISO/P is paid from the bank after bank collects money from Visa after charging a customer's card; ISO/P is generally paid). Merchant facilitation/intervention may or may not be allowed. An example of where Merchant facilitation/intervention may be allowed may be a Manual System, or where Merchant approves or authorizes the fund withholding (for example: this may be at terminal, cash register, or on laptop and may be done during daily batches, or may be achieved from an online Merchant Account Interface on the Affiliate Network System). Funds may be divided in several ways. One way funds may be divided may be with the ISO/P, Affiliate and Affiliate Company separate. A second way funds may be divided may be with the ISO/P, Affiliate and Affiliate Company combined. The Affiliate and Affiliate Company may be together or not. Funds may come from the bank, and may come from one charge to consumer's card. One option may be that PG/PPF or Bank (or other) puts funds into one Affiliate Gateway or Affiliate Company account. Another option may be that the PG/PPF or Bank (or other) puts funds into two Affiliate Gateway or Affiliate Company accounts; where one account may be designated for Affiliate Company, the other account may be designated as an escrow account for the Affiliate. This may exist as one overall collective account for all affiliates, separate from Affiliate Company's earnings; then that account gives to each Affiliate's own individual account, and may deposit funds put in each Affiliate's account on instant, daily, monthly, or any other time frame (although holding funds in escrow for a period of time may assist with chargebacks, refunds, returns, and certain awards that may be given to consumer). Or each Affiliate/Referrer may have their own separate and unique award/payment collection account. There may be an extra account for PG/PPF, and PG/PPF may receive its funds on the same processing system or on a different system, and on the same billing system or different system. Funds may be combined in the cost taken from Merchant (and may be sorted and separated later), or funds may be separate at the moment funds are taken from the merchant (may take funds separately from Affiliate Gateway system where Merchant sees withholdings for the Affiliate, and another set of withholdings for the Affiliate Company, and another set of Withholdings for the Consumer thereby operating as separate itemized charges to Merchant's account). Funds from AG, PG/PPF, ISO/P, Bank may be commission per transaction, monthly service fee, any and all types. There may not be entities such as a PG/PPF.

Method 2 for a System of Withholdings (“Section W”) may be Funds Withheld Manually. Funds may be monetary amount, or a points token, or other award to an Affiliate, Affiliate Company, or other party. Funds paid manually may be provided by Merchant, or by escrow account managed by Affiliate Company where Affiliate Company may receive deposits from Merchant in advance. Payments may be daily, weekly, or monthly, or even instantly at time of transaction (such as with Affiliate Company migrating funds from escrow account into Affiliate's account when a transaction takes place). Invoice to Merchant for payment of Affiliate's commission may come from the Affiliate Server Site, where Affiliate Gateway/Affiliate System has been operating. The Merchant may log in to their Merchant User Account via the Merchant Portal or Merchant Control Panel on the Affiliate Network System, enter data (such as purchase amount, commission amount, referral identifier, promotion code, affiliate identity, or other), and then may transfer funds from Merchant's account (bank account, Paypal account, points system, award offering to Affiliate, or other such account or exchange). Such a transfer of funds or award may be automatic by Affiliate System taking funds, as with an automated invoice and payment collections system, or may be manually “pushed” through by Merchant. It shall be noted that Tracking System may be manual, Fund Withholding System may be Manual; one system may be automated while the other system may be manual; or both systems may be automated. A manual Tracking System may operate similarly to a manual Fund Withholding System, where the Merchant may log into their Merchant User Account on the Affiliate Network System and enter in data that will be used to track a purchase, affiliate identifier, coupon code, or other information.

Method 3 for a System of Withholdings (“Section W”) may be Funds Withheld Partially Manually. Funds may be monetary amount, or a points token, or other award to an Affiliate, Affiliate Company, or other party. Equipment or other entity may collect data at the time of a sale, the Merchant may then manually initiate affiliate commission to go through or not. For example; a Consumer uses an affiliate's coupon code in the store which is identified and tracked by a special scan gun and sent throughout the Affiliate System, where it is recorded in a database on the Affiliate System, so that the Merchant may log in later that night from home and see the transaction details and commissions owed to Affiliate, and Merchant may then manually press a button to confirm the payout owed to Affiliate, thereby confirming funds that must be Withheld and sent to escrow. Tracking and Withholding may be at Point of Sale, daily batches, or other, and may be accomplished by logging in to the Merchant User Account.

Method 4 for a System of Withholdings (“Section W”) may be Funds paid automatically on a Period schedule. Funds may be monetary amount, or a points token, or other award to an Affiliate, Affiliate Company, or other party. Funds may be paid in batches sent out in any timeframe including but not limited to daily, four times a day, weekly, monthly, at point of sale, annually, or any other.

A Rebate may be mailed or electronically sent by Affiliate Company (or Merchant, or other), and may be deducted from the amount Affiliate Company withholds (or calculated into cost Affiliate Company receives from Merchant, etc.). There may be several means of calculating withholding cost Affiliate Company Receives.

Technical specifications may account for a Tracking System in a partnership, Network, or Joint Venture. A Payout Reserve System may withhold funds for both an Affiliate and Affiliate Company at the same moment in time. A commission split for a Primary Affiliate may be delivered from the Affiliate Company after the fact, or may be split and reserved prior to it (so there may be three payout reserves; a reserve for the Affiliate of Sale, a reserve for the Primary Affiliate, and a reserve for the Affiliate Company).

There may be a System of Payouts (herein “Section P”); where the purpose may be to disperse awards or make payments to Affiliate, Affiliate Company, ISO/P (such as fee collection), Consumer (such as bonus award with a retroactive rebate or gift certificate or points), and any other party. In One Method/Approach, the Affiliate System may collect commissions for All parties involved, except the ISO/P separately collects credit card processing fees from Merchant (if this is on a credit card system; if on a gift card system, it may be the gift card company, and so forth). In a Second Method/Approach, the Affiliate System may collect awards or commissions for only the Affiliate System, Affiliate Company, and Affiliate; and the ISO/P may collect the credit card processing and its fees (including any additional fees such as those associated with a third-party Electronic Check Card reader system). In a Third Method/Approach, the Affiliate System may collect awards or commissions for only the Affiliate System and Affiliate Company; and the ISO/P collects credit card charges, its fees, and Affiliate commissions (such as if an affiliate in the Affiliate Network is also an Agent within the ISO company, or a referring store in the system, etc.). In a Fourth Method/Approach the ISO/P may collect awards and fees for all involved. In a Fifth Method/Approach the Affiliate System or Affiliate Company may collect awards and fees for all involved. In all methods/approaches, the party that collects fees may be responsible for issues payouts to all parties involved, or may issue one overall payout to the Affiliate Company who may then disperse fees/awards to all parties involved. The party that collects awards/fees may receive compensation for this task, as may the party that disperses awards/commissions. Other methods and approaches may include any other system, and any other party such as a bank, stock market, and other. Payouts may be different than the payouts system used by the ISO/P, or may be on the same system.

There may be a Gift Card System & Group Gift Cards System (herein “Section G”); where the purpose may be to provide groups of gift cards. For example: A consumer may purchase a gift card or gift certificate for a region, which may be used at any shop in that area. The affiliate tracking and cross-promotion system may work within this gift-card system. For example: one store may give out a group gift card good for purchases in the entire town, and that store receives a commission on all those purchases at all those other stores where that card is used by the consumer who received the card from the merchant. Commission to this Affiliate Merchant may be paid from each Merchant where an award is received by consumer's purchase using the card or coupon or other identified, or the Affiliate Merchant may receive payment from the Affiliate System or Affiliate Company who has collectively gathered all commissions owed to the Affiliate Merchant. There may be the use of both a Gift Card, and an Affiliate Coupon. There may be two affiliates for a commission (dual affiliates) on one consumer; and by way of example one dual affiliate may give consumer a gift card (such as a gift certificate with a balance of $5 on it), and the other dual affiliate may give the consumer a coupon for 5% discount on their purchase, and consumer may use both the gift card with a balance and the discount coupon at their next purchase, and both dual affiliates receive a split commission. This may be used for Gift Cards, Loyalty Cards, Gift Certificates, Credit Cards, a new Affiliate Card, and any other such item. This may be used for any payment method, including cash or points. There may be precautions for chargebacks, returns, in-store credit on returns (such as the agent keeping money as a merchant keeps money if a consumer is given store credit rather than their money back). There may be manual options. There may be monitoring options by owner, Merchant, affiliate, ISO/P, Affiliate Company, Consumer, and other parties.

It should be understood that the foregoing relates to preferred embodiments of the invention and that modifications may be made without departing from the spirit and scope of the invention as set forth in the following claims.

I claim:

1. A method for managing referrals between a consumer, merchant, and at least one affiliate, wherein a first affiliate is a primary affiliate and subsequent affiliates are sub-affiliates;
generating a referral identifier by a referral identifier generator in a computer processor coupled to a network for an affiliate to give at least one consumer, said referral identifier representing a promotional offer for at least one consumer;
accepting and tracking said referral identifier from said at least one consumer in an affiliate tracking system in a computer processor coupled to a network;
awarding said at least one consumer at least one promotion according to said referral identifier;
determining the core set by said merchant;
determining the core reserve according to said core and at least consumers purchase history with at least one merchant store;
awarding said primary affiliate at least one affiliate reward according to said at core reserve and each said subaffiliate at least one affiliate reward according to said core reserve; and
awarding said merchant at least one merchant reward according to said at least one consumers purchase history with at least one merchant store and said core.

2. A method as in claim 1, wherein said core reserve is selected from the group consisting of core reserve, exponential split, equal split, divided with exponential disbursement, pooled community reserve pyramid and reserve pyramid.

3. A method as in claim 1, wherein said affiliate reward is an affiliate bonus according to the number of subaffiliates signed up by said primary affiliate.

4. A method as in claim 1, wherein said referral identifier is selected from the group consisting of a coupon, joint coupon, discount with joint coupon, award with joint coupon, rebate with joint coupon, Radio Frequency Identifier Coupon, computer generated link, mobile phone coupon, signal delivered coupon, referrer coupon, coupon code, system generated automated coupon code, consumer card, coupon card, and consumer coupon card.

5. A method as in claim 1, wherein said affiliate tracking system for accepting said referral identifier is offline.

6. A method as in claim 1, further comprising a subaffiliate referral identifier generated by said referral identifier generator, and further comprising the step of:
awarding said subaffiliate at least one affiliate reward according to said at least one consumers purchase history.

7. A method as in claim 1, wherein said referral identifier is a joint coupon and said at least one consumer is awarded at least one promotion according to said referral identifier, wherein said affiliate is also a second affiliate and said first affiliate and said second affiliate are each awarded at least one reward according to said at least one consumers purchase history with at least one store.

8. A method as in claim 1, wherein said referral identifier is a pooled advertisement.

9. A method as in claim 1, wherein said merchant is also an affiliate.

10. A method as in claim 1, further comprising a computer implemented networked directory wherein said at least one of said merchant and said affiliate selects at least one of said merchant and said affiliate to create at least one symbiotic relationship.

11. A method as in claim 10, wherein said symbiotic relationship is selected from the group consisting of joint venture, agent relationships, merchant relationships, merchant-agent relationship, networks, partnership networks and business alliance.

12. A method as in claim 1, wherein at least two of said merchants, subaffiliates and affiliates have an affiliate award agreement.

13. A method as in claim 1, wherein said affiliate tracking system is selected from the group consisting of In-Store Affiliate Tracking, Advanced Purchase Tracking, Advanced Credit-Card Tracking, Advanced Customer Tracking, Advanced Sales Tracking and Tracking by Elements.

14. A method as in claim 1, wherein said at least one promotion is selected from the group consisting of a points system, cross-promotion marketing, affiliate points, collective card system, collective points systems, stock package, stock back and product basket.

15. A method as in claim 1, wherein at least one affiliate is a middle affiliates in between a Primary Affiliate and an Agent of Sale

16. A method as in claim 1, wherein at said primary affiliate is the Affiliate closest to the Top Factor.

17. A method as in claim 1, further comprising the step of displaying said promotional offer via an automated feed on at least one of said at least one merchant's website and said at least one affiliates website.

18. A method as in claim 1, further comprising the step of:
withholding at least a portion of at least one of said affiliate reward, said merchant reward, said core and said core reserve at the time of Purchase at Point of Sale to provide withheld funds;
maintaining said withheld funds in an Escrow account for a predetermined period of time;
releasing said withheld funds after said predetermined period of time wherein chargebacks have not been made.

19. A method as in claim 1, wherein said affiliate reward is affiliate pool incentive split.

20. A computer processor implemented system for managing cross promotions and awarding at least two promotions between at least two merchants according to a consumers purchase history with at least one of said at least two merchants, said system comprising;
at least two merchants, each said merchant having a store and agreeing to an agreeable predetermined promotional offer at said store;
a referral identifier generator for each said merchant to give at least one consumer, said referral identifier generator in a computer processor system coupled to a network and said referral identifier representing a promotional offer for at least one consumer;
an affiliate tracking system for accepting and tracking said referral identifier from said at least one consumer, said affiliate tracking system in a computer coupled to a network, wherein said at least one consumer is awarded at least one promotion according to said referral identifier and at least one said merchant is awarded at least one merchant reward according to said at least one consumers purchase history with at least one store.

21. A system as in claim 20, wherein said referral identifier is selected from the group consisting of a coupon, joint coupon, discount with joint coupon, award with joint coupon, rebate with joint coupon, Radio Frequency Identifier Coupon, mobile phone coupon, signal delivered coupon, computer generated link, referrer coupon, coupon code, system generated automated coupon code, consumer card, coupon card, and consumer coupon card.

22. A system as in claim 20, wherein said further affiliate tracking system for accepting said referral identifier is offline.

23. A system as in claim 20, further comprising at least one affiliate, and an affiliate referral identifier generated by said referral identifier generator, wherein said affiliate is awarded at least one affiliate reward according to said at least one consumers purchase history.

24. A system as in claim 20, further comprising at least one subaffiliate, and a subaffiliate referral identifier generated by said referral identifier generator, wherein said subaffiliate is awarded at least one flat fee affiliate reward for a referral.

25. A system as in claim 20, further comprising at least one of an independent sales organization, affiliate company, bank clearing house, stock exchange and market.

26. A system as in claim 20, wherein said referral identifier is a pooled advertisement.

27. A system as in claim 20, wherein said merchant is also an affiliate.

28. A system as in claim 20, further comprising a computer implemented networked directory wherein at least two of said at least two merchants selects at least one symbiotic relationship to create a business alliance.

29. A system as in claim 20, further comprising an Affiliate-Tier system having at least one affiliate and at least one subaffiliate, wherein said at least one subaffiliate and affiliate have an affiliate award agreement.

30. A system as in claim 20, said affiliate tracking system further comprising In-Store Affiliate Tracking, Advanced Purchase Tracking, Advanced Credit-Card Tracking, Advanced Customer Tracking, Advanced Sales Tracking and Tracking by Elements.

31. A system as in claim 20, wherein said at least one promotion is selected from the group consisting of a points system, cross-promotion marketing, affiliate points, collective card system, collective points systems, stock package, stock back and product basket.

32. A system as in claim 20, wherein said at least two merchants is at least comprising a first merchant and a second merchant and a merchant reward for said second merchant is preconditioned upon consumers purchase history with said first merchant.

33. A system as in claim 20, further comprising an affiliate processing system in communication with said affiliate tracking system.

34. A system as in claim 20, further comprising an affiliate network system in communication with said affiliate tracking system.

35. A system as in claim 23, wherein said affiliate reward is affiliate pool incentive split.

36. A system as in claim 20, further comprising an automated feed in networked communication with said computer processor system coupled to a network, wherein said automated feed communicates said at least one promotional offer for display on at least one of said at least one merchant's website and said at least one affiliates website .
